(19) United States
(12) Patent Application Publication
(10) Pub. No.: US 2009/0042125 A1
(43) Pub. Date: Feb. 12, 2009

(54) PHOTOTHERMOGRAPHIC MATERIAL

(75) Inventors: Narito GOTO, Kanagawa (JP); Takuji HASEGAWA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/972,691

(22) Filed: Jan. 11, 2008

(30) Foreign Application Priority Data
Jan. 24, 2007 (JP) 2007013584
Feb. 26, 2007 (JP) 2007045354

(51) Int. Cl. G03C 1/498

(52) U.S. Cl. 430/271.1; 430/270.1; 430/281.1

(57) ABSTRACT

A photothermographic material comprising on one side of a support a light-sensitive layer containing an organic silver salt, silver halide grains, a binder and a reducing agent and on the other side of the support a back coating layer, wherein a dry thickness of the light-sensitive layer is 9 to 16 μm; a centerline average roughness (Ra(B)) of an outermost surface of a back coating layer side is 100 to 150 nm; and the back coating layer contains a lubricant having a molecular weight of 550 to 10000.

This application is based on Japanese Patent Application No. 2007-013584 filed on Jan. 24, 2007, and No. 2007-045354 filed on Feb. 26, 2007 in Japanese Patent Office, the entire content of which is hereby incorporated by reference.

### FIELD OF THE INVENTION

The present invention relates to a photothermographic material containing an organic silver salt, silver halide particles, a binder and a reducing agent on a support.

### BACKGROUND OF THE INVENTION

According to the conventional art, in the field of medical treatment and printing plate manufacture, the effluent generated in the wet processing of the image forming material has raised a problem in the working practice. In recent years, from the viewpoint of environmental preservation and space saving efforts, there has been an intense demand for reduction in the amount of processed effluents. In an effort to solve this problem, a photothermographic material which allows image formation only by heating has been commercialized, and is rapidly coming into widespread use in the aforementioned field.

This photothermographic material is normally processed by a thermal development processing apparatus—called a thermal development processing device—that forms an image through stably supplying heat to a photothermographic material. As described above, as a result of rapid spread in recent years, a large quantity of various types of thermal development processing apparatuses have appeared in the market. Further, in recent years, there has been an intense demand for a laser imager which is more compact and higher in processing speed.

In the meantime, in the photothermographic material, a sliding agent has been known to be used to adjust the friction coefficient for the purpose of enhancing a conveying performance (Patent Documents 1 and 2).

There has been a demand for a compact, low-cost and quick first-print thermal development apparatus. Use of such a thermal development apparatus for high-speed processing has given rise to a new problem involving contamination inside the thermal development apparatus at the time of thermal development, and damage on the film. Further, it has been difficult to obtain a sufficient image density for mammography, and also, it has been necessary to improve the conveying performance under low moisture conditions and to reduce the fluctuation in density resulting from temperature change.

[Patent Document 1] Japanese Patent Application Publication Open to Public Inspection (hereafter referred to as JP-A) No. 2004-219794 (Claims)

[Patent-Document 2] JP-A No. 2004-334077 (Claims)

### SUMMARY OF THE INVENTION

An object of the present invention is to provide a photothermographic material that ensures minimized contamination inside the thermal development apparatus, minimized occurrence of a film damage, an excellent conveying performance and an excellent image density without fluctuation, even when the photothermographic material has been subjected to quick thermal development using a compact and low-cost thermal development apparatus.

One of the aspects of the present invention to achieve the above object is a photothermographic material comprising on one side of a support a light-sensitive layer containing an organic silver salt, silver halide grains, a binder and a reducing agent and on the other side of the support a back coating layer, wherein a dry thickness of the light-sensitive layer is 9 to 16 μm; a centerline average roughness (Ra(B)) of an outermost surface of a back coating layer side is 100 to 150 nm; and the back coating layer contains a lubricant having a molecular weight of 550 to 10000.

### BRIEF DESCRIPTION OF THE DRAWINGS

FIG. 1 is a side-view illustrating an example of the embodiment for the thermal development apparatus of the present invention.

FIG. 2 is a diagram schematically representing an example of the structure of the heat plate in the thermal development apparatus of the present embodiment.

### DESCRIPTION OF THE PREFERRED EMBODIMENTS

The above object of the present invention is achieved by the following structures.

(1) A photothermographic material comprising on one side of a support a light-sensitive layer containing an organic silver salt, silver halide grains, a binder and a reducing agent and on the other side of the support a back coating layer,
wherein

a dry thickness of the light-sensitive layer is 9 to 16 μm;

a centerline average roughness (Ra(B)) of an outermost surface of a back coating layer side is 100 to 150 nm; and

the back coating layer contains a lubricant having a molecular weight of 550 to 10000.

(2) The photothermographic material of Item (1), wherein the lubricant is a polyvalent alcohol fatty acid ester.
(3) The photothermographic material of Item (1) or (2), wherein the centerline average roughness (Ra(B)) of the outermost surface of the back coating layer side is 110 to 140 nm.
(4) The photothermographic material of any one of Items (1) to (3), wherein the light-sensitive layer contains a silver saving agent.
(5) The photothermographic material of Item (4), wherein the silver saving agent is at least one selected from the group consisting of a hydrazine derivative compound, a vinyl compound, a phenol derivative compound, a naphthol derivative compound, a quaternary onium compound and a silane compound.
(6) The photothermographic material of any one of Items (1) to (5), wherein a maximum value of an image density after thermal development is 4.0 to 5.0.
(7) The photothermographic material of any one of Items (1) to (6), wherein a gradation (a gamma value) at an optical density of 1.2 on a photographic characteristic curve is 2.0 to 6.0.
(8) A photothermographic material comprising:

on one side of a support, a light-sensitive layer containing an organic silver salt, silver halide grains, a binder and a reducing agent; and

on the other side of the support, a back coating layer, and a subbing layer between the back coating layer and the support, the back coating layer and the subbing layer containing at least one of a polyester resin, an acryl resin and a polyurethane resin,

wherein B>A is satisfied,

wherein
A represents a mass ratio of a total mass of the polyester resin, the acryl resin and the polyurethane resin contained in the back coating layer based on a total mass of a binder contained in the back coating layer; and
B represents a mass ratio of a total mass of the polyester resin, the acryl resin and the polyurethane resin contained in the subbing layer based on a total mass of a binder contained in the subbing layer.
   (9) A photothermographic material comprising:

on one side of a support, a light-sensitive layer containing an organic silver salt, silver halide grains, a binder and a reducing agent, and a light-insensitive layer provided on the light-sensitive layer; and

on the other side of the support, a back coating layer, wherein

a dry thickness of the light-sensitive layer is 9 to 16 μm;

a centerline average roughness (Ra) of an outermost surface of a light-sensitive layer side is 1.20 to 170 nm; and

the light-insensitive layer or the back coating layer contains a lubricant having a molecular weight of 550 to 10000.

(10) A photothermographic material of Item (9), wherein the lubricant is a polyvalent alcohol fatty acid ester.
(11) A photothermographic material of Item (9) or (10), wherein the light-insensitive layer contains a matting agent particles, wherein an average diameter of the matting agent particles is 4.7 to 10.0 μm.
(12) A photothermographic material of any one of Items (9) to (11), wherein the centerline average roughness (Ra) of an outermost surface of a light-sensitive layer side of the support is 125 to 160 nm.
(13) A photothermographic material of any one of Items (9) to (12), wherein a ten-point average roughness (Rz) of the outermost surface of the light-sensitive layer side is 3.0 to 5.0 μm.
(14) A photothermographic material of any one of Items (9) to (13), wherein a maximum roughness (Rt) of the outermost surface of the light-sensitive layer side is 4.5 to 6.5 μm.
(15) The photothermographic material of any one of Items (9) to (14), wherein the light-sensitive layer contains a silver saving agent.
(16) The photothermographic material of Item (15), wherein the silver saving agent is at least one selected from the group consisting of a hydrazine derivative compound, a vinyl compound, a phenol derivative compound, a naphthol derivative compound, a quaternary onium compound and a silane compound.
(17) The photothermographic material of any one of Items (9) to (16), wherein a maximum value of an image density after thermal development is 4.0 to 5.0.
(18) The photothermographic material of any one of Items (9) to (17), wherein a gradation (a gamma value) at an optical density of 1.2 on a photographic characteristic curve is 2.0 to 6.0.

The present invention provides a photothermographic material that ensures increased image density, specifically image density without fluctuation due to moisture variation, reduced contamination inside the thermal development apparatus, reduced film damage, excellent conveying performances, specifically conveying performances under low moisture conditions.

The following describes the best embodiments of the present invention, however, the present invention is not limited thereto.

The following describes the components of the present invention:

### (Lubricant)

In the present invention, the lubricant having a molecular weight of 550 to 10,000, or polyvalent alcohol fatty acid ester is used as the lubricant. Especially it is preferred to use the polyvalent alcohol fatty acid ester having a molecular weight of 550 or more. The molecular weight is preferably 700 or more, more preferably 800 or more. There is no upper limit to the molecular weight as far as the object of the present invention can be achieved, however, the molecular weight is normally 10,000 or less, preferably 7,000 or less, more preferably 5,000 or less. If the molecular weight is 550 or more, a considerable reduction in the contamination inside the thermal development apparatus can be achieved. There is no restriction to the structure of the lubricant of the present invention as far as the molecular weight is in the range of 550 to 10,000, however, preferable are paraffin, liquid paraffin, fatty acid ester and silicon-containing comb-shaped graft polymer. The compounds described with reference to paragraph number “0018” of JP-A No. 2003-15259 can be used as the silicon-containing comb-shaped graft polymer. Of these compounds, the fatty acid ester is preferably used, and the polyvalent alcohol fatty acid ester is more preferably utilized.

When the polyvalent alcohol fatty acid ester is utilized, esterification may be completed, or part of the alcohol group may be remained. A fatty acid ester containing two or more ester groups in one molecule is preferred. A fatty acid ester containing three or more ester groups is more preferred. The lubricant used in the present invention is exemplified by triolein (glycerine triolate), glycerine trilaurate, glycerine tripalmitate, glycerine tristearate, glycerine tribehenate, isotridesyl laurate, isotridesyl myristate, isotridesyl palmitate, stearic acid isotridesyl, arachidic acid isotridesyl, isotridesyl erucate, behenic acid isotridesyl, trimethylol propane triisolayerate, trimethylol propane triisomyristate, trimethylol propane triisopalmitate, triisostrearic acid trimethylol propane, trimethylol propane triisoerucate, trimethylol propane triisoarachidate, trimethylol propane triisooleate, trimethylol propane triisobehenate, dipentaerythrityl hexaisostrearate, dipentaerythrityl hexaisopalmitate, dipentaerythrityl hexaisomyristate, dipentaerythrityl hexaisobehenate, and the compounds described in the Tables 1, 2 and 3 of the, JP-A No. 2004-334077 without the compounds of the present invention being restricted thereto.

The lubricant of the present invention is contained in the light-insensitive layer provided on the light-sensitive layer or in the back coating layer, and preferably in both the light-insensitive layer provided on the light-sensitive layer and the back coating layer. The back coating layer of the present invention refers to the layer provided opposite to the side of the support where the light-sensitive layer is provided. The subbing layer on the back coating layer side and the back coating layer protective layer are also contained in the back coating layer. The lubricant of the present invention is more preferably contained in the outermost layer of the light-insensitive layer provided on the light-sensitive layer or the protective layer of the back coating layer. The amount of the lubricant of the present invention to be added to the light-insensitive layer provided on the light-sensitive layer or to the back coating layer is preferably in the range of 0.1 to 20% by mass based on the mass of the binder (the binder also including the hardener if contained) contained in the layer to be used, more preferably in the range of 0.2 to 10% by mass, further more preferably 0.5 to 10% by mass and specifically more preferably 0.5 to 5% by mass.

### (Gamma Value)

### Photographic Characteristic Curve

The photographic characteristic curve in the present invention can be defined as the D-log E curve representing the relationship between the two axes wherein the common logarithm of the amount of exposure which is exposure energy (log E) is assigned on the horizontal axis and the optical density, namely, scattered light photographic density (D) is assigned on the vertical axis. The gamma value (Ga value or γ value) can be defined as the slope of the tangent line of the photographic characteristic curve at optical density of 1.2 (tan ↓ when θ represents the angle formed between the tangent line and the horizontal axis).

The gamma value (Ga value) at optical density of 1.2 is preferably in the range of 2.0 through 6.0, more preferably in the range of 3.5 through 5.5. When the gamma value is 2.0 to 6.0, the level of the development unevenness can be kept at a satisfactory level even when thermal development is carried out while conveying at a high speed, and an image which enables a high degree of diagnostic identification can be obtained with using a small amount of silver.

In the present invention, the gamma value (Ga value) of 2.0 to 6.0 at optical density of 1.2 can be easily obtained in combination of the following techniques:

1) Changing the type and the amount of the developer to be added.

2) Changing the type and the amount of the silver saving agent to be added.

3) Changing the amount of silver halide to be added, and the average particle diameter.

4) Changing the type and the amount of the spectral sensitizing pigment to be adsorbed by the silver halide particle.

5) Changing the method of chemical sensitization and the degree of reopening of the silver halide particles.

The dry film thickness of the light-sensitive layer is 9.0 μm or more without exceeding 16.0 μm, preferably 9.5 μm or more without exceeding 14.0 μm, more preferably 10.0 μm or more without exceeding 13.0 μm, whereby a high image density and an excellent image storage stability are obtained. Further, the sum of the dry film thicknesses of the light-sensitive layer and the light-insensitive layer both provided on at least one surface of the support of the photothermographic material is preferably 12.0 μm or more without exceeding 19.0 μm, more preferably 14.0 μm or more without exceeding 18.0 μm. In order to reduce the image density irregularity and to improve the sharpness after thermal development, the maximum value of the image density after thermal development is preferably 4.0 or more without exceeding 5.0, more preferably 4.0 or more without exceeding 4.8, still more preferably 4.2 or more without exceeding 4.6.

### (Surface Layer)

In the present invention, the centerline average roughness (Ra(B)) on the outermost surface on the side provided with the back coating layer is in the range of 100 through 150 nm, more preferably in the range of 110 through 140 nm, and still more preferably in the range of 115 through 135 nm. When the Ra(B) on the surface of the back coating layer side is kept within this range, the advantages of the present invention, particularly in reducing contamination inside the thermal development apparatus and scratches, can be improved. In this case, (B) represents the outermost surface on the back coating layer side opposite to the light-sensitive layer side. The ten-point average roughness (Rz(B)) on the outermost surface on the side provided with the back coating layer is preferably 4.0 through 8.0 μm, more preferably 4.0 through 7.0 μm. The maximum roughness (Rt(B)) on the outermost surface on the side provided with the back coating layer is preferably 5.0 through 12.0 μm, more preferably 5.5 through 10.0 μm. When the Rz(B) and Rt(B) of the surface on the back coating layer side is kept within the range, the advantages of the present invention, particularly in reducing contamination inside the thermal development apparatus and scratches, can be improved.

In the present invention, the centerline average roughness (Ra(E)) of the outermost surface of the light-sensitive layer side is 120 through 170 nm. It is preferably in the range of 125 through 160 nm, more preferably in the range of 130 through 150 nm. When the centerline average roughness Ra(E) of the outermost surface of the light-sensitive layer side is kept within this range, the advantages of the present invention can be ensured; in particular, contamination inside the thermal development apparatus can be minimized, and scratches can also be minimized. The ten-point average roughness Rz(E) on the outermost surface on the light-sensitive layer side is preferably in the range of 3.0 through 5.0 μm, more preferably in the range of 3.2 through 4.8 μm. The maximum roughness Rt(E) on the outermost surface of the light-sensitive layer side is preferably in the range of 4.5 through 6.5 μm, more preferably in the range of 4.7 through 6.0 μm. When the Rz(E) are Rt(E) on the outermost surface of the light-sensitive layer side are kept within these ranges, the advantages of the present invention can be ensured; in particular, contamination inside the thermal development apparatus can be minimized, and scratches can also be minimized.

In the present invention, (E) denotes the outermost surface of the light-sensitive layer side, and (B) indicates the outermost surface on the back coating layer side opposite the light-sensitive layer side.

In the present invention, the Ra(E)/Ra(B) value is preferably in the range of 0.6 or more without exceeding 1.5, more preferably in the range of 0.6 or more without exceeding 1.3. If this value is kept within this range, fogging that may occur with the lapse of time can be minimized, film conveying performances are improved, and the image density irregularity at the time of thermal development can be reduced.

In the photothermographic material, the ten-point mean roughness (Rz), the maximum roughness (Rt) and the center-line mean roughness (Ra) are defined in JIS Surface Roughness (B0601). The JIS B 0601 also corresponds to ISO 468-1982, ISO 3274-1975, ISO 4287/1-1984, ISO 4287/2-1984 and ISO 4288-1985. The ten-point mean roughness is the value of difference, being expressed in micrometer (μm), between the mean value of altitudes of peaks from the highest to the 5th, measured in the direction of vertical magnification from a straight line that is parallel to the mean line and that does not intersect the profile, and the mean value of altitudes of valleys from the deepest to the 5th, within a sample portion, the length of which corresponds to the reference length, from the profile. The maximum roughness (Rt) of the surface is determined as follows. Thus, when a length corresponding to the reference length (L) in the direction of a mean line is sampled from a roughness profile, the maximum roughness (Rt) is a value, expressed in micrometer (μm) measuring the space between a peak line and a valley line in the direction of vertical magnification of the profile. The center-line mean roughness (Ra), when the roughness curve is expressed by y=f(x), is a value, expressed in micrometer (μm), that is obtained from the following formula, extracting a part of reference length L in the direction of its center-line from the roughness curve, and taking the center-line of this extracted part as the X-axis and the direction vertical magnification as the Y-axis:

$$Ra = \frac{1}{L} {\int }_{0}^{L} \vert f ( x ) \vert d x$$

The measurement of Rz, Rt and Ra were made under an environment of 25° C. and 65% RH after allowed to stand under the same environment so that samples are not overlapped. The expression, samples are not overlapped means a method of winding with raising the film edge portion, overlapping with inserting paper between films or a method in which a frame is prepared with thick paper and its four corners are fixed. Measurement apparatuses usable in the present invention include, for example, RST PLUS non-contact three-dimensional micro-surface-form measurement system (WYKO Co.).

The Rz, Rt and Ra values can be adjusted so as to fall within the intended range by combination of the following technical means:

(1) the kind, average particle diameter, amount and a surface treatment method of a matting agent (inorganic or organic powder) contained in the layer of the light-sensitive layer side and in the layer of the opposite side,

(2) dispersing conditions of the matting agent (e.g., the kind of a dispersing machine, dispersing time, the kind or the average particle diameter of beads used in the dispersion, the kind and amount of a dispersing agent, the kind of a polar group of a binder and its content),

(3) drying conditions in the coating stage (e.g., coating speed, distance from the coating side to the hot air nozzle, drying air volume) and residual solvent quantity,

(4) the kind of a filter used for filtration of coating solutions and filtration time, and

(5) when subjected to a calendering treatment after coating, its conditions (e.g., a calendering temperature of 40 to 80° C., a pressure of 50 to 300 kg/cm, a line-speed of 20 to 100 m and the nip number of 2 to 6).

The photothermographic material of the present invention preferably contains matting agent particles exhibiting an average particle diameter of 4.7 to 10.0 μm, more preferably 5.0 to 8.0 μm in the outermost layer of the light-sensitive layer side. The matting agent may be used in combination, and, when it is used in combination, matting agent A exhibiting an average particle diameter of 0.3 to 2.0 μm and matting agent B exhibiting an average particle diameter of 4.7 to 10.0 μm are preferably used. The particle diameter of matting agent A is more preferably 0.5 to 1.5 μm and the particle diameter of matting agent B is more preferably 5.0 to 8.0 μm. The mass ratio of matting agent A to matting agent B is preferably from 99:1 to 60:40, and more preferably 95:5 to 70:30, The matting agent content of the outermost layer of the light-sensitive layer side is usually 1.0% to 20%, preferably 2.0% to 15%, and more preferably 3.0% to 10% by mass of the binder content of the outermost layer (in which cross-linking agents are included in the binder content).

A matting agent (preferably, a matting agent comprised of a cross-linked organic resin) contained in the outermost layer of the opposite side of the light-sensitive layer preferably has an average particle diameter of 8.0 to 15.0 μm, and more preferably 9.0 to 12.0 μm.

The adding amount of the matting agent is usually 0.2 to 10% by mass, preferably 0.4 to 7%; by mass and more preferably 0.6 to 5% by mass based on the mass of the binder used in the outermost layer of the back coating layer side (the mass of the cross-linking agent is included in the mass of the binder).

In the present invention, the Rz(E)/Rz(B) value is preferably 0.1 to 0.7, more preferably 0.2 to 0.6 and still more preferably 0.3 to 0.55, whereby the film conveying performances are improved, and the image density irregularity at the time of thermal development can be reduced.

The photothermographic material of the present invention preferably has constituting layers on both sides of the supports having plural kinds of matting agents. In the photothermographic material of the present invention, when matting agent(s) are contained in the outermost layer of the light-sensitive layer side and the average particle diameter of a matting agent exhibiting the maximum average particle diameter is designated as Le (μm), and matting agents are also contained in the outermost surface layer of the opposite side to the light-sensitive layer and the average particle diameter of a matting agent exhibiting the maximum average particle diameter is designated as Lb (μm), the ratio of Lb/Le is 2.0 to 10, and more preferably 3.0 to 4.5.

The above Lb/Le ratio results in an improvement in unevenness of density when the image is thermally developed. Further, the value of Rz(E)/Ra(E) of the light-sensitive layer side is preferably 12 to 60, and more preferably 14 to 50, thereby resulting in improvements in unevenness of density and storage stability.

The value of Rz(B)/Ra(B) is preferably 25 to 65, and more preferably 30 to 60, thereby resulting in improvements in unevenness of density and storage stability.

The foregoing surface roughness was evaluated in the following manner.

Using a noncontact three-dimensional surface analyzer (ST/PLUS, produced by WYICO Co.), a raw material sample which has not been subjected to thermal development, was measured as follows:
1) objective lens: ×10, intermediate lens: ×1.0
2) measurement range: 463.4 μm×623.9 μm
3) pixel size: 368×238
4) filter: cylinder correction and inclination correction
5) smoothing: medium smoothing
6) scanning speed: Low.

The foregoing Ra, Rz and Rt are defined in JIS Surface Roughness (B0601). A sample of 10 cm×10 cm was divided to 100 squares at intervals of 1 cm, the center of the respective square regions was measured and an average value was calculated from 100 measurements.

In one preferred embodiment of the present invention, the surface layer contains a matting agent. In the surface layer of the light-sensitive layer side or of the opposite side of the support to the light-sensitive layer of the photothermographic material, it is preferred to use organic or inorganic powdery material as a matting agent to control the surface roughness.

Powdery material employed in the present invention preferably has a Mohs hardness of 5 or more. The powdery material can suitably be chosen from organic or inorganic powdery materials. Examples of inorganic powdery material include titanium oxide, boron nitride, SnO₂, SiO₂, Cr₂O₃, α-Al₂O₃, α-Fe₂O₃, α-FeOOH, SiC, cerium oxide, corundum, artificial diamond, garnet, mica, silicate, silicon nitride and silicon carbide. Example of organic powdery material include polymethyl methacrylate, polystyrene, and Teflon (trade name). In the present invention, organic powdery material is preferably employed as a matting agent in the layer provided on the opposite side to the light-sensitive layer of the support (back coating layer), more preferably organic polymer particles and specifically preferably three-dimensionally cross-linked polymethyl methacrylate particles are employed. The glass transition temperature (Tg) of the organic polymer particles is preferably 130-150° C., whereby the contamination in inside of the thermal developer apparatus is suppressed. On the other hand, in the photo-insensitive layer provided on the light-sensitive layer side of the support, inorganic particles are preferably employed as a matting agent. Of these, preferable are inorganic particles such as SiO₂, titanium oxide, barium sulfate, α-Al₂O₃, α-Fe₂O₃, α-FeOOH, Cr₂O₃ and mica. In the present invention, the abovementioned organic polymer particles and inorganic particles are preferably used in combination. The mass ratio of organic polymer particles to inorganic particles, in the layer in which organic polymer particles and inorganic particles are used in combination, is preferably 10:90 to 90:10, more preferably 20:80 to 80:20 and specifically preferably 30:70 to 70:30.

Of the foregoing powdery materials, those which have been subjected to a surface treatment, are preferred. The surface treatment layer is formed in the following manner. An inorganic raw material is subjected to dry-system pulverization, then water and a dispersing agent are added thereto and further subjected wet-system pulverization, and after subjected to centrifugal separation, coarse classification is conducted. Thereafter, the thus prepare particulate slurry is transferred to the surface treatment bath where surface coating of a metal hydroxide is performed.

Thus, a prescribed amount of an aqueous solution of a salt of Al, Si, Ti, Zr, Sb, Sn, Zn or the like is added thereto and an acid or alkali is further added for neutralization to coat the inorganic powdery particulate surface with a hydrous oxide. Water-soluble salts as by-products are removed by decantation, filtration or washing. The slurry is adjusted to a specific pH value, filtered and washed with pure water. The thus washed cake is dried by a spray drier or a hand drier. Finally, the dried material is pulverized to obtain a product. Besides of the foregoing aqueous system, vapor of AlCl₃ or SiCl₄ may be introduced to non-magnetic inorganic powder, followed by introduction of water vapor to perform Al- or Si-surface treatment. Other surface treatment methods are referred to “Characterization of Powder Surfaces”, Academic Press.

In the present invention, it is preferred to perform a surface treatment using a silicon (Si) compound or Aluminum (Al) compound. The use of the thus surface-treated powder results in superior dispersion when preparing the dispersion of a matting agent. In that case, the Si content is preferably 0.1% to 10% by mass, more preferably 0.1% to 5% by mass and still more preferably 0.1% to 2% by mass; the Al content is preferably 0.1% to 10% by mass, more preferably 0.1% to 5% by mass and still more preferably 0.1% to 2% by mass. The weight ratio of Si to Al is preferably to be Si<Al. The surface treatment can also be performed by the method described in JP-A No. 2-83219. With respect to the average particle diameter of a powdery material, that of spherical particle powder is its average diameter, that of a needle-form particle powder is the average major axis length and that of tabular particle powder is the average value of maximum diagonal lines on the tabular plane, which can readily be determined by electron microscopic observation.

The coefficient of variation of powdery particle diameter distribution is preferably 50% or less, more preferably 40% or less, and still more preferably 30% or less. The coefficient of variation of particle diameter distribution is the value defined in the following equation:

(Coefficient of variation of particle diameter distribution)=[(standard deviation of particle diameter)/(average particle diameter)]×100.

Organic or inorganic powdery material may be dispersed in a coating solution and then coated. Alternatively, after coating a coating solution, organic or inorganic powdery material may be sprayed thereon. Plural powdery materials may employ the foregoing methods in combination.

### (Organic Silver Salt)

An organic silver salt usable in the present invention is a light-insensitive organic silver salt capable of functioning as a source for supplying silver ions necessary to form an image in the light-sensitive layer of a photothermographic material.

Organic silver salts usable in the present invention which are relatively stable to light, function as a silver ion supplying source and contribute to formation of silver images when heated at a temperature of 80° C. or more in the presence of silver halide grains (photocatalyst) having latent images formed upon exposure a photocatalyst on the grain surface and a reducing agent.

There have been known silver salts of organic compounds having various chemical structure. Such light-insensitive organic silver salts are described in JP-A No. 10-62899, paragraph [0048]-[0049]; European Patent Application Publication (hereinafter, denoted simply as EP-A) No. 803,764A1, page 18, line 24 to page 24, line 37; EP-A No. 962,812A1; JP-A Nos. 11-349591, 2000-7683, 2000-72711, 2002-23301, 2002-23303, 2002-49119, 2002-196446; EP-A Nos. 1246001A1 and 1258775A1; JP-A Nos. 2003-140290, 2003-195445, 2003-295378, 2003-295379, 2003-295380, 2003-295381 and 2003-270755.

Silver salts of aliphatic carboxylic acids, specifically long chain aliphatic carboxylic acids having 10 to 30 carbon atoms, preferably 15 to 28 carbon atoms are preferable used alone or in combination with the foregoing organic silver salts. The molecular weight of such an aliphatic carboxylic acid is preferably from 200 to 500, and more preferably 250 to 400. Preferred aliphatic carboxylic acid (or fatty acid) silver salts include, for example, silver behenate, silver arachidate, silver stearate, silver oleate, silver laurate, silver caprate, silver myristate, silver palmitate and their mixtures.

Of the foregoing aliphatic carboxylic acid silver salts, a fatty acid silver salt having a silver behenate content of 50 mol % or more (preferably 80 to 99.9 mol %, and more preferably 90 to 99.9 mol %) is preferably used. The content of silver erucate is preferably 2 mol % or less, more preferably 1 mol % or less and further more preferably 0.1 mol % or less.

Prior to preparation of an aliphatic carboxylic acid silver salt, it needs to prepare an alkali metal salt of an aliphatic carboxylic acid. Alkali metal salts usable in the present invention include, for example, sodium hydroxide, potassium hydroxide and lithium hydroxide. Of these, the use of potassium hydroxide is preferred. The combined use of sodium hydroxide and potassium hydroxide is also preferred. The molar ratio of the combined use is preferably within the range of 10:90 to 75:25. The use within the foregoing range can suitably control the viscosity of a reaction mixture when forming an alkali metal salt of an aliphatic carboxylic acid through the reaction with an aliphatic carboxylic acid.

When preparing an aliphatic carboxylic acid silver salt in the presence of silver halide grains having an average grain diameter of 0.050 μm or less, a higher content of potassium of alkali metal salts is preferred in terms of prevention of dissolution of silver halide grains and Ostwald ripening. A high potassium content results in reduced sizes of aliphatic acid silver salt particles. The proportion of a potassium salt of total alkali metal salts is preferably 50 to 100 mol % of the whole alkali metal salts. The alkali metal salt concentration is preferably from 0.1 to 0.3 mol/1000 ml.

The sphere-equivalent diameter refers to a diameter of a sphere having a volume equivalent to the volume of a particle of the aliphatic carboxylic acid silver salts. A coated sample is observed by a transmission electron microscope and a particle volume is determined from the projection area and thickness of an observed particle. When the particle volume is converted to a sphere having the same volume as the particle, the particle diameter is represented by a diameter of the sphere. The average sphere-equivalent diameter of light-insensitive aliphatic carboxylic acid silver salts can readily be controlled, for example, by increasing the proportion of a potassium salt in preparation of aliphatic carboxylic acid silver salts or by adjusting a zirconia bead size, a circumferential speed of a mill or a dispersing time in the process of dispersing a light-sensitive emulsion. To obtain a sufficient image density after thermal development, the average sphere-equivalent diameter of aliphatic carboxylic acid silver salts used in the present invention is preferably from 0.05 to 0.50 μm, more preferably 0.10 to 0.45 μm, and still more preferably 0.15 to 0.40 μm.

In addition to the foregoing organic silver salts, also usable are core/shell organic silver salts described in JP-A No. 2002-23303; silver salts of polyvalent carboxylic acids, as described in EP 1246001 and JP-A No. 2004-061948; and polymeric silver salts, as described in JP-A Nos. 2000-292881 and 2003-295378 to 2003-295381.

The shape of aliphatic carboxylic acid silver salts usable in the present invention is not specifically limited and organic silver salts in any form, such as needle form, bar form, tabular form or scale form, are usable. Aliphatic carboxylic acid silver salts in a scale-form are preferred in the present invention. There are also preferably used organic silver salts in the form of a short needle exhibiting a ratio of major axis to minor axis of 5 or less, a rectangular parallelepiped or a cube.

In the present invention, an aliphatic carboxylic acid silver salt in a scale form is defined as follows. The aliphatic carboxylic acid silver salt is electron-microscopically observed and the form of organic silver salt grains is approximated by a rectangular parallelepiped. When edges of the rectangular parallelepiped are designated as “a”, “b” and “c” in the order from the shortest edge (in which c may be equal to b), values of shorter edges a and b are calculated to determine “x” defined as below:

x=b/a

Values of x are determined for approximately 200 grains and the average value thereof (denoted as x(av.)) is calculated. Thus, grains satisfying the requirement of x(av.)≧1.5 are defined to be a scale form. Preferably, 30≧x(av.)≧1.5, and more preferably, 20≧x(av.)≧2.0. In this connection, the needle form satisfies 1≦x(av.)≦1.5.

In the foregoing grain in a scale form, “a” is regarded as a thickness of a tabular grain having a major face comprised of edges of “b” and “c”. The average value of “a” is preferably from 0.01 to 0.23 μm, more preferably 0.1 to 0.20 μm. The average value of c/b is preferably from 1 to 6, more preferably 1.05 to 4, still more preferably 1.1 to 3, and further still more preferably 1.1 to 2.

The grain diameter distribution of an aliphatic carboxylic acid silver salt is preferably monodisperse. The expression, being monodisperse means that the percentage of a standard deviation of minor or major axis lengths, divided by an average value of the minor or major axis, is preferably less than 100%, more preferably not more than 80%, and still more preferably not more than 50%. The shape of aliphatic carboxylic acid silver salts can be determined through transmission electron-microscopic images of an aliphatic carboxylic acid silver salt dispersion. Alternatively, the standard deviation of volume-weighted grain diameter, divided by the average volume-weighted grain diameter (that is a coefficient of variation) is preferably less than 100%, more preferably not more than 80%, and still more preferably not more than 50%. The measurement thereof is carried out, for example, as follows. To an aliphatic carboxylic acid silver salt dispersed in a liquid, laser light is irradiated and an auto-correction function vs. time change of fluctuation of scattered light to determine the grain diameter (volume-weighted average grain diameter).

As the method of preparation of the organic silver salt of the present invention and the method of dispersion thereof, any known method is applicable. For example, the aliphatic carboxylic acid silver salt particles of the present invention is prepared preferably by allowing a silver ion-containing solution to react with a solution or suspension of an aliphatic carboxylic acid alkali metal salt. Such a silver ion-containing solution is preferably an aqueous silver nitrate solution and a solution (or suspension) of an aliphatic carboxylic acid alkali metal salt is preferably an aqueous solution or suspension thereof. The addition and mixing of the both solution are preferably carried out simultaneously. The solutions may be added onto the surface or into the interior of the mother liquid. In the present invention, however, mixing via a transfer means is preferred. Mixing in a transfer means signifies line mixing. Thus, a silver ion containing solution and a solution or suspension of an aliphatic carboxylic acid alkali metal salt are mixed before being introduced into a batch for stocking a reaction mixture containing products. Any stirring means of the mixing section may be applicable, for example, mechanical stirring such as a homomixer, static mixer or a turbulent-flow mixing, but it is preferred not to use mechanical stirring. In the foregoing mixing in a transfer means, there may be mixed a third liquid, such as water or a reaction mixture stocked in the batch, in addition to a silver ion containing solution and a solution or suspension of an aliphatic carboxylic acid alkali metal salt. As for other method, conventionally known methods are applicable, for example, as described in JP-A No. 10-62899, EP 803,763A1, EP 962,812A1, JP-A Nos. 2001-167022, 2000-7683, 2000-72711, 2001-163889, 2001-163890, 2001-163827, 2001-33907, 2001-188313, 2001-83652, 2002-64422002-31870, 2003-280135 and 2005-157190.

Dispersing aliphatic carboxylic acid silver salts concurrently in the presence of a light-sensitive silver salt, such as silver halide grains results in increased fogging and decreased sensitivity, and it is therefore preferred that the dispersion contains substantially no light-sensitive silver salt. Thus, the content of an aqueous dispersion of light-sensitive silver salt is preferably not more than 1 mol % based on 1 mole of an organic silver salt in the dispersion, more preferably not more than 0.1 mol %, and no addition of light-sensitive silver salt is more preferred.

The photothermographic material of the present invention can be prepared by mixing an aqueous dispersion of aliphatic carboxylic acid silver salts with an aqueous dispersion of light-sensitive silver salt. The ratio of light-sensitive silver salt to aliphatic carboxylic acid silver salt can be optionally chosen but preferably from 1 to 30 mol %, more preferably 2 to 20 mol %, and still more preferably 3 to 15 mol %. To control photographic characteristics, it is preferred to mix an aqueous dispersion of at least two kinds of organic silver salts with an aqueous dispersion of at least two kinds of light-sensitive silver salts.

Organic silver salts of the present invention are usable in an intended amount but preferably 0.1 to 5 g/m², based on silver amount, more preferably 0.3 to 3 g/m², and still more preferably 0.5 to 2 g/m².

### (Silver Halide Grains)

Silver halide grains (hereinafter, also denoted as light-sensitive silver halide grains) used in the present invention are those which are capable of absorbing light as an inherent property of silver halide crystal or capable of absorbing visible or infrared light by artificial physico-chemical methods, and which are treated or prepared so as to cause a physico-chemical change in the interior and/or on the surface of the silver halide crystal upon absorbing light within the region of ultraviolet to infrared.

The silver halide grains used in the present invention can be prepared according to conventionally known methods. Any one of acidic precipitation, neutral precipitation and ammoniacal precipitation is applicable and the reaction mode of aqueous soluble silver salt and halide salt includes single jet addition, double jet addition and a combination thereof. Specifically, preparation of silver halide grains with controlling the grain formation condition, so-called controlled double-jet precipitation is preferred.

The grain forming process is usually classified into two stages of formation of silver halide seed crystal grains (nucleation) and grain growth. These stages may continuously be conducted, or the nucleation (seed grain formation) and grain growth may be separately performed. The controlled double-jet precipitation, in which grain formation is undergone with controlling grain forming conditions such as pAg and pH, is preferred to control the grain form or grain diameter. In cases when nucleation and grain growth are separately conducted, for example, a soluble silver salt and a soluble halide salt are homogeneously and promptly mixed in an aqueous gelatin solution to form nucleus grains (seed grains), thereafter, grain growth is performed by supplying soluble silver and halide salts, while being controlled at a pAg and pH to prepare silver halide grains. After completion of grain formation, soluble salts are removed in the desalting stage, using commonly known desalting methods such as the noodle method, flocculation method, ultrafiltration method and electrodialysis method.

Silver halide grains are preferably monodisperse grains with respect to grain diameter. The monodisperse grains as described herein refer to grains having a coefficient of variation of grain diameter obtained by the formula described below of not more than 30%; more preferably not more than 20%, and still more preferably not more than 15%:

Coefficient of variation of grain diameter (%)=standard deviation of grain diameter/average grain diameter×100

The grain form can be of almost any one, including cubic, octahedral or tetradecahedral grains, tabular grains, spherical grains, bar-like grains, and potato-shaped grains. Of these, cubic grains, octahedral grains, tetradecahedral grains and tabular grains are specifically preferred.

The aspect ratio of tabular grains is preferably 1.5 to 100, and more preferably 2 to 50. These grains are described in U.S. Pat. Nos. 5,264,337, 5,314,798 and 5,320,958 and desired tabular grains can be readily obtained. Silver halide grains having rounded corners are also preferably employed.

Crystal habit of the outer surface of the silver halide grains is not specifically limited, but in cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized.

It is preferred to use low molecular gelatin having an average molecular weight of not more than 50,000 in the preparation of silver halide grains used in the present invention, specifically, in the stage of nucleation.

Thus, the low molecular gelatin has an average molecular eight of not more than 50,000, preferably 2,000 to 40,000, and more preferably 5,000 to 25,000. The average molecular weight can be determined by means of gel permeation chromatography. The low molecular weight gelatin can be obtained by adding an enzyme to conventionally used gelatin having a molecular weight of ca. 100,000 to perform enzymatic degradation, by adding acid or alkali with heating to perform hydrolysis, by heating under atmospheric pressure or under high pressure to perform thermal degradation, or by exposure to ultrasonic.

The concentration of dispersion medium used in the nucleation stage is preferably not more than 5% by mass, and more preferably 0.05 to 3.0% by mass.

In the preparation of silver halide grains, it is preferred to use a compound represented by the following formula, specifically in the nucleation stage:

YO(CH₂CH₂O)ₘ(CH(CH₃)CH₂O)ₚ(CH₂CH₂O)ₙY

where Y is a hydrogen atom, —SO₃M or —CO—B—COOM, in which M is a hydrogen atom, alkali metal atom, ammonium group or ammonium group substituted by an alkyl group having carbon atoms of not more than 5, and B is a chained or cyclic group forming an organic dibasic acid; m and n each are 0 to 50; and p is 1 to 100.

Polyethylene oxide compounds represented by foregoing formula have been employed as a defoaming agent to inhibit marked foaming occurred when stirring or moving emulsion raw materials, specifically in the stage of preparing an aqueous gelatin solution, adding a water-soluble silver and halide salts to the aqueous gelatin solution or coating an emulsion on a support during the process of preparing silver halide photographic light sensitive materials. A technique of using these compounds as a defoaming agent is described in JP-A No. 44-9497. The polyethylene oxide compound represented by the foregoing formula also functions as a defoaming agent during nucleation. The compound represented by the foregoing formula is used preferably in an amount of not more than 1%, and more preferably 0.01 to 0.1% by mass, based on silver.

The compound is to be present at the stage of nucleation, and may be added to a dispersing medium prior to or during nucleation. Alternatively, the compound may be added to an aqueous silver salt solution or halide solution used for nucleation. It is preferred to add it to a halide solution or both silver salt and halide solutions in an amount of 0.01 to 2.0% by mass. It is also preferred to make the compound represented by foregoing formula present over a period of at least 50% (more preferably, at least 70%) of the nucleation stage. The compound represented by foregoing formula may be added in the form of powder or being dissolved in, for example, in methanol.

The temperature during the stage of nucleation is preferably 5 to 60° C., and more preferably 15 to 50° C. Even when nucleation is conducted at a constant temperature, in a temperature-increasing pattern (e.g., in such a manner that nucleation starts at 25° C. and the temperature is gradually increased to reach 40° C. at the time of completion of nucleation) or its reverse pattern, it is preferred to control the temperature within the range described above.

Silver salt and halide salt solutions used for nucleation are preferably in a concentration of not more than 3.5 mol/l, and more preferably 0.01 to 2.5 mol/l. The flow rate of aqueous silver salt solution is preferably 1.5×10⁻³ to 3.0×10⁻¹ mol/min per liter of the solution, and more preferably 3.0×10⁻³ to 8.0×10⁻² mol/min. per liter of the solution.

The pH during nucleation is within a range of 1.7 to 10, and since the pH at the alkaline side broadens the grain diameter distribution, the pH is preferably 2 to 6. The pBr during nucleation is 0.05 to 3.0, preferably 1.0 to 2.5, and more preferably 1.5 to 2.0.

The average grain diameter of silver halide of the present invention is preferably 10 to 50 nm, more preferably 10 to 40 nm, and still more preferably 10 to 35 nm. An average grain diameter of less than 10 nm often lowers the image density or deteriorated storage stability under light exposure (aging stability when images obtained in thermal development is used for diagnosis under room light or aged under ambient light). An average grain diameter of more than 50 nm results in lowered image density.

In the present invention, the average grain diameter refers to an edge length of the grain in the case of regular grains such as cubic or octahedral grains. In the case of tabular grains, the average grain diameter refers to a diameter of a circle equivalent to the projected area of the major face. In the case of irregular grains, such as spherical grains or bar-like grains, the diameter of a sphere having the same volume as the grain is defined as the average grain diameter. Measurement is made using an electron microscope and grain diamether values of at least 300 grains are average and defined as an average grain diameter.

The combined use of silver halide grains having an average grain diameter of 55 to 100 nm and silver halide grains having an average grain diameter of 10 to 50 nm not only can control the gradation of image density but also can enhance the image density or improve (or reduce) lowering in image density during storage. The ratio (by weight) of silver halide grains having an average grain diameter of 10 to 50 nm to silver halide grains having an average grain diameter of 55 to 100 nm is preferably from 95:5 to 50:50, and more preferably form 90:10 to 60:40.

When two silver halide emulsions differing in average grain diameter are used in combination, these emulsions may be blended and incorporated to the light-sensitive layer. To make adjustment of gradation, the light-sensitive layer divided to at least two layers and two silver halide emulsions differing in average grain diameter are contained in the respective layers.

Iodide containing silver halide grains are preferably used as silver halide grains used in the present invention. With respect to halide composition, silver halide grains of the present invention preferably have an iodide content of 5 to 100 mol % (more preferably 40 to 100 mo %, still more preferably 70 to 100 mol % and specifically preferably 90 to 100 mole %). In the foregoing iodide content range, the halide composition within the grain may be homogeneous, or stepwise or continuously varied.

Silver halide grains of a core/shell structure, exhibiting a higher iodide content in the interior and/or on the surface are preferably used. The structure is preferably 2-fold to 5-fold structure and core/shell grains having the 2-fold to 4-fold structure are more preferred.

Introduction of silver iodide into silver halide can be achieved by addition of an aqueous alkali iodide solution in the course of grain formation, addition of fine grains such as particulate silver iodide, particulate silver iodobromide, particulate silver iodochloride or silver iodochlorobromide, or addition of an iodide ion-releasing agent as described in JP-A Nos. 5-323487 and 6-11780.

The silver halide usable in the present invention preferably exhibits a direct transition absorption attributed to the silver iodide crystal structure within the wavelength region of 350 to 440 nm. The direct transition absorption of silver halide can be readily distinguished by observation of an exciton absorption in the range of 400 to 430 nm, due to the direct transition.

### (Thermal Conversion Internal Latent Image Type Silver Halide Particle)

The light-sensitive silver halide particle of the present invention disclosed in the JP-A Nos. 2003-270755 and 2005-106927 is preferably the thermal conversion internal latent image type (post-thermal development internal latent image type) silver halide particle. To be more specific, it is the silver halide particle whose surface sensitivity is reduced by conversion from the surface latent image type to the internal latent image type by thermal development. In other words, the latent image that can function as a catalyst for development reaction (silver ion reduction by silver ion reducing agent) in the exposure before thermal development is formed on the surface of this silver halide particle. In the exposure after thermal development process, a greater deal of latent images are formed internally than on the surface of this silver halide particle, and therefore, the silver halide particle wherein the formation of the latent image on the surface is suppressed provides greater benefits in both the photosensitivity and image storage performance.

Similarly to the case of the normal surface latent image type silver halide particle, it is preferred to use 0.001 through 0.7 mol, preferably 0.03 through 0.5 mol of the thermal conversion internal latent image type silver halide particle with respect to 1 mol of the aliphatic silver salt carboxylate capable of functioning as a silver ion supply source.

### (Silver Halide Particle Amphiphilic Dispersion)

In the process of manufacturing the photothermographic material, it is preferred that the coagulation of the silver halide particles should be avoided from the viewpoint of improving the photographing performance and color tone, and the silver halide particles should be dispersed relatively uniformly, so that the development silver can be controlled to have a desired shape in the final phase.

To avoid coagulation and ensure uniform dispersion, the hydrophilic group such as amino group and carboxy group of the gelatine used is preferably subjected to chemical modification in response to the conditions of usage, thereby modifying the gelatine characteristics. For example, the modification of hydrophobing the amino group in the gelatine molecule is exemplified by phenyl carbamoylation, phthalation, succination, acetylation, benzoylation and nitrophenylation, without being restricted thereto. The substitutional rate thereof is preferably 956 or more, more preferably 99% or more. Further, hydrophobing of the carboxyl group can be combined. Methyl esterification and amidation can be mentioned, without being restricted thereto. The substitutional rate of the carboxyl group is preferably 50 through 90%, more preferably 70 through 90%. The aforementioned hydrophobic group of hydrophobing modification refers to the group whose hydrophobic property is increased by substitution of the amino group and/or carboxyl group of the gelatine.

Further, depending on a particular application, the silver halide particle emulsion can be preferably prepared using the polymer that dissolves in both water and organic solvent as shown in below, instead of gelatine or in combination with gelatine. For example, this is particularly preferred at the time of coating by uniform dispersion of a silver halide particle emulsion in an organic solvent or its equivalent. The alcohol, ester or ketone based compound is preferably used as an organic solvent. In particular, the ketone based organic solvent as exemplified by methanol, acetone, methyl ethyl ketone or diethyl ketone is preferred.

The aforementioned polymer that dissolves in both water and organic solvent can be any one of the natural polymer, synthetic polymer and copolymer. For example, it is possible to use the gelatins and rubbers having been modified so as to pertain to the category of the present invention. It is also possible to use the polymer pertaining to the following classification after instruction of the functional group suited for prevention of coagulation and uniform dispersion.

The aforementioned polymer is exemplified by the polymer described in the paragraph number “0018” of the JP-A No. 2005-316054.

This polymer can be the polymer that can be dissolved in both the water and organic solvent under the same conditions. It can be the polymer that can be dissolved or cannot be dissolved in water and organic solvent under the control of pH value or temperature. For example, the polymer having acidic group such as carboxyl group becomes hydrophilic in the dissociated state, depending on the type. However, if the pH value is decreased and is put to non-dissociated state, the polymer becomes lipophilic and can be dissolved in a solvent. Conversely, the polymer having an amino group becomes lipophilic when the pH value is increased. When the pH value is decreased, it is ionized and becomes more water-insoluble. In the case of a nonionic activator, phenomenon of clouding point is widely known. The present invention includes the temperature sensitive polymer (a widely known temperature sensitive polymer includes a poly-N-1-propylacryl amido and the copolymer thereof) which is made lipophilic and solvable in an organic solvent by the rise of temperature, and is made hydrophilic and dissolvable in water by the fall of temperature. It is sufficient only if a micelle is formed and uniform emulsification is performed, even if complete dissolution is not achieved.

Combinations of various types of monomers are used in the present invention. Accordingly, there is no sweeping statement about the recommended type and amount of monomers to be used. It is apparent that a desired polymer is obtained by a combination of proper percentages of hydrophilic and hydrophobic monomers.

The aforementioned polymer that can be dissolved in both water and organic solvent can be obtained by adjusting the conditions of the aforementioned pH value or the like at the time of dissolution, or adjustment may not be essential. However, for water, this polymer preferably has a solubility of at least 1% by mass (at 25° C.), and a solubility of at least 5% by mass (at 25° C.) in the methyl ethyl ketone as an organic solvent. As the polymer that can be dissolved in both water and organic solvent to be used in the present invention, the so-called block polymer, graft polymer and comb-shaped polymer are more preferred than the straight chained polymer, from the viewpoint of solubility. The comb-shaped polymer is used with particular preference. The isoelectric point of the polymer is preferably the pH value of 6 or less.

Various forms of techniques can be used to produce a comb-shaped polymer. It is preferred to produce a monomer which allows introduction of the side chain having a molecular weight of 200 and more in the comb portion (side chain). It is preferred in particular to use the ethylenic unsaturated monomer containing a polyoxyalkylene group such as ethylene oxide and propylene oxide. The polyoxyalkylene group described in paragraph numbers “0022” through “0024” of the JP-A No. 2005-316054 can be used with particular preference as the ethylenic unsaturated monomer containing a polyoxyalkylene group.

The monomers described in paragraph number “0025” of the JP-A No. 2005-316054 can be motioned as the commercially available monomers.

The graft polymers using the so-called the macromer can be used as the polymers. The details are disclosed in the “Synthesis and Reaction of Polymer, New Polymer Test Study 2” edited by the Japan Society of Polymer, Kyoritsu Publishing Co., Ltd., 1995 or “Chemistry and Industry of Macromer” by Y. Yamashita, IPC, 1989. The useful molecular weight of the macromer is in the range of 10,000 through 100,000, preferably 10,000 through 50,000, more preferably 10,000 through 20,000. If the molecular weight is below 10,000, the advantages in the present invention cannot be produced. If it exceeds 100,000, the polymerizability with the polymerized monomer constituting the principal chain will deteriorate. The specific examples are given by AA-6, AS-6S and AN-6S by Toagosei Co., Ltd.

It goes without saying that the present invention is not restricted by the aforementioned examples. Only one type of ethylenic unsaturated monomer containing a polyoxyalkylene, or two or more types in combination can be used.

Other monomers to be reacted with the aforementioned monomer are exemplified by (meth)acryl acid esters, ((meth)acryl amides, allyl esters, allyloxyethanols, vinyl ethers, vinyl esters, itaconic acid dialkyl, and mono-(or di-) alkyl esters of fumaric acid, as well as crotonic acid, itaconic acid, (meth)acrylonitryl, maleilonitrile and styrene.

Specific examples are the compounds described in the paragraph numbers “0029 and “0030” of the JP-A No. 2005-316054. The isoelectric point of the polymerization initiator, polymerization inhibitor and polymer, the type of the solvent used for polymerization, and the molecular weight of the polymer described in the paragraph numbers “0031” through “0039” of the JP-A No. 2005-316054.

Examples of amphiphilic polymers will be shown below, however, the present invention is not limited thereto.

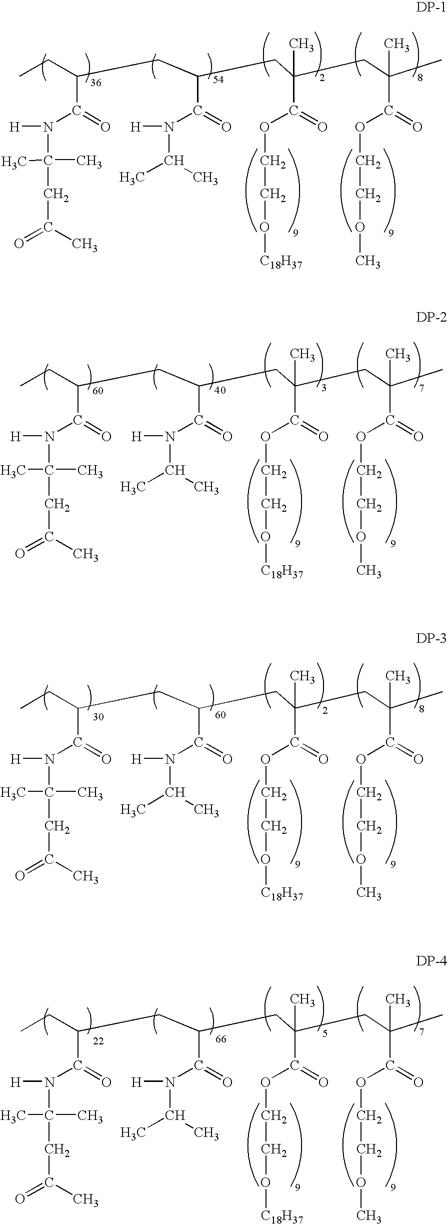

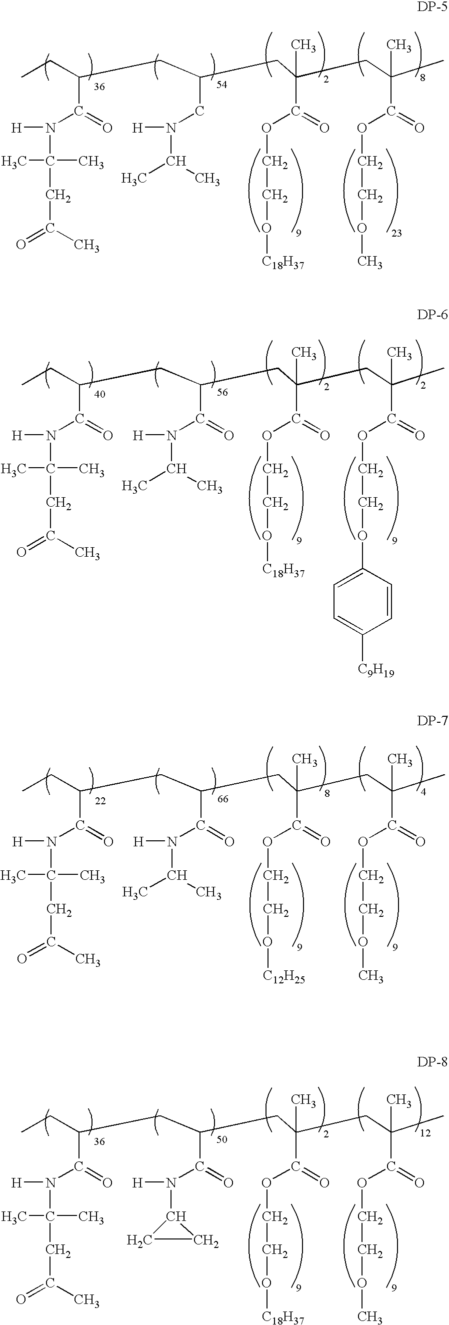

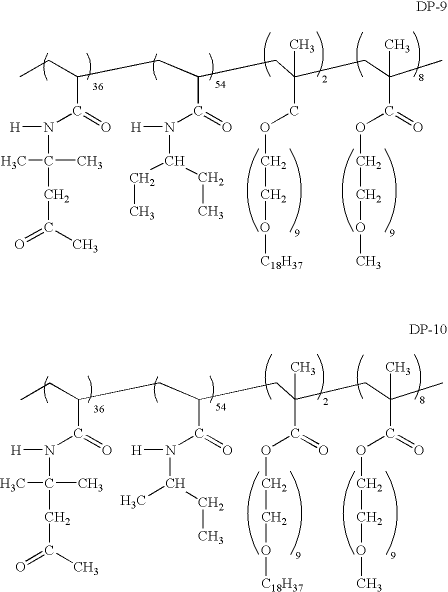

### (Chemical Sensitization)

Silver halide grains used in the present invention can be subjected to chemical sensitization. In accordance with methods described in JP-A Nos. 2001-249428 and 2001-249426, for example, a chemical sensitization center (chemical sensitization speck) can be formed using compounds capable of releasing chalcogen such as sulfur or noble metal compounds capable of releasing a noble metal ion such as a gold ion. In the present invention, it is preferred to conduct chemical sensitization with an organic sensitizer containing a chalcogen atom, as described below.

Such a chalcogen atom-containing organic sensitizer is preferably a compound containing a group capable of being adsorbed onto silver halide and a labile chalcogen atom site.

These organic sensitizers include, for example, those having various structures, as described in JP-A Nos. 60-150046, 4-109240 and 11-218874. Specifically preferred of these is at least a compound having a structure in which a chalcogen atom is attacked to a carbon or phosphorus atom through a double-bond. Specifically, heterocycle-containing thiourea derivatives and triphenylphosphine sulfide derivatives are preferred.

A variety of techniques for chemical sensitization employed in silver halide photographic material for use in wet processing are applicable to conduct chemical sensitization, as described, for example, in T. H. James, The Theory of the Photographic Process, 4th Ed. (Macmillan Publishing Co., Ltd., 1977 and Nippon Shashin Gakai Ed., “Shashin Kogaku no Kiso (Gin-ene Shashin)” (Corona Co., Ltd., 1998).

The amount of a chalcogen compound added as an organic sensitizer is variable, depending on the chalcogen compound to be used, silver halide grains and a reaction environment when subjected to chemical sensitization and is preferably 10⁻⁸ to 10⁻² mol, and more preferably 10⁻⁷ to 10⁻³ mol per mol of silver halide.

In the present invention, the chemical sensitization environment is not specifically limited but it is preferred to conduct chemical sensitization in the presence of a compound capable of eliminating a silver chalcogenide or silver specks formed on the silver halide grain or reducing the size thereof, or specifically in the presence of an oxidizing agent capable of oxidizing the silver specks, using a chalcogen atom-containing organic sensitizer. To conduct chemical sensitization under preferred conditions, the pAg is preferably 6 to 11, and more preferably 7 to 10, the pH is preferably 4 to 10 and more preferably 5 to 8, and the temperature is preferably not more than 30° C.

Chemical sensitization using the foregoing organic sensitizer is also preferably conducted in the presence of a spectral sensitizing dye or a heteroatom-containing compound capable of being adsorbed onto silver halide grains. Thus, chemical sensitization in the present of such a silver halide-adsorptive compound results in prevention of dispersion of chemical sensitization center specks, thereby achieving enhanced sensitivity and minimized fogging. Although there will be described spectral sensitizing dyes used in the present invention, preferred examples of the silver halide-adsorptive, heteroatom-containing compound include nitrogen containing heterocyclic compounds described in JP-A No. 3-24537. In the heteroatom-containing compound, examples of the heterocyclic ring include a pyrazolo ring, pyrimidine ring, 1,2,4-triazole ring, 1,2,3-triazole ring, 1,3,4-thiazole ring, 1,2,3-thiadiazole ring, 1,2,4-thiadiazole ring, 1,2,5-thiadiazole ring, 1,2,3,4-tetrazole ring, pyridazine ring, 1,2,3-triazine ring, and a condensed ring of two or three of these rings, such as triazolotriazole ring, diazaindene ring, triazaindene ring and pentazaindene ring. Condensed heterocyclic ring comprised of a monocyclic hetero-ring and an aromatic ring include, for example, a phthalazine ring, benzimidazole ring indazole ring, and benzthiazole ring.

Of these, an azaindene ring is preferred and hydroxy-substituted azaindene compounds, such as hydroxytriazaindene, tetrahydroxyazaindene and hydroxypentazaundene compound are more preferred.

The heterocyclic ring may be substituted by substituent groups other than hydroxy group. Examples of the substituent group include an alkyl group, substituted alkyl group, alkylthio group, amino group, hydroxyamino group, alkylamino group, dialkylamino group, arylamino group, carboxy group, alkoxycarbonyl group, halogen atom and cyano group.

The amount of the heterocyclic ring containing compound to be added, which is broadly variable with the size or composition of silver halide grains, is within the range of 10⁻⁶ to 1 mol, and preferably 10⁻⁴ to 10⁻¹ mol per mol silver halide.

Silver halide grains can be subjected to noble metal sensitization using compounds capable of releasing noble metal ions such as a gold ion. Examples of usable gold sensitizers include chlomoaurates and organic gold compounds. The gold sensitizing technique disclosed in JP-A No. 11-194447 can be preferably referred to.

In addition to the foregoing sensitization, reduction sensitization can also be employed and exemplary compounds for reduction sensitization include ascorbic acid, thiourea dioxide, stannous chloride, hydrazine derivatives, borane compounds, silane compounds and polyamine compounds. Reduction sensitization can also conducted by ripening the emulsion while maintaining the pH at not less than 7 or the pAg at not more than 8.3.

Silver halide to be subjected to chemical sensitization may be one which has been prepared in the presence of an organic silver salt, one which has been formed under the condition in the absence of the organic silver salt, or a mixture thereof.

When the surface of silver halide grains is subjected to chemical sensitization, it is preferred that an effect of the chemical sensitization substantially disappears after subjected to thermal development. An effect of chemical sensitization substantially disappearing means that the sensitivity of the photothermographic material, obtained by the foregoing chemical sensitization is reduced, after thermal development, to not more than 1.1 times that of the case not having been subjected to chemical sensitization. To allow the effect of chemical sensitization to disappear, it is preferred to allow an oxidizing agent such as a halogen radical-releasing compound which is capable of decomposing a chemical sensitization center (or chemical sensitization nucleus) through an oxidation reaction to be contained in an optimum amount in the light-sensitive layer and/or the light-insensitive layer. The content of an oxidizing agent is adjusted in light of oxidizing strength of an oxidizing agent and chemical sensitization effects.

### (Spectral Sensitization)

The light-sensitive silver halide usable in the present invention is preferably spectrally sensitized by adsorption of spectral sensitizing dyes. Examples of the spectral sensitizing dye include cyanine, merocyanine, complex cyanine, complex merocyanine, holo-polar cyanine, styryl, hemicyanine, oxonol and hemioxonol dyes, as described in JP-A Nos. 63-159841, 60-140335, 63-231437, 63-259651, 63-304242, 63-15245; U.S. Pat. Nos. 4,639,414, 4,740,455, 4,741,966, 4,751,175 and 4,835,096.

Usable sensitizing dyes are also described in Research Disclosure (hereinafter, also denoted as RD) 17643, page 23, sect. IV-A (December, 1978), and ibid 18431, page 437, sect. X (August, 1978). It is preferred to use sensitizing dyes exhibiting spectral sensitivity suitable for spectral characteristics of light sources of various laser imagers or scanners. Examples thereof include compounds described in JP-A Nos. 9-34078, 9-54409 and 9-80679.

Useful cyanine dyes include, for example, cyanine dyes containing a basic nucleus, such as thiazoline, oxazoline, pyrroline, pyridine, oxazole, thiazole, selenazole and imidazole nuclei. Useful merocyanine dyes preferably contain, in addition to the foregoing nucleus, an acidic nucleus such as thiohydantoin, rhodanine, oxazolidine-dione, thiazoline-dione, barbituric acid, thiazolinone, malononitrile and pyrazolone nuclei.

In the present invention, there are also preferably used sensitizing dyes having spectral sensitivity within the infrared region. Examples of the preferred infrared sensitizing dye include those described in U.S. Pat. Nos. 4,536,478, 4,515,888 and 4,959,294.

A photothermographic material used in the present invention preferably contains at least one of sensitizing dyes represented by formula (1) and sensitizing dyes represented by formula (2), as disclosed in U.S. Patent Application publication No. 20040224266, and more preferably at least one of sensitizing dyes represented by formula (5) and sensitizing dyes represented by formula (6). The combined use of sensitizing dyes represented by formula (5) and sensitizing dyes represented by formula (6) results in improved dependency on the wavelength of exposing light at the time of exposure.

The infrared sensitizing dyes and spectral sensitizing dyes described above can be readily synthesized according to the methods described in F. M. Hammer, The Chemistry of Heterocyclic Compounds vol. 18, “The Cyanine Dyes and Related Compounds” (A. Weissberger ed. Interscience Corp., New York, 1964).

The infrared sensitizing dyes can be added at any time after preparation of silver halide. For example, the dye can be added to a light sensitive emulsion containing silver halide grains/organic silver salt grains in the form of by dissolution in a solvent or in the form of a fine particle dispersion, so-called solid particle dispersion. Similarly to the heteroatom containing compound having adsorptivity to silver halide, after adding the dye prior to chemical sensitization and allowing it to be adsorbed onto silver halide grains, chemical sensitization is conducted, thereby preventing dispersion of chemical sensitization center specks and achieving enhanced sensitivity and minimized fogging.

These sensitizing dyes may be used alone or in combination thereof. The combined use of sensitizing dyes is often employed for the purpose of supersensitization, expansion or adjustment of the light-sensitive wavelength region.

A super-sensitizing compound, such as a dye which does not exhibit spectral sensitization or substance which does not substantially absorb visible light may be incorporated, in combination with a sensitizing dye, into the emulsion containing silver halide grains and organic silver salt grains used in photothermographic imaging materials of the present invention.

Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A No. 59-19032, 59-192242 and 5-341432. In the present invention, an aromatic heterocyclic mercapto compound represented by the following formula is preferred as a supersensitizer:

Ar—SM

wherein M is a hydrogen atom or an alkali metal atom; Ar is an aromatic ring or condensed aromatic ring containing a nitrogen atom, oxygen atom, sulfur atom, selenium atom or tellurium atom.

Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver halide grain emulsion is also included in the present invention. In particular, a preferred example thereof is a disulfide compound represented by the following formula:

Ar—S—S—Ar

wherein Ar is the same as defined in the mercapto compound represented by the formula described earlier.

The aromatic heterocyclic rings described above may be substituted with a halogen atom (e.g., Cl, Br, I), a hydroxy group, an amino group, a carboxy group, an alkyl group (having one or more carbon atoms, and preferably 1 to 4 carbon atoms) or an alkoxy group (having one or more carbon atoms, and preferably 1 to 4 carbon atoms).

In addition to the foregoing supersensitizers, there are usable heteroatom-containing macrocyclic compounds described in JP-A No. 2001-330918, as a supersensitizer.

The supersensitizer is incorporated into a light-sensitive layer containing organic silver salt and silver halide grains, preferably in an amount of 0.001 to 1.0 mol, and more preferably 0.01 to 0.5 mol per mol of silver.

It is preferred that a sensitizing dye is allowed to adsorb onto the surface of light-sensitive silver halide grains to achieve spectral sensitization and the spectral sensitization effect substantially disappears after being subjected to thermal development. The effect of spectral sensitization substantially disappearing means that the sensitivity of the photothermographic material which has been spectrally sensitized with a sensitizing dye and optionally a supersensitizer, is reduced, after thermal development, to not more than 1.1 times that of the photothermographic material which has not been spectrally sensitized.

To allow the effect of spectral sensitization to disappear, it is preferred to use a spectral sensitizing dye easily releasable from silver halide grains and/or to allow an oxidizing agent such as a halogen radical-releasing compound which is capable of decomposing a spectral sensitizing dye through an oxidation reaction to be contained in an optimum amount in the light-sensitive layer and/or the light-insensitive layer. The content of an oxidizing agent is adjusted in light of oxidizing strength of the oxidizing agent and its spectral sensitization effects.

### (Reducing Agent)

Reducing agents used in the present invention are those which can reduce silver ions in the light-sensitive layer, are also called a developer or a developing agent. A reducing agent usable in the present invention is preferably a compound represented by the following Formula (RD1) or its combined use with other reducing agents of different chemical formulas:

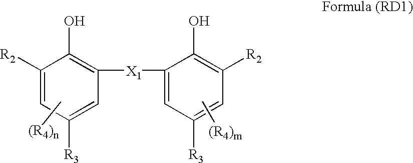

wherein X₁ is a chalcogen atom or CHR₁, in which R₁ is a hydrogen atom, a halogen atom, an alkyl group, an alkenyl group, an aryl group or a heterocyclic group; R₂ is an alkyl group, provided that both R₂s may be the same or different and at least one of them is a secondary or tertiary alkyl group; R₃ is a hydrogen atom or a group capable of being substituted on a benzene ring; R₄ is a group capable of being substituted on a benzene ring; m and n are each an integer of 0 to 2.

In the present invention, to control thermal development characteristics, the compound of Formula (RD1) can also be used in combination with a compound represented by the following Formula (RD2):

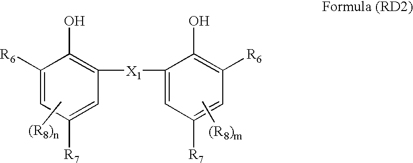

wherein X₂ represents a chalcogen atom or CHR₅ in which R₅ is a hydrogen atom, a halogen atom, an alkyl group, an alkenyl group, an aryl group or a heterocyclic group; both R₆s are alkyl groups, which may be the same or different, provided that R₆ is not a secondary or tertiary alkyl group; R₇ is a hydrogen atom or a group capable of being substituted on a benzene ring; R₈ is a group capable of being substituted on a benzene ring; m and n are each an integer of 0 to 2.

The mass ratio of [compound of Formula (RD1)]: [compound of Formula (RD2)] is preferably from 5:95 to 45:55, and more preferably from 10:90 to 40:60.

In the foregoing Formula (RD1), X₁ represents a chalcogen atom or CHR₁. Specifically, the chalcogen atom is a sulfur atom, a selenium atom, or a tellurium atom. Of these, a sulfur atom is preferred; R₁ in CHR₁, represents a hydrogen atom, a halogen atom, an alkyl group, an alkenyl group, an alkynyl group, an aryl group or a heterocyclic group. Halogen atoms include, for example, a fluorine atom, a chlorine atom, and a bromine atom. Alkyl groups are an alkyl groups having 1-20 carbon atoms and specific examples thereof include a methyl group, an ethyl group, a propyl group, a butyl group, a hexyl group, a heptyl group and a cycloalkyl group. Examples of alkenyl groups are, a vinyl group, an allyl group, a butenyl group, a hexenyl group, a hexadienyl group, an ethenyl-2-propenyl group, a 3-butenyl group, a 1-methyl-3-propenyl group, a 3-pentenyl group, a 1-methyl-3-butenyl group and a cyclohexenyl group. Examples of aryl groups are, a phenyl group and a naphthyl group. Examples of heterocyclic groups are, a thienyl group, a furyl group, an imidazolyl group, a pyrazolyl group and a pyrrolyl group.

These groups may have a substituent. Listed as the substituents are a halogen atom (for example, a fluorine atom, a chlorine atom, or a bromine atom), a cycloalkyl group (for example, a cyclohexyl group or a cyclobutyl group), a cycloalkenyl group (for example, a 1-cycloalkenyl group or a 2-cycloalkenyl group), an alkoxy group (for example, a methoxy group, an ethoxy group, or a propoxy group), an alkylcarbonyloxy group (for example, an acetyloxy group), an alkylthio group (for example, a methylthio group or a trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl group (for example, a methanesulfonyl group and a trifluoromethanesulfonyl group), a carbamoyl group (for example, a carbamoyl group, an N,N-dimethylcarbamoyl group, or an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamide group (for example, a methanesulfonamide group or a butanesulfonamide group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetamidocarbonyl group or a methoxyacetamidocarbonyl group), and an alkylsulfinylaminocarbonyl group (for example, a methanesulfinylaminocarbonyl group or an ethanesulfinylaminocarbonyl group). Further, when at least two substituents are present, they may be the same or different. Most preferred substituent is an alkyl group.

In the Formula (RD1), both R₂s are alkyl groups, which may be the same or different and at least one of the alkyl groups is a secondary or tertiary alkyl group. The alkyl groups are preferably those having 1 to 20 carbon atoms, which may be substituted or unsubstituted. Specific examples thereof include methyl, ethyl, i-propyl, butyl, i-butyl, t-butyl, t-pentyl, t-octyl, cyclohexyl, 1-methylcyclohexyl, or 1-methylcyclopropyl.

The alkyl groups each may be substituted. Substituents of the alkyl groups are not particularly limited and include, for example, an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom. In addition, (R₄)ₙ and (R₄)ₘ may form a saturated ring. Both R₂s are preferably a secondary or tertiary alkyl group and preferably has 2-20 carbon atoms, more preferably a tertiary alkyl group, still more preferably a t-butyl group, a t-amyl group, a t-pentyl group, or a 1-methylcyclohexyl group, and further still more preferably a t-butyl group or t-amyl.

R₃, represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group. R₃ is preferably methyl, ethyl, i-propyl, t-butyl, cyclohexyl, 1-methylcyclohexyl, 2-hydroxyethyl or 3-hydroxypropyl.

The foregoing groups may be substituted and examples of substituent are those as cited in the foregoing R₁.

In the Formula (RD1), both R₃s are alkyl groups, which may be the same or different, and at least one of the alkyl groups is an alkyl group having 1 to 20 carbon atoms and containing a hydroxyl group as a substituent or an alkyl group having 1 to 20 carbon atoms and containing, as a substituent, a group capable of forming a hydroxyl group upon deprotection, and preferably an alkyl group having 3 to 10 carbon atoms and containing a hydroxyl group or an alkyl group having 3 to 10 carbon atoms and containing a group capable of forming a hydroxyl group upon deprotection. An alkyl group having carbon atoms falling within the foregoing range can obtain an image exhibiting an average gradation of 2.0-6.0, which is suitable for diagnosis. R₃ is more preferably an alkyl group having 3 to 5 carbon atoms and containing a hydroxyl group. Specific examples of R₃ include 3-hydroxypropyl, 4-hydroxybutyl and 5-hydroxypentyl. These groups may be substituted and examples of a substituent are the same as cited in R₁.

The group capable of forming a hydroxyl group upon deprotection is a group which is a so-called protected hydroxyl group and is capable of being easily cleaved (or performing deprotection) by the action of acids and/or heat to form a hydroxyl group. Hereinafter, the group capable of forming a hydroxyl group upon deprotection is also called a precursor group of a hydroxyl group. Specific examples thereof include an ether group (e.g., methoxy, tert-butoxy, allyloxy, benzoyloxy, triphenylmethoxy, trimethylsilyloxy), a hemiacetal group (e.g., tetrahydropyranyloxy), an ester group (e.g., acetyloxy, benzoyloxy, p-nitrobenzoyloxy, formyloxy, trifluoroacetyloxy, pivaloyloxy), a carbonato group (e.g., ethoxycarbonyloxy, phenoxycarbonyloxy, tert-butyloxycarbonyloxy), a sulfonate group (e.g., p-toluenesulfonyloxy, benzenesulfonyloxy), a carbamoyloxy group (e.g., phenylcarbamoyloxy), a thiocarbonyloxy group (e.g., benzylthiocarbonyloxy), a nitric acid ester group, and a sulphenato group (e.g., 2,4-dinitrobenzenesulphenyloxy).

Specifically preferably, R₃ is a primary alkyl group of 3 to 5 carbon atoms which contains a hydroxyl group or its precursor group, for example, 3-hydroxypropyl. A specifically preferred combination of R₂ and R₃ is that R₂ is a tertiary alkyl group (for example, t-butyl, t-amyl, t-pentyl, 1-methylcyclohexyl) and R₃ is a primary alkyl group of 3 to 10 carbon atoms, containing a hydroxyl group or its precursor group (for example, 3-hydroxypropyl, 4-hydroxtbutyl). Plural R₂s or R₃s may be the same or different.

R₄ represents a group capable of being substituted on a benzene ring. Specific examples include an alkyl group having 1 to 25 carbon atoms (e.g., methyl, ethyl, propyl, i-propyl, t-butyl, pentyl, hexyl, or cyclohexyl), a halogenated alkyl group (e.g., trifluoromethyl or perfluorooctyl), a cycloalkyl group (e.g., cyclohexyl or cyclopentyl); an alkynyl group (e.g., propargyl), a glycidyl group, an acrylate group, a methacrylate group, an aryl group (e.g., phenyl), a heterocyclic group (e.g., pyridyl, thiazolyl, oxazolyl, imidazolyl, furyl, pyrrolyl, pyradinyl, pyrimidyl, pyridadinyl, selenazolyl, piperidinyl, sulforanyl, piperidinyl, pyrazolyl, or tetrazolyl), a halogen atom (e.g., chlorine, bromine, iodine or fluorine), an alkoxy group (e.g., methoxy, ethoxy, propyloxy, pentyloxy, cyclopentyloxy, hexyloxy, or cyclohexyloxy), an aryloxy group (e.g., phenoxy), an alkoxycarbonyl group (e.g., methyloxycarbonyl, ethyloxycarbonyl, or butyloxycarbonyl), an aryloxycarbonyl group (e.g., phenyloxycarbonyl), a sulfonamido group (e.g., methanesulfonamido, ethanesulfonamido, butanesulfonamido, hexanesulfonamido, cyclohexabesulfonamido, benzenesulfonamido), sulfamoyl group (e.g., aminosulfonyl, methyaminosulfonyl, dimethylaminosulfonyl, butylaminosulfonyl, hexylaminosulfonyl, cyclohexylaminosulfonyl, phenylaminosulfonyl, or 2-pyridylaminosulfonyl), a urethane group (e.g., methylureido, ethylureido, pentylureido, cyclopentylureido, phenylureido, or 2-pyridylureido), an acyl group (e.g., acetyl, propionyl, butanoyl, hexanoyl, cyclohexanoyl, benzoyl, or pyridinoyl), a carbamoyl group (e.g., aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (e.g., acetamide, propionamide, butaneamide, hexaneamide, or benzamide), a sulfonyl group (e.g., methylsulfonyl, ethylsulfonyl, butylsulfonyl, cyclohexylsulfonyl, phenylsulfonyl, or 2-pyridylsulfonyl), an amino group (e.g., amino, ethylamino, dimethylamino, butylamino, cyclopentylamino, anilino, or 2-pyridylamino), a cyano group, a nitro group, a sulfo group, a carboxyl group, a hydroxyl group, and an oxamoyl group. Further, these groups may further be substituted with these groups. Each of n and m represents an integer of from 0 to 2. However, the most preferred case is that both n and m are 0.

Further, R₄ may form a saturated ring together with R₂ and R₃. R₄ is preferably a hydrogen atom, a halogen atom, or an alkyl group, and is more preferably a hydrogen atom. Plural R₄s may be the same or different.

In Formula (RD2), R₅ is the same group as defined in R₁ and R₈ is the same group as defined in R₄. Both R₆s are an alkyl groups, which may be the same or different, and are not a secondary or tertiary alkyl group.

R₇ is a hydrogen atom or a group capable of being substituted on a benzene ring. Examples of a group capable of being substituted on a benzene ring include a halogen atom such as fluorine, chlorine, bromine or iodine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfinyl group, cyan group and a heterocycle group.

R₇ is preferably methyl, ethyl, I-propyl, t-butyl, cyclohexyl, 1-methylcyclohexyl, 2-hydroxyethyl, or 3-hydroxypropyl; and more preferably methyl or 3-hydroxypropyl.

The alkyl group is preferably substituted or unsubstituted one of 1-20 carbon atoms, and specific examples thereof include methyl, ethyl, propyl and butyl.

Substituents for the alkyl group are not specifically limited and examples thereof include an aryl group, hydroxyl, an alkoxy group, an aryloxy group, an alkylthio group, an arylthio group, an acylamino group, a sulfonamido group, a sulfonyl group, a phosphoryl group, an acyl group, a carbamoyl group, an ester group and a halogen atom.

R₆ may combine with (R₈)ₙ or (R₈)ₘ to form a saturated ring. R₆ is preferably methyl, which is most preferred compound of Formula (RD₂). The compounds are those which satisfy formula (S) and formula (T) described in European Patent No. 1,278,101, specifically, compounds (1-24), (1-28) to (1-54) and (1-56) to (1-75) are cited.

Specific examples of the compound of Formula (RD1) or (RD2) are shown below, however, the present invention is not limited thereto.

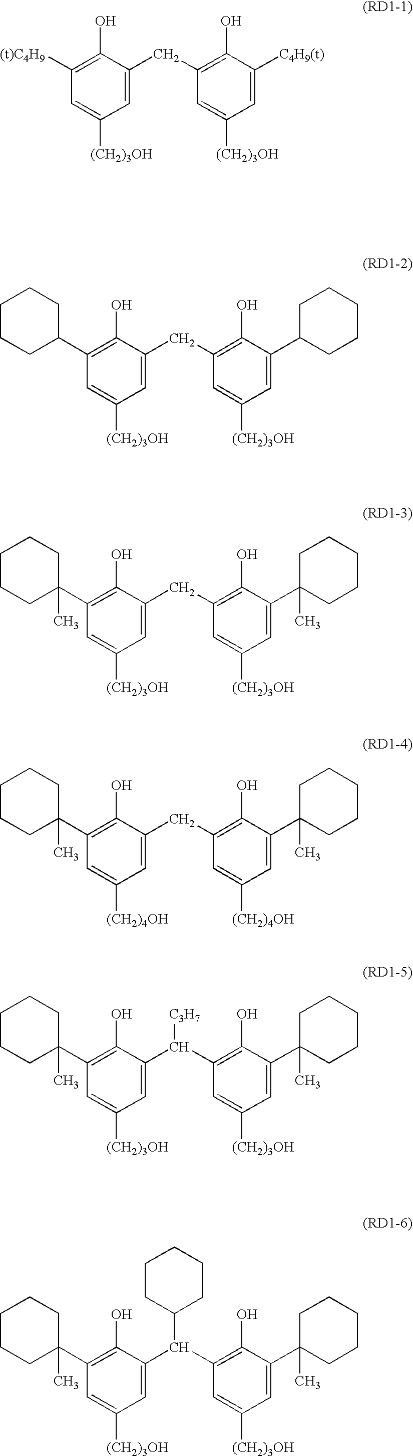

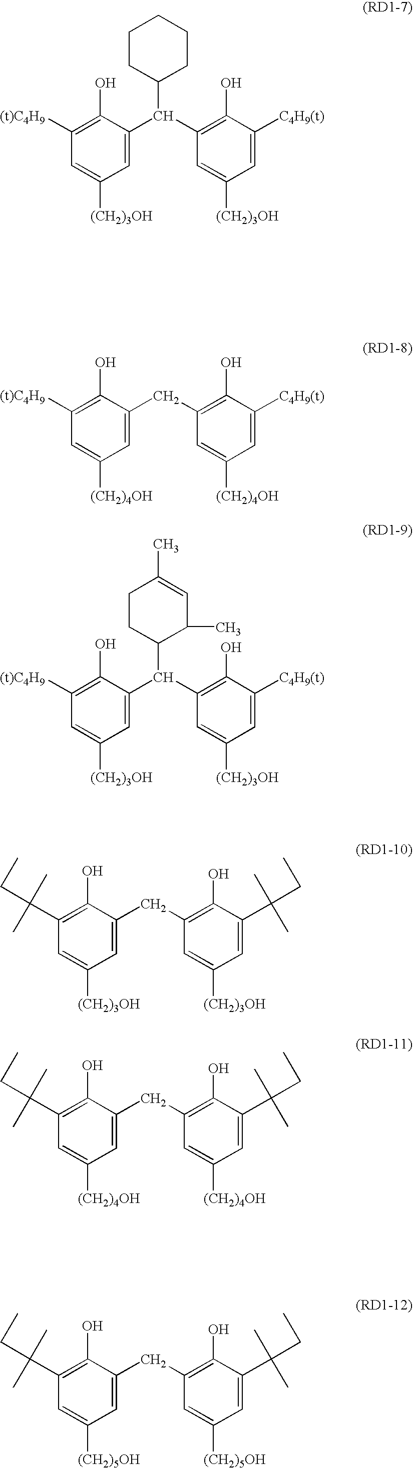

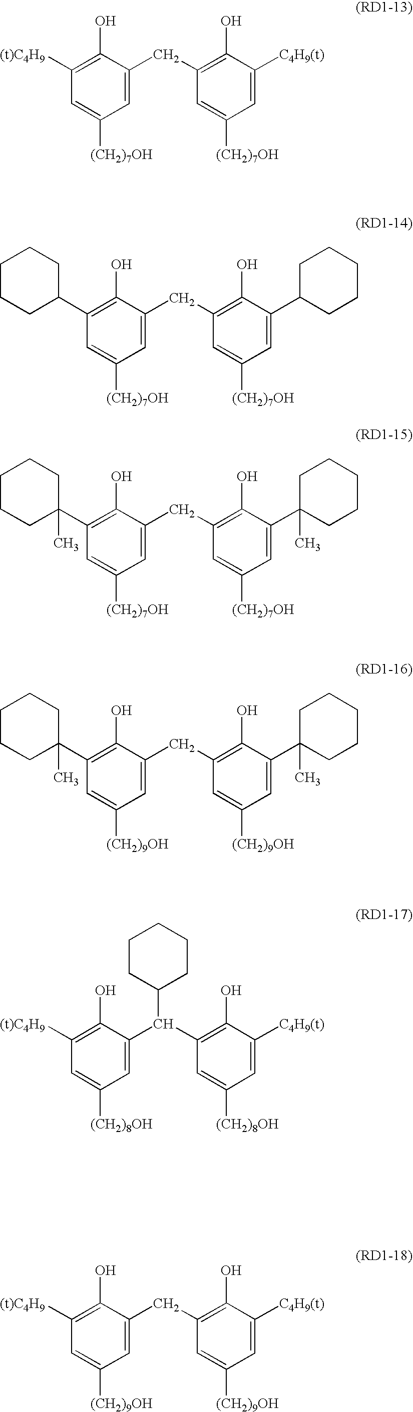

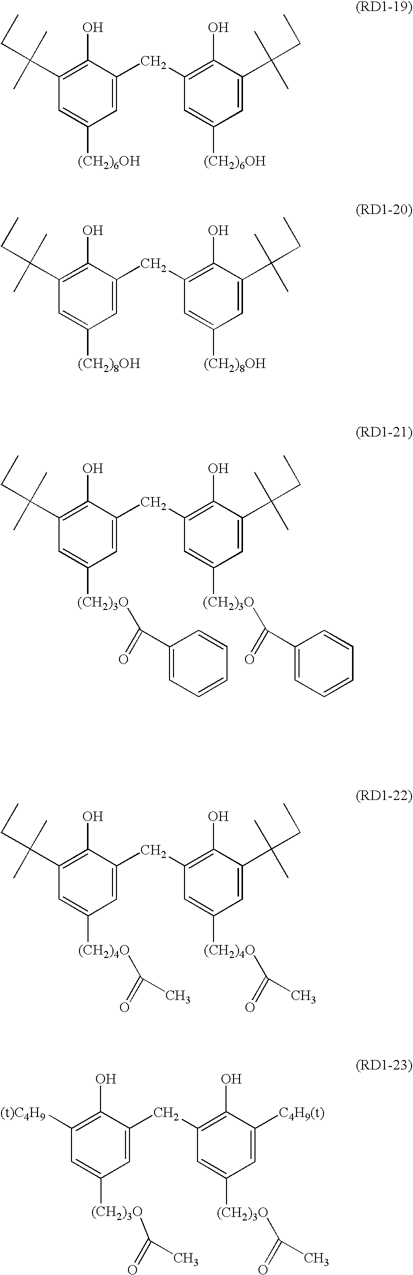

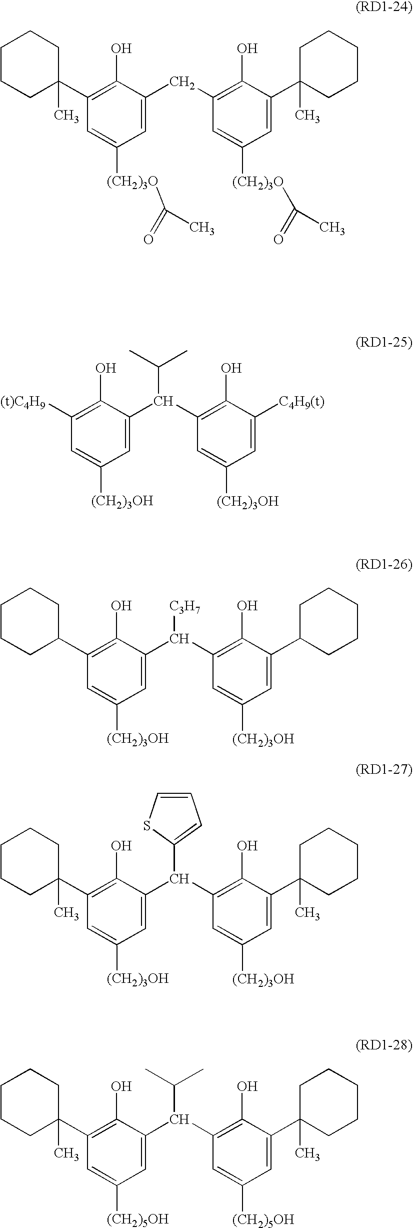

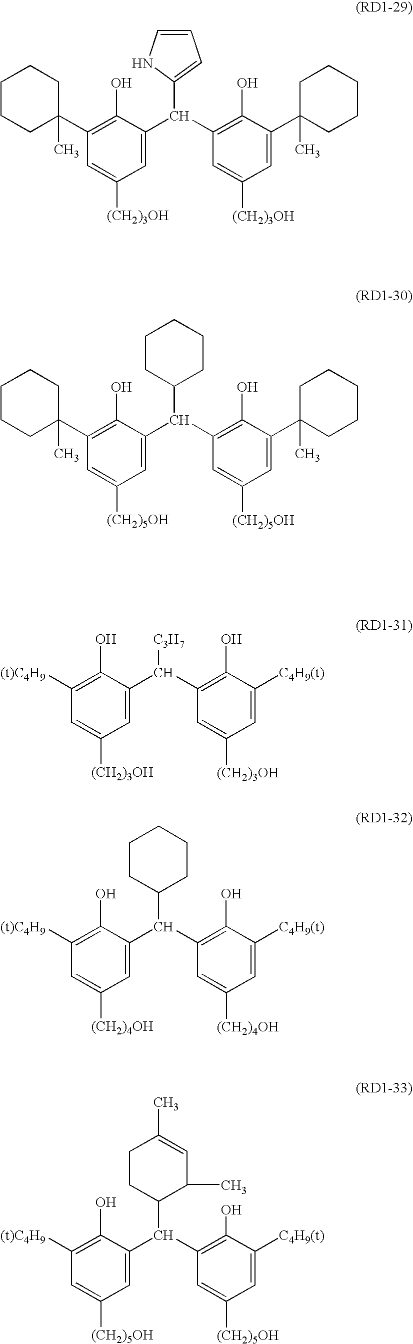

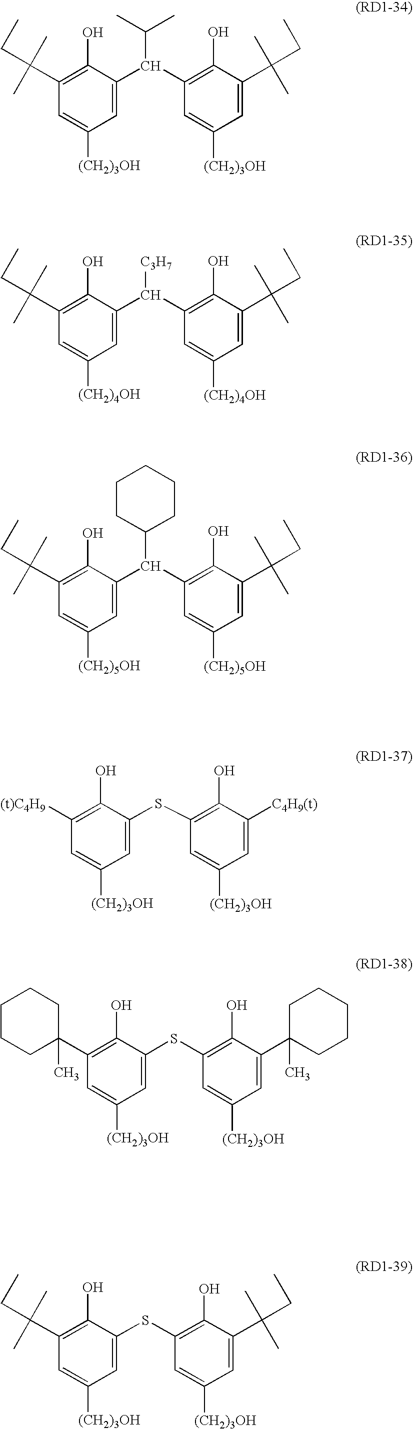

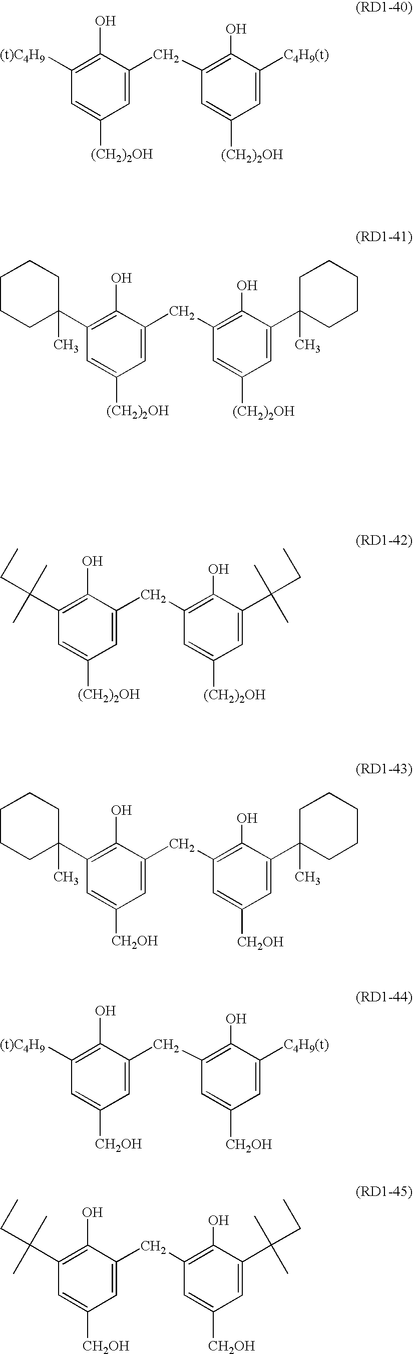

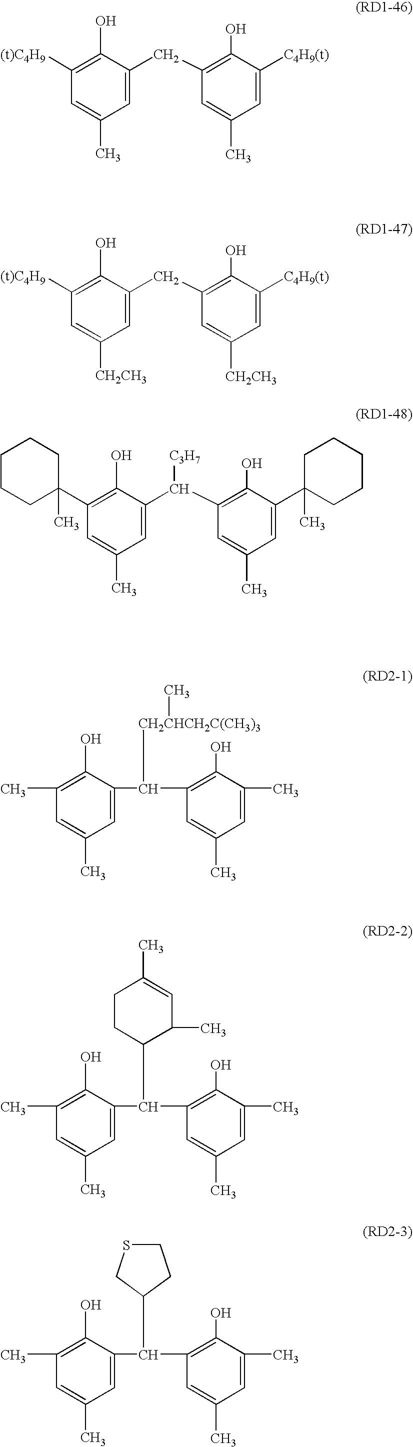

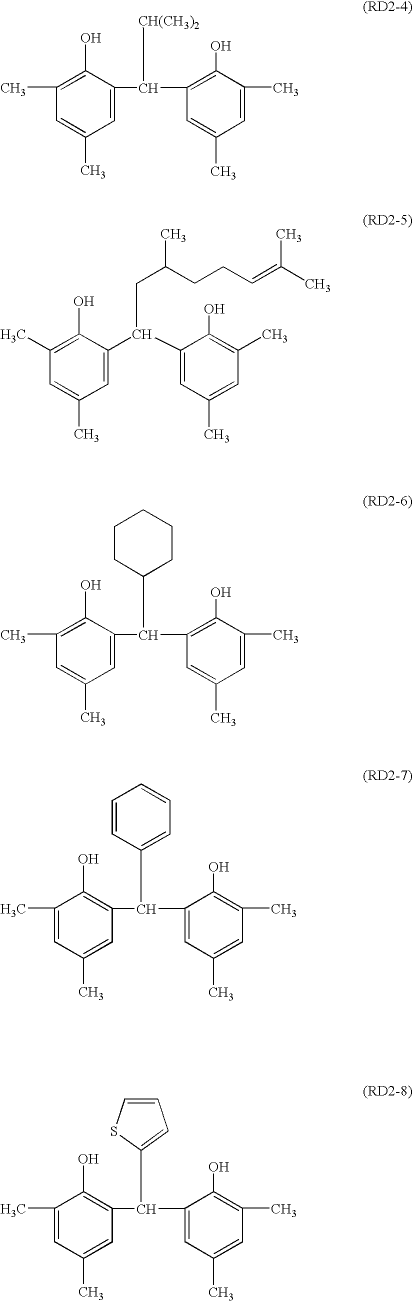

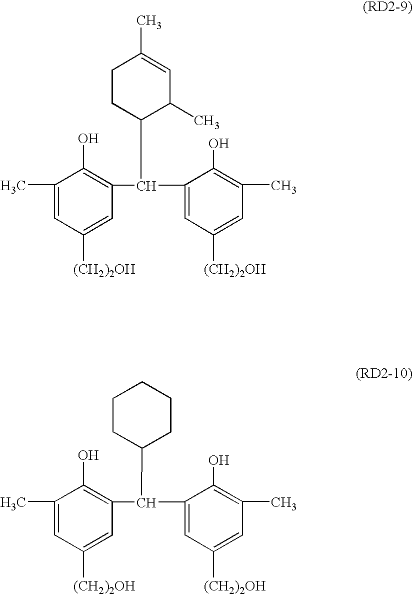

Bisphenol compounds of Formula (RD1) or (RD2) can readily be synthesized according to conventionally known methods.

Examples of reducing agents which are usable in combination with the reducing agent described above are described in U.S. Pat. Nos. 3,770,448, 3,773,512, and 3,593,863; RD 17029 and 29963; JP-A Nos. 11-119372 and 2002-62616.

Reducing agents including the compounds of Formula (RD1) are incorporated preferably in an amount of 1×10⁻² to 10 mol per mol of silver, and more preferably 1×10⁻² to 1.5 mol.

### Image Color

The color tone of images obtained by thermal development of the imaging material is described.

It has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown. The tone is more described below based on an expression defined by a method recommended by the Commission Internationale de l'Eclairage (CIE) in order to define more quantitatively.

“Colder tone” as well as “warmer tone”, which is terminology of image tone, is expressed, employing minimum density Dmin and hue angle hab at an optical density D of 1.0. The hue angle hab is obtained by the following formula, utilizing color specifications a* and b* of L*a*b* Color Space which is a color space perceptively having approximately a uniform rate, recommended by Commission Internationale de l'Eclairage (CIE) in 1976.

hab=tan⁻¹(b*/a*)

In the present invention, hab is preferably in the range of 180 degrees<hab<270 degrees, is more preferably in the range of 200 degrees<hab<270 degrees, and is most preferably in the range of 220 degrees<hab<260 degrees.

This finding is also disclosed in JP-A 2002-6463.

Incidentally, as described, for example, in JP-A No. 2000-29164, it is conventionally known that diagnostic images with visually preferred color tone are obtained by adjusting, to the specified values, u* and v* or a* and b* in CIE 1976 (L*u*v*) color space or (L*a*b*) color space near an optical density of 1.0. For example, it is disclosed in JP-A No. 2000-29164.

Extensive investigation was performed for the silver salt photothermographic material according to the present invention. As a result, it was discovered that when a linear regression line was formed on a graph in which in the CIE 1976 (L*u*v*) color space or the (L*a*b*) color space, u* or a* was used as the abscissa and v* or b* was used as the ordinate, the aforesaid material exhibited diagnostic properties which were equal to or better than conventional wet type silver salt light-sensitive materials by regulating the resulting linear regression line to the specified range. The condition ranges of the present invention will now be described.

(1) It is preferable that the coefficient of determination value R² of the linear regression line, which is made by arranging u* and v* in terms of each of the optical densities of 0.5, 1.0, and 1.5 and the minimum optical density, is also from 0.998 to 1.000.

The value v* of the intersection point of the aforesaid linear regression line with the ordinate is from −5 to +5; and gradient (v*/u*) is from 0.7 to 2.5.

(2) The coefficient of determination value (coefficient of multiple determination) R² of the linear regression line is from 0.998 to 1.000, which is formed in such a manner that each of optical density of 0.5, 1.0, and 1.5 and the minimum optical density of the aforesaid imaging material is measured, and a* and b* in terms of each of the above optical densities are arranged in two-dimensional coordinates in which a* is used as the abscissa of the CIE 1976 (L*a*b*) color space, while b* is used as the ordinate of the same. In addition, value b* of the intersection point of the aforesaid linear regression line with the ordinate is from −5 to +5, while gradient (b*/a*) is from 0.7 to 2.5.

A method for making the above-mentioned linear regression line, namely one example of a method for determining u* and v* as well as a* and b* in the CIE 1976 color space, will now be described.

By employing a thermal development apparatus, a 4-step wedge sample including an unexposed portion and optical densities of 0.5, 1.0, and 1.5 is prepared. Each of the wedge density portions prepared as above is determined employing a spectral chronometer (for example, CM-3600d, manufactured by Minolta Co., Ltd.) and either u* and v* or a* and b* are calculated. Measurement conditions are such that an F7 light source is used as a light source, the visual field angle is 10 degrees, and the transmission measurement mode is used. Subsequently, either measured u* and v* or measured a* and b* are plotted on the graph in which u* or a* is used as the abscissa, while v* or b* is used as the ordinate, and a linear regression line is formed, whereby the coefficient of determination value (coefficient of multiple determination) R² as well as intersection points and gradients are determined.

The specific method enabling to obtain a linear regression line having the above-described characteristics will be described below.

In the present invention, by regulating the added amount of the reducing agents (developing agents), silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver.

Usually, image toning agents such as phthalazinone or a combinations of phthalazine with phthalic acids, or phthalic anhydride are employed. Examples of suitable image toning agents are disclosed in Research Disclosure, Item 17029, and U.S. Pat. Nos. 4,123,282, 3,994,732, 3,846,136, and 4,021,249.

In the present invention, when rapid processing was performed using a compact laser image having a cooling section of a short length, it was proved that silver image tone was greatly different from preferable color. To overcome such a problem, conventional toning agents were insufficient and there were needed compounds capable of performing imagewise dye formation upon thermal development to form a dye image (e.g., leuco dyes or coupler compounds). As such a compound is preferable one capable of forming a dye image exhibiting an absorption peak at a wavelength of 360 to 450 nm upon thermal development or one capable of forming a dye image exhibiting an absorption peak at a wavelength of 600 to 700 nm upon thermal development. It is specifically preferred to contain both compounds to achieve superior image tone. Thus, it is preferable to control color tone employing couplers disclosed in JP-A No. 11-288057 and EP 1134611A2 as well as leuco dyes detailed below.

### (Leuco Dye)

The photothermographic material relating to the present invention can employ leuco dyes to control image tone, as described above. Leuco dyes are employed in the silver salt photothermographic materials relating to the present invention. There may be employed, as leuco dyes, any of the colorless or slightly tinted compounds which are oxidized to form a colored state when heated at temperatures of about 80 to about 200° C. for about 0.5 to about 30 seconds. It is possible to use any of the leuco dyes which are oxidized by silver ions to form dyes. Compounds are useful which are sensitive to pH and are oxidizable to a colored state.

Representative leuco dyes suitable for the use in the present invention are not particularly limited. Examples include bisphenol leuco dyes, phenol leuco dyes, indoaniline leuco dyes, acrylated azine leuco dyes, phenoxazine leuco dyes, phenodiazine leuco dyes, and phenothiazine leuco dyes. Further, other useful leuco dyes are those disclosed in U.S. Pat. Nos. 3,445,234, 3,846,136, 3,994,732, 4,021,249, 4,021,250, 4,022,617, 4,123,282, 4,368,247, and 4,461,681, as well as JP-A Nos. 50-36110, 59-206831, 5-204087, 11-231460, 2002-169249, and 2002-236334.

In order to control images to specified color tones, it is preferable that various color leuco dyes are employed individually or in combinations of a plurality of types. In the present invention, for minimizing excessive yellowish color tone due to the use of highly active reducing agents, as well as excessive reddish images especially at a density of at least 2.0 due to the use of minute silver halide grains, it is preferable to employ leuco dyes which change to cyan. Further, in order to achieve precise adjustment of color tone, it is further preferable to simultaneously use yellow leuco dyes and other leuco dyes which change to cyan.

It is preferable to appropriately control the density of the resulting color while taking into account the relationship with the color tone of developed silver itself. In the present invention, dye formation is performed so as to have a reflection density of 0.01 to 0.05 or a transmission density of 0.005 to 0.50, and the image tone is adjusted so as to form images exhibiting tone falling within the foregoing tone range. In the present invention, color formation is performed so that the sum of maximum densities at the maximum adsorption wavelengths of dye images formed by leuco dyes is customarily 0.01 to 0.50, is preferably 0.02 to 0.30, and is most preferably 0.03 to 0.10. Further, it is preferable that images be controlled within the preferred color tone range described below.

### (Yellow Dye Forming Leuco Dye)

In the present invention, particularly preferably employed as yellow forming leuco dyes are color image forming agents represented by the following Formula (YA) which increase absorbance between 360 and 450 nm via oxidation:

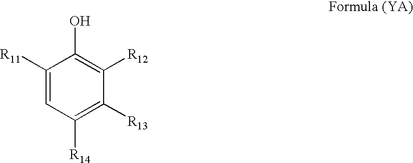

wherein R₁₁ is a substituted or unsubstituted alkyl group; R₁₂ is a hydrogen atom or a substituted or unsubstituted alkyl or acyl group, provided that R₁₁ and R₁₂ are not 2-hydroxyphenylmethyl; R₁₃ is a hydrogen atom or a substituted or unsubstituted alkyl group; R₁₄ is a group capable of being substituted on a benzene ring.

The compounds represented by Formula (YA) will now be detailed.

In the Formula (YA), R₁₁ is a substituted or unsubstituted alkyl group, provided that when R₁₂ is a substituent other than a hydrogen atom, R₁₁ is an alkyl group. In the foregoing Formula (YA), the alkyl groups represented by R₁ are preferably those having 1 to 30 carbon atoms, which may have a substituent.

Specifically preferred is methyl, ethyl, butyl, octyl, i-propyl, t-butyl, t-octyl, t-pentyl, sec-butyl, cyclohexyl, or 1-methyl-cyclohexyl. Groups (i-propyl, i-nonyl, t-butyl, t-amyl, t-octyl, cyclohexyl, 1-methyl-cyclohexyl or adamantyl) which are three-dimensionally larger than i-propyl are preferred. Of these, preferred are secondary or tertiary alkyl groups and t-butyl, t-octyl, and t-pentyl, which are tertiary alkyl groups, are particularly preferred. Examples of substituents which R₁ may have include a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group.

R₁₂ represents a hydrogen atom, a substituted or unsubstituted alkyl group, or an acylamino group. The alkyl group represented by R₂ is preferably one having 1-30 carbon atoms, while the acylamino group is preferably one having 1-30 carbon atoms. Of these, description for the alkyl group is the same as for aforesaid R11₁.

The acylamino group represented by R₂ may be unsubstituted or have a substituent. Specific examples thereof include an acetylamino group, an alkoxyacetylamino group, and an aryloxyacetylamino group. R₁₂ is preferably a hydrogen atom or an unsubstituted group having 1 to 24 carbon atoms, and specifically listed are methyl, i-propyl, and t-butyl. Further, neither R₁ nor R₂ is a 2-hydroxyphenylmethyl group.

R₁₃ represents a hydrogen atom, and a substituted or unsubstituted alkyl group. Preferred as alkyl groups are those having 1 to 30 carbon atoms. Description for the above alkyl groups is the same as for R₁₁. Preferred as R₁₃ are a hydrogen atom and an unsubstituted alkyl group having 1 to 24 carbon atoms, and specifically listed are methyl, i-propyl and t-butyl. It is preferable that either R₁₂ or R₁₃ represents a hydrogen atom.

R₁₄ represents a group capable of being substituted to a benzene ring, and represents the same group as described for substituent R₄, for example, in aforesaid Formula (RD1). R₄ is preferably a substituted or unsubstituted alkyl group having 1 to 30 carbon atoms, as well as an oxycarbonyl group having 2 to 30 carbon atoms. The alkyl group having 1 to 24 carbon atoms is more preferred. As substituents of the alkyl group are cited an aryl group, an amino group, an alkoxy group, an oxycarbonyl group, an acylamino group, an acyloxy group, an imido group, and a ureido group. Of these, more preferred are an aryl group, an amino group, an oxycarbonyl group, and an alkoxy group. The substituent of the alkyl group may be substituted with any of the above alkyl groups.

Among the compounds represented by the foregoing Formula (YA), preferred compounds are bis-phenol compounds represented by the following Formula (YB):

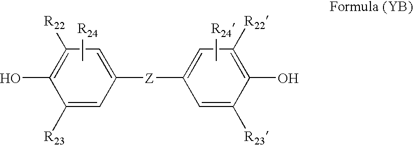

wherein, Z represents a —S— or —C(R₂₁) (R_{21′})— group. R₂₁ and R_{21′} each represent a hydrogen atom or a substituent.

The substituents represented by R₂₁ and R_{21′} are the same substituents listed for R₂₁ in the aforementioned Formula (RD1). R₂₁ and R_{21′} are preferably a hydrogen atom or an alkyl group.

R₂₂, R₂₃, R₂₂′ and R₂₃′ each represent a substituent. The substituents represented by R₂₂, R₂₃, R₂₂′ and R₂₃′ are the same substituents listed for R₂ and R₃ in the afore-mentioned Formula (RD1).

R₂₂, R₂₂, R₂₂′ and R₂₃′ are preferably, an alkyl group, an alkenyl group, an alkynyl group, an aryl group, a heterocyclic group, and more preferably, an alkyl group. Substituents on the alkyl group are the same substituents listed for the substituents in the aforementioned Formula (RD1).

R₂₂, R₂₃, R₂₂′ and R₂₃′ are more preferably tertiary alkyl groups such as t-butyl, t-amino, t-octyl and 1-methyl-cyclohexyl.

R₂₄ and R_{24′} each represent a hydrogen atom or a substituent, and the substituents are the same substituents listed for R₄ in the afore-mentioned Formula (RD1).

Examples of the bis-phenol compounds represented by the Formulas (YA) and (YB) are, the compounds disclosed in JP-A No. 2002-169249, Compounds (II-1) to (II-40), paragraph Nos. [0032]-[0038]; and EP 1211093, Compounds (ITS-1) to (ITS-12), paragraph No. [0026].

Specific examples of bisphenol compounds represented by Formulas (YA) and (YB) are shown below.

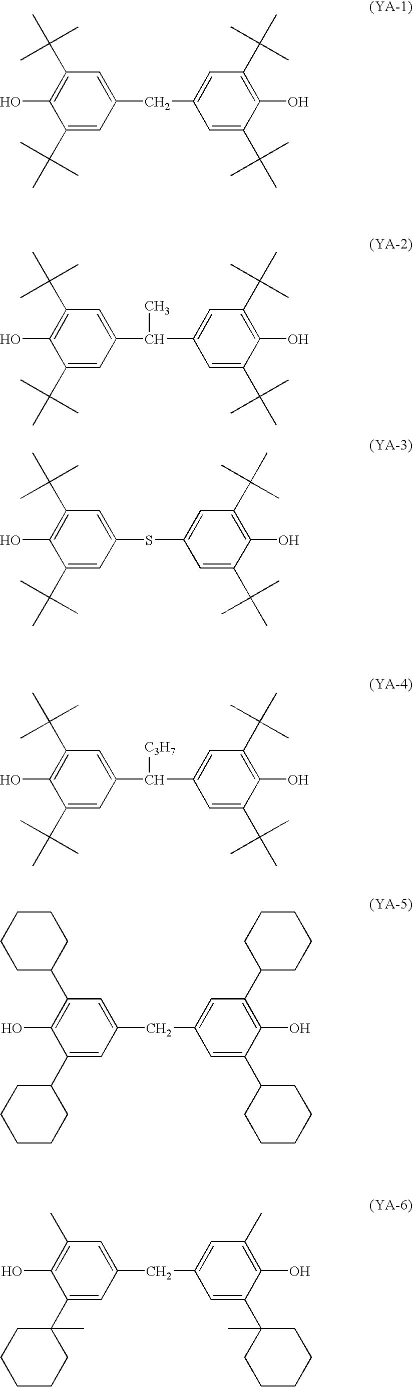

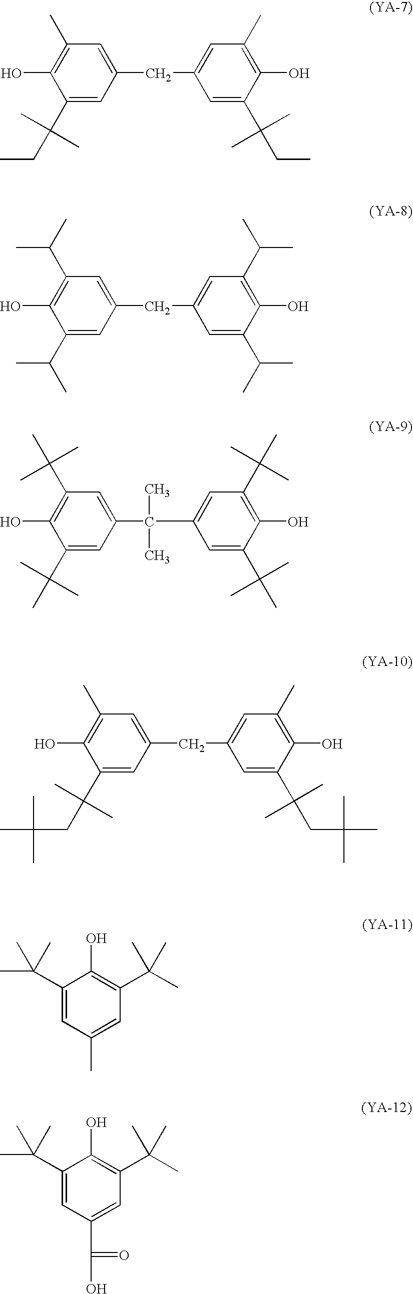

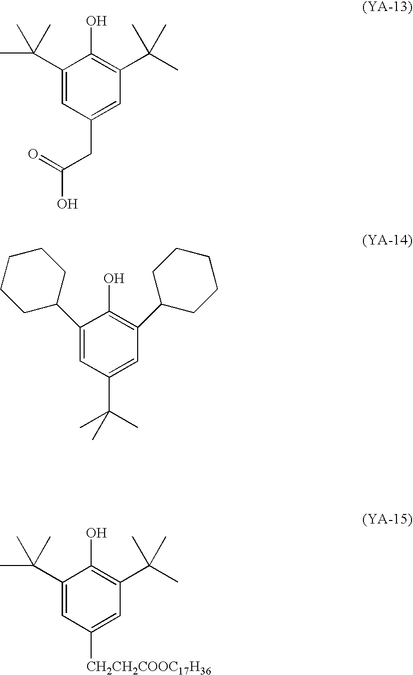

An amount of an incorporated compound represented by Formula (YA), which is hindered phenol compound and include compound of Formula (YB), is; usually, 0.00001 to 0.01 mol, and preferably, 0.0005 to 0.01 mol, and more preferably, to 0.008 mol per mol of Ag.

A yellow dye forming leuco dye is incorporated preferably in a molar ratio of 0.00001 to 0.2, and more preferably 0.005 to 0.1, based on the total amount of reducing agents of Formulas (RD1) and (RD2). In the photothermographic material of the present invention, the sum of the maximum density at the wavelength of maximum absorption of the dye image formed of a yell dye-forming leuco dye is preferably from 0.01 to 0.50, more preferably from 0.02 to 0.30, and still more preferably from 0.03 to 0.10.

### (Cyan Dye Forming Leuco Dye)

Besides the foregoing yellow dye forming leuco dyes, cyan dye forming leuco dyes are also usable in a photothermographic material to control image tone.

Cyan dye forming leuco dyes will be described hereinafter. A leuco dye is preferably a colorless or slightly colored compound which is capable of forming color upon oxidation when heated at 80 to 200° C. for 5 to 30 sec. There is also usable any leuco dye capable of forming a dye upon oxidation by silver ions. A compound which is sensitive to pH and being oxidized to a colored form.

Cyan dye forming leuco dyes will now be described. In the present invention, particularly preferably employed as cyan forming leuco dyes are color image forming agents which increase absorbance between 600 and 700 nm via oxidation, and include the compounds described in JP-A No. 59-206831 (particularly, compounds of λmax in the range of 600 to 700 nm), compounds represented by formulas (I) through (IV) of JP-A No. 5-204087 (specifically, compounds (1) through (18) described in paragraphs [0032] through [0037]), and compounds represented by formulas 4-7 (specifically, compound Nos. 1 through 79 described in paragraph [0105]) of JP-A No. 11-231460.

Specific examples of a cyan dye forming leuco dye will be shown below, however, the present invention is not limited thereto.

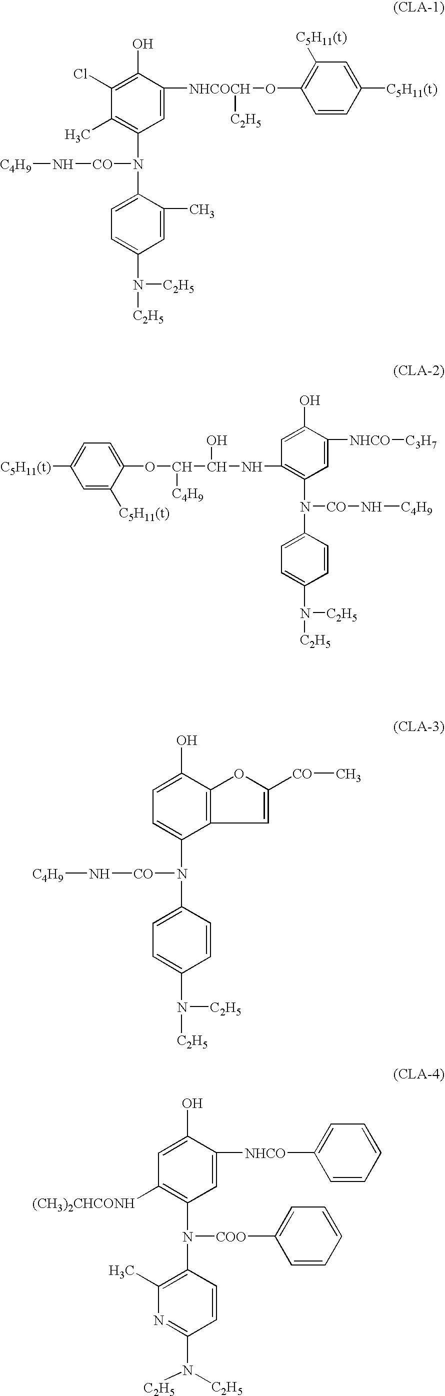

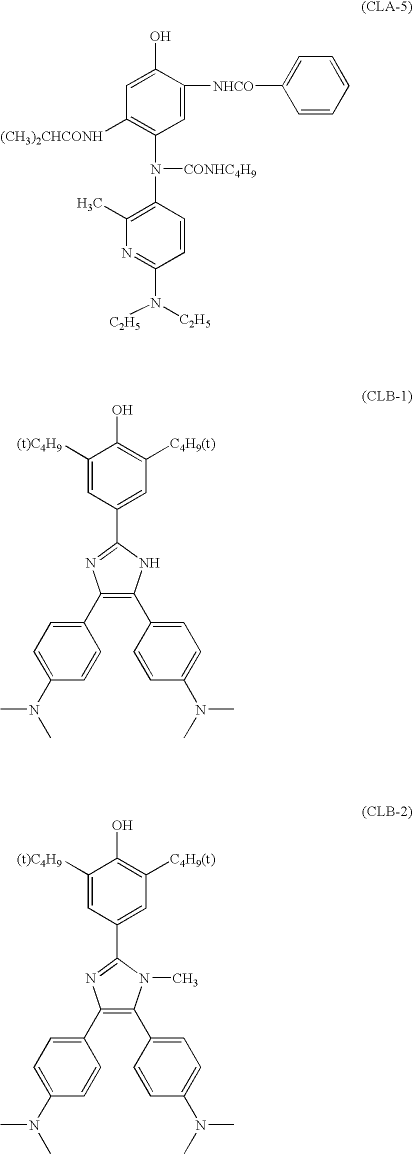

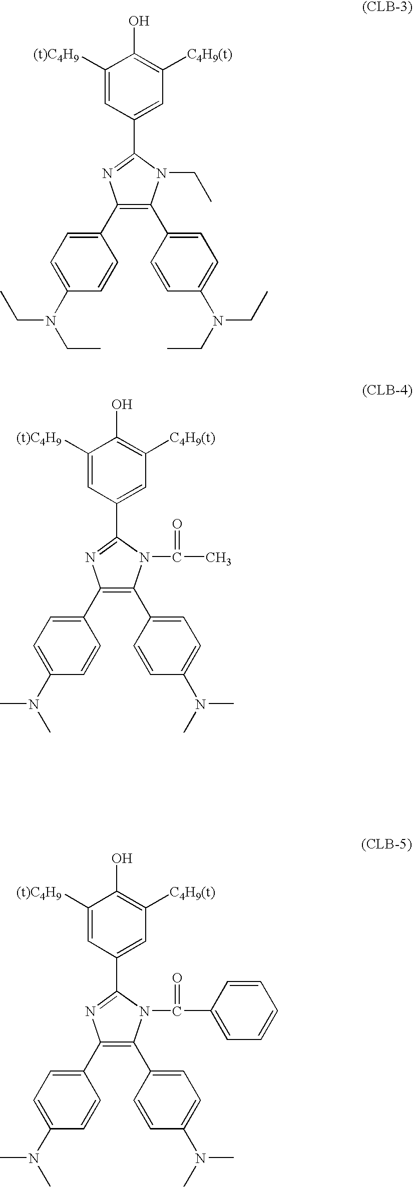

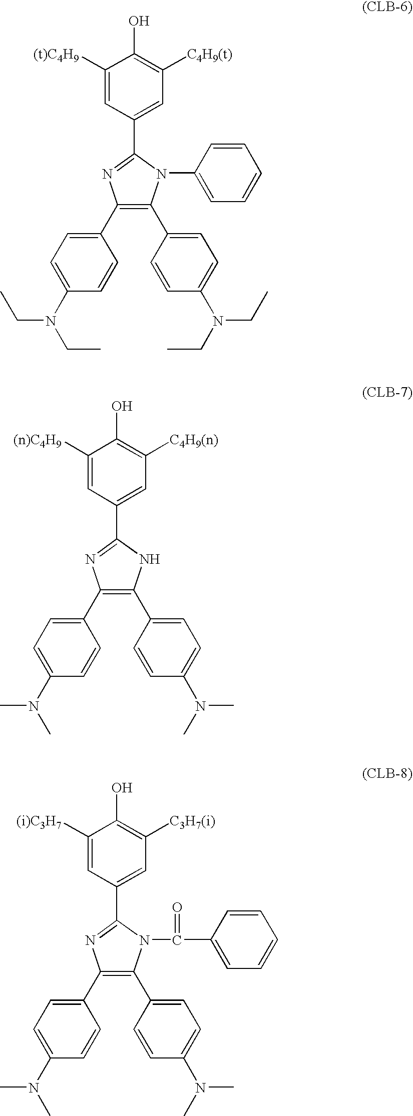

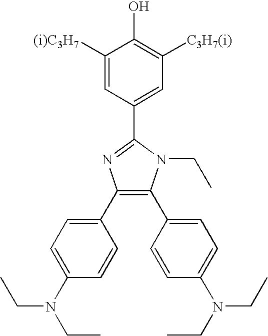

The addition amount of cyan forming leuco dyes is usually 0.00001 to 0.05 mol/mol of Ag, preferably 0.0005 to 0.02 mol/mol, and more preferably 0.001 to 0.01 mol. A cyan forming leuco dye is incorporated preferably in a molar ratio of 0.001 to 0.2, and more preferably 0.005 to 0.1, based on the total amount of reducing agents of Formulas (RD1) and (RD2).

The cyan dye is preferably formed so that the sum of the maximum density at the absorption maximum of a color image formed by a cyan forming leuco dye is preferably 0.001 to 0.2, more preferably 0.02 to 0.30, and still more preferably 0.03 to 0.10.

In addition to the foregoing cyan forming leuco dye, magenta color forming leuco dyes or yellow color forming leuco dyes may be used to control delicate color tone.

The compounds represented by the foregoing Formulas (YA) and (YB) and cyan forming leuco dyes may be added employing the same method as for the reducing agents represented by the foregoing Formula (RD1). They may be incorporated in liquid coating compositions employing an optional method to result in a solution form, an emulsified dispersion form, or a minute solid particle dispersion form, and then incorporated in a light-sensitive material.

It is preferable to incorporate the compounds represented by Formulas (RD1) and (RD2), Formulas (YA) and (YB), and cyan forming leuco dyes into an light-sensitive layer containing organic silver salts. On the other hand, the former may be incorporated in the light-sensitive layer, while the latter may be incorporated in a light-insensitive layer adjacent to the aforesaid light-sensitive layer. Alternatively, both may be incorporated in the light-insensitive layer. Further, when the light-sensitive layer is comprised of a plurality of layers, incorporation may be performed for each of the layers.

### (Binder)

The photothermographic material of the present invention may contain a binder in the light-sensitive layer or the light-insensitive layer.

Suitable binders for the silver salt photothermographic material are to be transparent or translucent and commonly colorless, and include natural polymers, synthetic resin polymers and copolymers, as well as media to form film, for example, those described in paragraph [0069] of JP-A No. 2001-330918.

Preferable binders for the light-sensitive layer of the photothermographic material of the present invention are poly(vinyl acetals), and a particularly preferable binder is poly(vinyl butyral), which will be detailed hereunder.

Polymers such as cellulose esters, especially polymers such as triacetyl cellulose, cellulose acetate butyrate, which exhibit higher softening temperature, are preferable for an over-coating layer as well as an subbing layer, specifically for a light-insensitive layer such as a protective layer and a backing layer. Incidentally, if desired, the binders may be employed in combination of at least two types.

The binder preferably introduces at least a polar group chosen from —COOM, —SO₃M, —OSO₃M, —P═O(OM)₂, —O—P═O(OM)₂, —N(R)₂, —N⁺(R)₃, (in which M is a hydrogen atom, an alkali metal base or a hydrocarbon group), epoxy group, —SH, and —CN in the stage of copolymerization or addition reaction. Of these, —SO₃M or —OSO₃M is preferred. The content of a polar group is in the range of 1×10⁻⁸ to 1×10⁻¹ mol/g, and preferably 1×10⁻⁶ to 1×10⁻² mol/g.

Such binders are employed in the range of a proportion in which the binders function effectively.

Skilled persons in the art can easily determine the effective range. For example, preferred as the index for maintaining aliphatic carboxylic acid silver salts in a light-sensitive layer is the proportion range of binders to aliphatic carboxylic acid silver salts of 15:1 to 1:2 (in mass ratio) and most preferably of 8:1 to 1:1. Namely, the binder amount in the light-sensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In the present invention, it is preferable that thermal transition point temperature (Tg) is preferably from 70 to 105° C. Thermal transition point temperature (Tg) can be measured by a differential scanning calorimeter, in which the crossing point of the base line and a slope of the endothermic peak is defined as Tg.

The glass transition temperature (Tg) is determined employing the method, described in Brandlap et al., “Polymer Handbook”, pages III-139 to III-179, 1966 (published by Wiley and Son Co.).

The Tg of the binder composed of copolymer resins is obtained based on the following formula:

Tg of the copolymer (in ° C.)=v₁Tg₁+v₂Tg₂+ . . . +vₙTgₙ wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer. The accuracy of Tg, calculated based on the formula calculation, is ±5° C.

The use of a binder exhibiting a Tg of 70 to 105° C. can achieve sufficient maximum density in the image formation.

Binders usable in the present invention exhibit a Tg of 70 to 105° C., a number-average molecular weight of 1,000 to 1,000,000 (preferably 10,000 to 500,000) and a polymerization degree of 50 to 1,000. Polymer containing ethylenically unsaturated monomer as a constitution unit and its copolymer are those described in JP-A No. 2001-330918, paragraph

Of these, preferred examples thereof include methacrylic acid alkyl esters, methacrylic acid aryl esters, and styrenes. Polymer compounds containing an acetal group are preferred among polymer compounds. Of such polymer compounds containing an acetal group, polyvinyl acetal having an acetal structure is preferred, including, for example, polyvinyl acetal described in U.S. Pat. Nos. 2,358,836, 3,003,879 and 2,828,204; and British Patent No. 771,155.

Further, The polymer compound containing an acetal group is also preferably a compound represented by formula (V) described in JP-A no. 2002-287299, paragraph [150].

There are usable in the present invention commonly known polyurethane resins, such as a polyester-polyurethane, polyether-polyurethane, polyether-polyester polyurethane, polycarbonate-polyurethane, polyester-polycarbonate polyurethane, or polycaprolactone-polyurethane. Polyurethane preferably contains at least one hydroxyl group at each of both ends of the molecule, i.e., at least two hydroxyl group in total. The hydroxyl group cross-links polyisocyanate as a hardener to form a network structure so that it is preferred to contain hydroxyl groups as many as possible. Specifically, a hydroxyl group existing at the end of the molecule exhibits enhanced reactivity with a hardener. Polyurethane contains preferably at least three (more preferably at least four) hydroxyl groups at the end of the molecule. When polyurethane is employed, the polyurethane preferably has a glass transition temperature of 70 to 105° C., a breakage elongation of 100 to 2,000 percent, and a breakage stress of 0.5 to 100 M/mm².

The foregoing polymeric compounds (or polymers) may be used singly or plural polymers may be blended.

The foregoing polymer is preferably used as a main binder in the light-sensitive layer. The main binder means that at least 50% by mass of the whole binder in the light-sensitive layer is accounted for by the foregoing polymer. Accordingly, other polymers may be blended within the range of less than 50% by mass of the whole binder. Such polymers are not specifically limited when using a solvent in which the main polymer is soluble. Preferred examples thereof include polyvinyl acetate, acryl resin and urethane resin.

The light-sensitive layer may contain an organic gelling agent. The organic gelling agent refers to a compound which provides its system a yield point when incorporated to organic liquid and having a function of disappearing or lowering fluidity.

In one preferred embodiment of the present invention, a coating solution for the light-sensitive layer contains an aqueous-dispersed polymer latex. The aqueous-dispersed polymer latex accounts for preferably at least 50% by mass of the whole binder of the coating solution. The polymer latex preferably accounts for at least 50% by mass of the whole binder of the light-sensitive layer, and more preferably at least 70% by mass.

The polymer latex is a dispersion in which a water-insoluble hydrophobic polymer is in the form of minute particles dispersed in aqueous dispersing medium. The polymer may be dispersed in any form, such as being emulsified in the dispersing medium, being emulsion-polymerized, being dispersed in the form of micelles or a polymer partially having a hydrophilic structure in the molecule and its molecular chain being molecularly dispersed. The average diameter of dispersed particles is preferably 1 to 50,000 nm, and more preferably 5 to 1,000 nm. The particle diameter distribution of the dispersed particles is not specifically limited and may be one having a broad distribution or a monodisperse distribution.

Polymer latex usable in the photothermographic material of the present invention may be not only conventional polymer latex having a uniform structure but also a so-called core/shell type latex. In this regard, core and shell differing in Tg, are occasionally preferred. The minimum film-forming temperature (MFT) of a polymer latex relating to the present invention is preferably from −30 to 90° C., and more preferably 0 to 70° C. There may be added a film-forming aid to control the minimum film-forming temperature.

The film-forming aid is also called a plasticizer and an organic compound (usually, organic solvent) which lowers the minimum film-forming temperature, as described in S. Muroi “Gosei Latex no Kagaku” (Chemistry of Synthetic Latex) Kobunshi Kankokai, 1970.

Polymer species used in polymer latex include, for example, acryl resin, vinyl acetate resin, polyester resin, polyurethane resin, rubber type resin, vinyl chloride resin, vinylidene chloride resin, polyolefin resin and their copolymers. The polymer may be a straight chained or branched polymer, or may be cross-linked. The polymer may be a homopolymer comprised of a single monomer or a copolymer comprised of at least two monomers. Copolymer may be a random copolymer or a block copolymer. The polymer molecular weight is usually from 5,000 to 1,000,000, and preferably 10,000 to 100,000 in terms of number-average molecular weight. An excessively small molecular weight results in insufficient mechanical strength and an excessively large one results in deteriorated film-forming capability.

The equilibrium moisture content of a polymer latex is preferably from 0.01% to 2% by mass at 25° C. and 60% RH (relative humidity), and more preferably 0.01% to 1%. The definition and measurement of the equilibrium moisture content is referred to, for example, “Kobunshi-Kogaku Koza 14, Kobunshi-Shikenho” (edited by Kobunshi Gakkai, Chijin Shoin).

Specific examples of polymer latex include those described in JP-A No. 2002-287299, {0173}. These polymers may be used singly or in their combination as a blend. A carboxylic acid component as a polymer specie, such as an acrylate or methacrylate component, is contained preferably in an amount of 0.1 to 10% by mass.

A hydrophilic polymer such as gelatin, polyvinyl alcohol, methyl cellulose, hydroxypropyl cellulose, carboxymethyl cellulose, or hydroxypropyl cellulose may optionally be incorporated within the range of not more than 50% by mass of the whole binder. The hydrophilic polymer content is preferably not more than 30% by mass of the light-sensitive layer.

In the preparation of a coating solution for the light-sensitive layer, an organic silver salt and an aqueous-dispersed polymer latex may be added in any order. Thus, either one may be added at first or both may be added simultaneously, but the polymer latex is added preferably later.

Before adding a polymer latex, an organic silver salt is added and then a reducing agent is preferably mixed. Aging a mixture of an organic silver salt and a polymer latex at an excessively low temperature results in deteriorated coated layer surface, and aging at an excessively high temperature leads to increased fogging. After mixing, the coating solution is aged preferably at a temperature of 30 to 65° C., more preferably 35 to 60° C., and still more preferably 35 to 55° C.

The coating solution for the light-sensitive layer, after mixing an organic silver salt and an aqueous-dispersed polymer latex, is coated preferably after 30 min. to 24 hr., more preferably after 60 min. to 10 hr., and still more preferably after 120 min. to 10 hr.

The expression “after mixing” means that an organic silver salt and aqueous-dispersed polymer latex are added and additive materials have been homogeneously dispersed.

### (Cross-Linking Agent)

The light-sensitive layer may contains cross-linking agents capable of binding binder molecules through cross linking. It is known that employing cross-linking agents in the aforesaid binders minimizes uneven development, due to the improved adhesion of the layer to the support. In addition, it results in such effects that fogging during storage is minimized and the creation of printout silver after development is also minimized.

There may be employed, as cross-linking agents used in the present invention, various conventional cross-linking agents, which have been employed for silver halide light-sensitive photographic materials, such as aldehyde type, epoxy type, ethyleneimine type, vinylsulfone type, sulfonic acid ester type, acryloyl type, carbodiimide type, and silane compound type cross-linking agents, which are described in JP-A No. 50-96216. Of these, isocyanate type compounds, silane type compounds, epoxy type compounds and acid anhydride are preferred.

The aforesaid isocyanate based cross-linking agents are isocyanates having at least two isocyanate groups and adducts thereof. Specific examples thereof include aliphatic isocyanates, aliphatic isocyanates having a ring group, benzene diisocyanates, naphthalene diisocyanates, biphenyl isocyanates, diphenylmethane diisocyanates, triphenylmethane diisocyanates, triisocyanates, tetraisocyanates, and adducts of these isocyanates and adducts of these isocyanates with dihydric or trihydric alcohols. Employed as specific examples may be isocyanate compounds described on pages 10 through 12 of JP-A No. 56-5535.

Incidentally, adducts of an isocyanate with a polyalcohol are capable of markedly improving the adhesion between layers and further of markedly minimizing layer peeling, image dislocation, and air bubble formation. Such isocyanates may be incorporated in any portion of the silver salt photothermographic material. They may be incorporated in, for example, a support (particularly, when the support is paper, they may be incorporated in a sizing composition), and optional layers such as a light-sensitive layer, a surface protective layer, an interlayer, an antihalation layer, and a subbing layer, all of which are placed on the light-sensitive layer side of the support, and may be incorporated in at least two of the layers.

Further, as thioisocyanate based cross-linking agents usable in the present invention, compounds having a thioisocyanate structure corresponding to the isocyanates are also useful as thioisocyanate based cross-linking agents usable in the present invention.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have only one functional group.

Examples of silane compounds which can be employed as a cross-linking agent in the present invention are compounds represented by General formulas (1) to (3), described in JP-A No. 2001-264930.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Acid anhydrides usable in the present invention are compounds containing at least one acid anhydride group having a structure, as shown below. The number of acid anhydride group, molecular weight, for example, of the acid anhydride usable in the present invention is not specifically limited, provided that the compound has at least an acid anhydride group.

—CO—O—CO—.

Any compound containing such at least one acid anhydride group is not limited with respect to the number of acid anhydride groups, molecular weight and others.

The foregoing epoxy compounds or acid anhydrides may be used singly or in combination. The addition amount is preferably 1×10⁻⁶ to 1×10⁻² mol/m², and more preferably 1×10⁻⁵ to 1×10⁻³ mol/m². The epoxy compounds or acid anhydrides may be incorporated into any layer of the light-sensitive layer side, such as a light-sensitive layer, surface protective layer, an interlayer, an antihalation layer or a sublayer. The compounds may be incorporated into one or more of these layers.

### (Silver Saving Agent)

A silver saving agent may be incorporated to the light-sensitive or light-insensitive layer. The silver saving agent refers to a compound which is capable of lessen a silver amount necessary to obtain a prescribed silver image density.

Various mechanisms of working have been assumed with respect to function of lessen the silver amount but a compound capable of enhancing covering power of developed silver is preferred. The covering power of developed silver refers to an optical density per unit amount of silver. Silver saving agents may be incorporated to a light-sensitive layer or a light-insensitive layer, or to both layers. Examples of a silver saving agent include a hydrazine derivative compound, a vinyl compound, a phenol derivative compound, a naphthol compound, a quaternary onium compound and a silane compound.

Specific examples of the hydrazine derivative include compounds H-1 through H-29 described in U.S. Pat. No. 5,545,505, col. 1-20; compounds 1 through 12 described in U.S. Pat. No. 5,464,738, col. 9-11; and compounds H 1-1 through H 1-28, H 2-1 through H 2-9, H 3-1 through H-3-12, H 4-1 through H 4-21, and H-5-1 through H-5-5, described in JP-A No. 2001-27790.

Specific examples of the vinyl compound include compounds CN-01 through CN-13, described in U.S. Pat. No. 5,545,515, col. 13-14; compounds HET-01 through HET-02, described in U.S. Pat. No. 5,635,339, col. 10; compounds MA-01 through MA-07, described in U.S. Pat. No. 5,654,130, col. 9-10; compounds IS-01 through IS-04, described in U.S. Pat. No. 5,705,324, col. 9-10; and compounds 1-1 through 218-2, described in JP-A No. 2001-125224.

Specific examples of phenol derivatives and naphthol derivatives include compounds A-1 through A-89 described in JP-A No. 2000-267222, paragraph [0075]-[0078]; compounds A-1 through A-258 described in JP-A No. 2003-66558, paragraph [0025]-[0045].

Specific examples of the onium compound include triphenyltetrazolium.

Specific examples of the silane compound include an alkoxysilane compounds having a primary or secondary amino group, e.g., compounds A1 through A33, described in JP-A No. 2003-5324, paragraph [0027]-[0029].

A silver saving agent is contained in an amount of 1×10⁻⁵ to 1 mol, preferably 1×10⁻⁴ to 5×10⁻¹ mol per mol of organic silver salt.

Specific examples of a preferred silver saving agent are shown below, but are not limited to these.

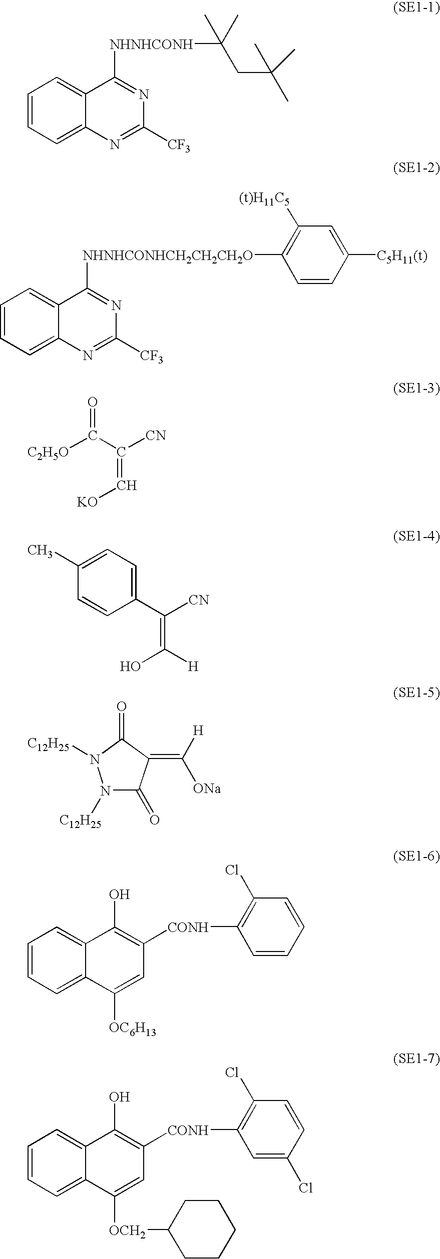

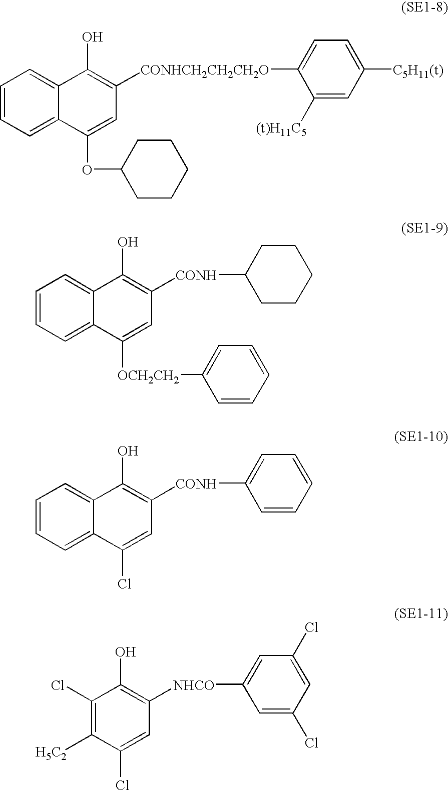

### (Thermal Solvent)

The photothermographic material of the present invention preferably contains a thermal solvent In the present invention, the thermal is defined as a material capable of lowering the thermal developing temperature of a thermal solvent-containing photothermographic material by at least 1° C. (preferably at least 2° C., and more preferably at least 3° C.), as compared to a photothermographic material containing no thermal solvent. For example, a density obtained by developing a photothermographic material (B) containing no thermal solvent at 120° C. for 20 sec., can be obtained by developing a photothermographic material (A) in which a thermal solvent is added to the photothermographic material (B), at a temperature of 119° C. or less for the period of the same time as the photothermographic material (B).

A thermal solvent contains a polar group and is preferably a compound represented by the following Formula (TS), however, the thermal solvent is not limited thereto:

(Y)ₙZ Formula (TS)

wherein Y is a group selected from an alkyl group, an alkenyl group, an alkynyl group, an aryl group or a heterocyclic group; Z is hydroxyl, carboxyl, an amino group, an amide group, a sulfonamido group, a phosphoric acid amide, cyano, imide, ureido, sulfonoxide, sulfone, phosphine, phosphineoxide and nitrogen-containing heterocyclic group; n is an integer of 1 to 3, provided that when Z is a mono-valent, n is 1 and when Z has a valence of two or more, n is the same as a valence number of Z, and when n is 2 or more, Ys may be the same or different.

Y may be substituted and examples of a substituent may be the same as represented by Z described above. In the Formula (TS), Y is a straight, branched or cyclic alkyl group (preferably having 1-40 carbon atoms, more preferably 1-30, still more preferably 1-25 carbon atoms, e.g., methyl, ethyl, propyl, isopropyl, sec-butyl, tert-butyl, t-octyl, n-amyl, t-amyl, n-dodecyl, n-tridecyl, octadecyl, icosyl, docosyl, cyclopentyl, cyclohexyl), alkenyl group (preferably having 2-40 carbon atoms, more preferably 2-30, still more preferably 2-25 carbon atoms, e.g., vinyl, allyl, 2-butenyl, 3-pentenyl), aryl group (preferably having 6-40 carbon atoms, more preferably 6-30, still more preferably 6-25 carbon atoms, e.g., phenyl, p-methylphenyl, naphthyl), heterocyclic group preferably having 2-20 carbon atoms, more preferably 2-16, still more preferably 2-12 carbon atoms, e.g., pyridyl, pyrazyl, imidazolyl, pyrrolidyl). These substituents may be substituted and substituents may combine with each other to form a ring.

Y may be substituted and as examples of a substituent are cited those described in JP-A No. 2004-21068, paragraph [0015]. It is assumed, as the reason for the use of a thermal solvent activating development that the thermal solvent melts at a temperature near a developing temperature and solubilizes a material participating in development, rendering a reaction feasible at a temperature lower than the case containing no thermal solvent. Thermal development is a reduction reaction in which a carboxylic acid having a relatively high polarity or a silver ion carrier is involved. It is therefore preferred that a reaction field exhibiting an appropriate polarity is formed by a thermal solvent having a polar group.

The melting point of a thermal solvent is preferably 50 to 200° C., and more preferably 60 to 150° C. The melting point is preferably 100 to 150° C. specifically in a photothermographic material which places primary importance on stability to external environments, such as image durability.

Specific examples of a thermal solvent include compounds described in JP-A No. 2004-21068, paragraph [0017] and compounds MF-1 through MF-3, MF-6, MF-7, MF-9 through MF-12 and MF-15 through MF-22.

A thermal solvent is contained preferably at 0.01 to 5.0 g/m², more preferably 0.05 to 2.5 g/m², and still more preferably 0.1 to 1.5 g/m². Thermal solvents may be contained singly or in combination thereof. A thermal solvent may be added to a coating solution in any form, such as a solution, emulsion or solid particle dispersion.

There is known a method in which a thermal solvent is dissolved using oil such as dibutyl phthalate, tricresyl phosphate, glyceryl triacetate or diethyl phthalate, and optionally an auxiliary solvent such as diethyl acetate or cyclohexanone, and is mechanically dispersed to obtain an emulsified dispersion.

Solid particle dispersion is prepared by dispersing powdery thermal solvent in an appropriate solvent such as water using a ball mill, a colloid mill, a vibration ball mill, a jet mill, a roller mill or a ultrasonic homogenizer. A protective colloid (e.g., polyvinyl alcohol), a surfactant (e.g., anionic surfactants such as sodium triisopropylnaphthalenesulfonate) may be used therein. In the foregoing mills, beads such as zirconia are usually used. Zr or the like is sometime dissolved out and mixed in the dispersion within a range of 1 to 1,000 ppm, depending dispersing conditions. A Zr content of 0.5 g or less per g of silver is acceptable to practical use. Aqueous dispersion preferably contains an antiseptic (e.g., benzoisothiazolinone sodium salt).

### (Antifoggant and Image Stabilizer)

Any component layer of the photothermographic material of the present invention preferably contains an antifoggant to inhibit fogging caused before being thermally developed and an image stabilizer to prevent deterioration of images after being thermally developed.

Next, there will be described an antifoggant and an image stabilizer usable in the photothermographic material of the present invention.

Since bisphenols and sulfonamidophenols which contain a proton are mainly employed as a reducing agent, incorporation of a compound which generates reactive species capable of abstracting hydrogen is preferred to deactivate the reducing agent. It is also preferred to include a compound capable of oxidizing silver atoms or metallic silver (silver cluster) generated during storage of raw film or images. Specific examples of a compound exhibiting such a function include biimidazolyl compounds and iodonium compounds. The foregoing biimidazolyl compounds or iodonium compound is incorporated preferably in an amount of 0.001 to 0.1 mol/m² and more preferably 0.005 to 0.05 mol/m².

In cases when a reducing agent used in the present invention is a compound containing an aromatic hydroxyl group, specifically bisphenols, it is preferred to use a non-reducible compound capable of forming a hydrogen bond with such a group, for example, compounds (II-1) to (II-40) described in JP-A No 2002-90937, paragraph [0061]-[0064].

A number of compounds capable of generating a halogen atom as reactive species are known as an antifoggant or an image stabilizer. Specific examples of a compound generating an active halogen atom include compounds of formula (9) described in JP-A No. 2002-287299, paragraph [0264]-[0271]. These compounds are incorporated preferably at an amount within the range of an increase of printed-out silver formed of silver halide being ignorable. Thus, the ratio to a compound forming no active halogen radical is preferably at most 150%, more preferably at most 100%. Specific examples of a compound generating active halogen atom include compounds (III-1) to (III-23) described in paragraph [0086]-[0087] of JP-A NO. 2002-169249; compounds 1-1a to 1-1o, and 1-2a to 1-2o described in paragraph [0031] to [0034] and compounds 2a to 2z, 2aa to 2ll and 2-1a to 2-1f described in paragraph [0050]-[0056] of JP-A No. 2003-50441; and compound 4-1 to 4-32 described in paragraph [0055] to [0058] and compounds 5-1 to 5-10 described in paragraph [0069] to [0072] of JP-A No. 2003-91054.

Examples of preferred antifoggants usable in the present invention include compounds a to j described in [0012] of JP-A No. 8-314059, thiosufonate esters A to K described in [0028] of JP-A No. 7-209797, compounds (1) to (44) described on page 14 of JP-A No. 55-140833, compounds (I-1) to (1-6) described in [0063] and compounds (C-1) to (C-3) described in [0066] of JP-A No. 2001-13627, compounds (III-1) to )III-108) described in [0027] of JP-A No. 2002-90937, vinylsulfone and/or β-halosulfone compounds VS-1 to VS-7 and HS-1 to HS-5 described in [0013] of JP-A No. 6-208192, sulfonylbenzotriazole compounds KS-1 to KS-8 described in JP-A No. 200-330235, substituted propenenitrile compounds PR-01 to PR-08 described in JP-A No. 2000-515995 (published Japanese translation of PCT international publication for patent application) and compounds (1)-1 to (1)-132 described in [0042] to [0051] of JP-A No. 2002-207273.

The foregoing antifoggant is used usually in an amount of at least 0.001 mol per mol of silver, preferably from 0.01 to 5 mol, and more preferably from 0.02 to 0.6 mol.

Compounds commonly known as other than the foregoing compounds may be contained in the photothermographic material of the present invention, which may be a compound capable of forming a reactive species or a compound exhibiting a different mechanism of antifogging. Examples of such compounds include those described in U.S. Pat. Nos. 3,589,903, 4,546,075 and 4,452,885; JP-A No. 59-57234; U.S. Pat. Nos. 3,874,946 and 4,756,999; JP-A No. 59-57234, 9-188328 and 9-90550. Further, other antifoggants include, for example, compounds described in U.S. Pat. No. 5,028,523 and European Patent No. 600,587, 605,981 and 631,176.

### (Toning Agent)

The photothermographic material of the present invention forms a photographic image upon thermal development and preferably contains an image toning agent (toner) to control image color in the form of dispersion in (organic) binder matrix.

Examples of suitable image toning agents are described in RD 17029, U.S. Pat. Nos. 4,123,282, 3,994,732 and 4,021,249.

Specific examples include imides (e.g. succinimide, phthalimide, naphthalimide, N-hydroxy-1,8-naphthalimide), mercaptans (e.g., 3-mercapto-1,24-triazole), phthalazinone derivatives and their metal salts (e.g., phthalazinone, 4-(1-naphthyl)phthalazinone, 6-chlorophthalazinone, 5,7-dimethyloxyphthalazinone, 2,3-dihydroxyl,4-phthalazine-dione), combination of phthalazine and phthalic acids (e.g., phthalic acid, 4-methylphthalic acid, 4-nitrophthalic acid, tetrachlorophthalic acid); combination of phthalazine and a compound selected from maleic acid anhydride, phthalic acid, 2.3-naphthalenedicarboxylic acid and o-phenylene acid derivatives and their anhydrides (e.g., phthalic acid, 4-methylpthalic acid, 4-nitrophthalic acid, tetrachlorophthalic acid anhydride). Of these, a specifically preferred image toning agent is a combination of phthalazinone or phthalazine, and phthalic acids or phthalic acid anhydrides. In the present invention, the content of phthalazine and its derivative or phthalazinone and its derivative is preferably 0.1 to 2.0 in molar ratio based on the mole of the reductant, more preferably 0.2 to 1.5 and further more preferably 0.3 to 1.0. Further, the content of phthalazine and its derivative or phthalazinone and its derivative is preferably 0.0001 to 1 mole per 1 mole of coated silver, more preferably 0.001 to 0.5 mole and further more preferably 0.002 to 0.2 mole.

### (Fluorinated Surfactant)

To improve film tracking characteristics of thermal development apparatus and environmental suitability (accumulativeness in organ), fluorinated surfactants represented by the following Formula (SF) are preferably used:

[R_{f}-(L₁)ₘ₁-]ₚ-(Y)ₙ₁-(A)_{q} Formula (SF)

wherein R_{f} represents a fluorine-containing substituent, L₁ represents a bivalent linkage group containing no fluorine, Y represents a (p+q)-valent linkage group containing no fluorine, A represents an anion or its salt, m1 and n1 are each an integer of 0 or 1, p is an integer of 1 to 3, q is an integer of 1 to 3, provided that when q is 1, m1 and n1 are not zero at the same time.

In Formula (SF), examples of R_{f} of a fluorine-containing substituent include a fluoroalkyl group having 1 to 25 carbon atoms (e.g., trifluoromethyl, trifluoroethyl, perfluoroethyl, perfluorobutyl, perfluorooctyl, perfluorododecyl, perfluorooctadecyl), and a fluoroalkenyl group (e.g., perfluoropropenyl, perfluorobutenyl, perfluorononenyl, perfluorododecenyl). R_{f} preferably contains 2 to 8 carbon atoms, and more preferably 2 to 6 carbon atoms. R_{f} preferably 2 to 12 fluorine atoms, and more preferably 3 to 12 fluorine atoms.

In the foregoing formula, L₁ represents a bivalent, fluorine free linkage group. Examples of divalent linking groups containing no fluorine atom include an alkylene group (e.g., a methylene group, an ethylene group, and a butylene group), an alkyleneoxy group (such as a methyleneoxy group, an ethyleneoxy group, or a butyleneoxy group), an oxyalkylene group (e.g., an oxymethylene group, an oxyethylene group, and an oxybutylene group), an oxyalkyleneoxy group (e.g., an oxymethyleneoxy group, an oxyethyleneoxy group, and an oxyethyleneoxyethyleneoxy group), a phenylene group, and an oxyphenylene group, a phenyloxy group, and an oxyphenyloxy group, or a group formed by combining these groups.

In the foregoing formula, A represents an anion group or a salt group thereof. Examples include a carboxylic acid group or salt groups thereof (sodium salts, potassium salts and lithium salts), a sulfonic acid group or salt groups thereof (sodium salts, potassium salts and lithium salts), a sulfuric acid half ester group or salt group thereof (sodium salts, potassium salts and lithium salts) and a phosphoric acid group and salt groups thereof (for example, sodium salts and potassium salts).

In the foregoing formula, Y represents a fluorine-free linkage group having a valence of (p+q). Examples thereof include trivalent or tetravalent linking groups having no fluorine atom, which are groups of atoms comprised of a nitrogen atom as the center; n is an integer of 0 or 1, and preferably 1.

The fluorinated surfactants represented by the foregoing Formula (SF) are prepared as follows. Alkyl compounds having 1 to 25 carbon atoms into which fluorine atoms are introduced (e.g., compounds having a trifluoromethyl group, a pentafluoroethyl group, a perfluorobutyl group, a perfluorooctyl group, or a perfluorooctadecyl group) and alkenyl compounds (e.g., a perfluorohexenyl group or a perfluorononenyl group) undergo addition reaction or condensation reaction with each of the tri- to hexa-valent alkanol compounds into which fluorine atom(s) are not introduced, aromatic compounds having 3 or 4 hydroxyl groups or hetero compounds. Anion group (A) is further introduced into the resulting compounds (including alkanol compounds which have been partially subjected to introduction of Rf) employing, for example, sulfuric acid esterification.

Examples of the aforesaid tri- to hexa-valent alkanol compounds include glycerin, pentaerythritol, 2-methyl-2-hydroxymethyl-1,3-propanediol, 2,4-dihydroxy-3-hydroxymethylpentane, 1,2,6-hexanrtriol. 1,1,1-tris(hydroxymethyl)propane, 2,2-bis(butanol), aliphatic triol, tetramethylolmethane, D-sorbitol, xylitol, and D-mannitol.

The aforesaid aromatic compounds, having 3-4 hydroxyl groups and hetero compounds, include, for example, 1,3,5-trihydroxybenzene and 2,4,6-trihydroxypyridine.

Specific examples of a fluorinated surfactant include compounds (FS-1) through (FS-66) described in JP-A No. 2003-149766, paragraph [0029]-[0044]; compounds 1-1 through 1-4, described in JP-A No. 2004-021084; and compounds described in JP-A No. 2004-077792, paragraph [0025] and [0030].

Specific examples of fluorinated surfactants of Formula (SF) are sown below.

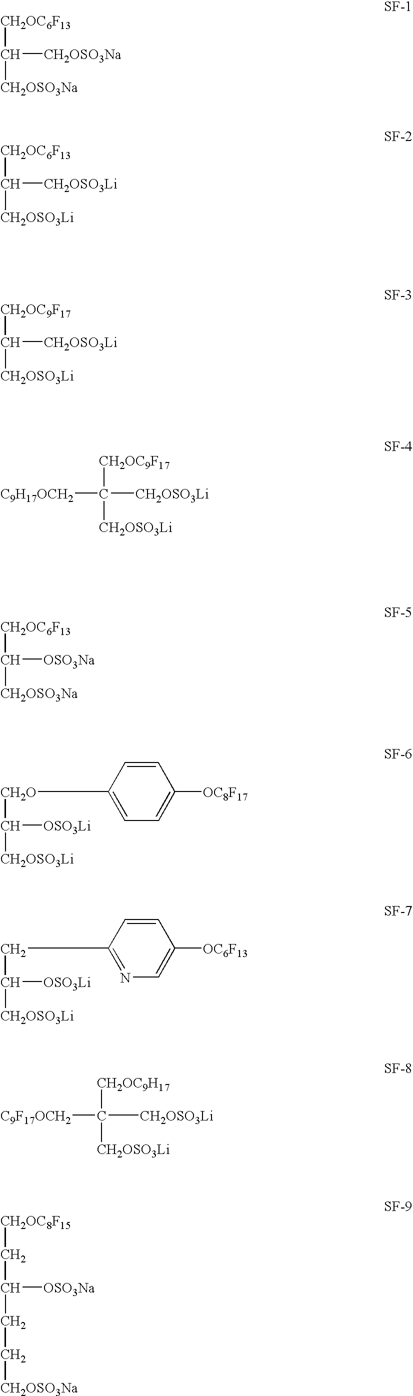

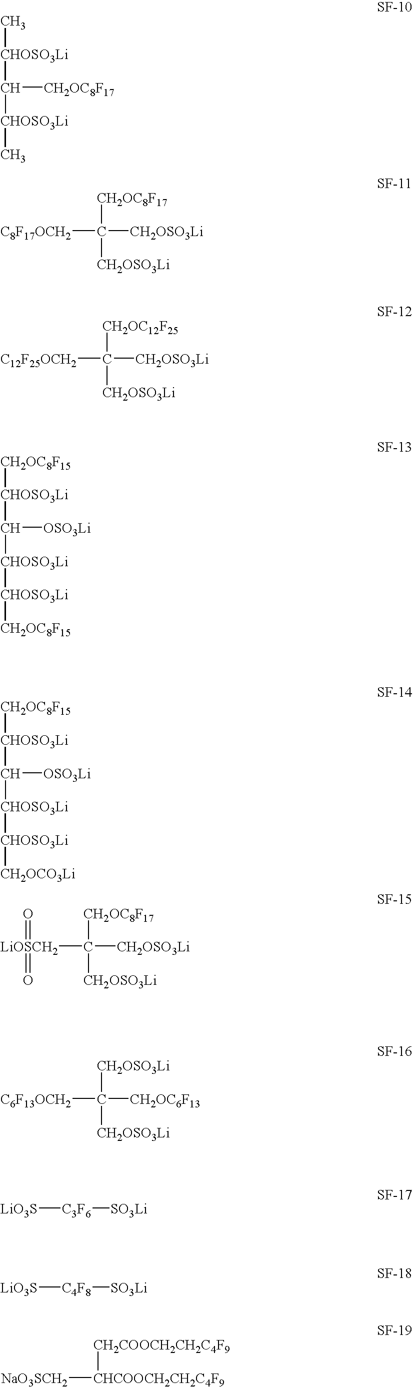

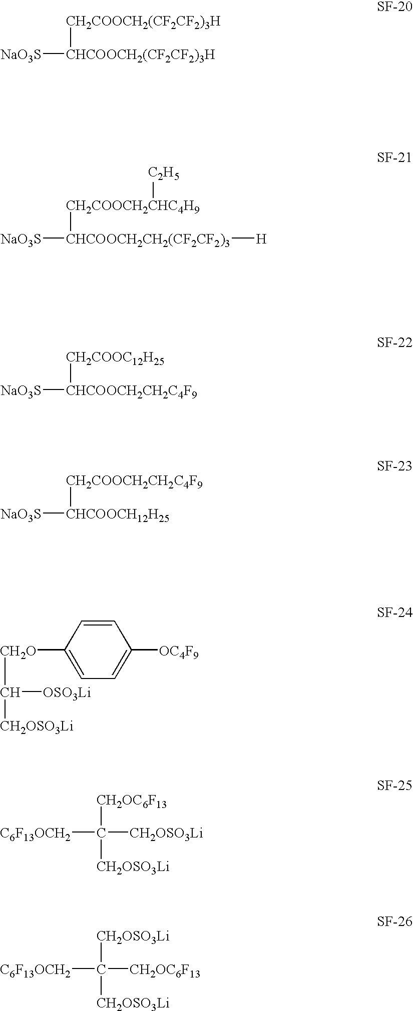

Fluorinated surfactants usable in this invention, other than the foregoing ones include compounds described in JP-A No. 2004-117505, paragraph [0035] and compounds described in JP-A Nos. 2000-214554, 2003-156819, 2003-177494, 2003-114504, 2003-270754 and 2003-270760.

The combined use of the foregoing anionic surfactants of Formula (SF) and conventionally known nonionic fluorinated surfactants in the photothermographic material is preferred in terms of enhanced static property and coatability.

It is possible to add the fluorinated surfactants represented by the foregoing Formula (SF) to liquid coating compositions, employing any conventional addition methods known in the art. Thus, they are dissolved in solvents such as alcohols including methanol or ethanol, ketones such as methyl ethyl ketone or acetone, and polar solvents such as dimethylformamide, and then added. Further, they may be dispersed into water or organic solvents in the font of minute particles at a maximum size of 1 μM, employing a sand mill, a jet mill, or an ultrasonic homogenizer and then added. Many techniques are disclosed for minute particle dispersion, and it is possible to perform dispersion based on any of these. It is preferable that the aforesaid fluorinated surfactants are added to the protective layer which is the outermost layer.

The added amount of the aforesaid fluorinated surfactants is preferably 1×10⁻⁸ to 1×10⁻¹ mol per m², more preferably 1×10⁻⁵ to 1×10⁻² mol per m². When the added amount is less than the lower limit, it is not possible to achieve desired charging characteristics, while it exceeds the upper limit, storage stability degrades due to an increase in humidity dependence.

### (Layer Containing Radiation Absorption Compound)

Various kinds of dyes and pigments known in the art are usable as radiation-absorbing compounds used in the layer provided on the light-sensitive layer side or the layer provided on the side opposite the light-sensitive layer. Such dyes and pigments include those described in Color Index, for example, pyrazoloazole dyes, anthraquinone dyes, azo dyes, azomethine dyes, oxonol dyes, carbocyanine dyes, styryl dyes, triphenylmethane dyes, indoaniline dyes, indophenol dyes, organic pigments such as phthalocyanine and inorganic pigments.

Examples of preferred dyes used in the present invention include anthraquinone dyes (e.g., compounds 1-9 described in JP-A No. 5-341441, compounds 3-6 to 3-18 and 3-23 to 3-38 described in JP-A No. 5-165147), azomethine dyes (e.g., compounds 17-47, described in JP-A No. 5-289227), indoaniline dyes (e.g., compounds 11-19, described in JP-A No. 5-289227, compound 47 described in JP-A No. 5-341441, compounds 2-10 to 2-11, described in JP-A No. 5-165147), and azo dyes (e.g., compounds 10-16, described in JP-A No. 5-341441). When the photothermographic material of the present invention is applied as an image recording material using infrared light, for instance, squarilium dyes containing a thiopyrylium nucleus and squarilium dyes containing a pyrylium nucleus, thiopyrylium chroconium similar to squarilium dyes, and pyrylium chroconium dyes, as disclosed in JP-A No. 2001-83655, are preferable. A compound containing a squarilium nucleus refers to a compound containing 1-cyclobutene-hydroxy-4-one in the molecular structure, and a compound containing a chroconium nucleus refers to 1-cyclopentene-2-hydroxy-4,5-dione in the molecular structure, in which the hydroxy group may be dissociated. Preferred examples of such dyes include compounds described in JP-A No. 8-201959, compound described in Japanese translation of PCT International Patent Application Publication No. 9-509503, and compounds AD-1 to AD-55 described in JP-A No. 2003-195450. When the photothermographic material of the present invention is employed as an image recording material using blue light, there are preferably used compounds Nos. 1-93 described in JP-A No. 2003-215751 and Dye-1 to Dye-51 described in JP-A No. 2005-157245. These dyes or compounds described above can be incorporated by any means, for instance, in the form of a solution, emulsion or solid particle dispersion, or in a state mordanted by mordants. These dyes or compounds are used in amounts depending on the objective absorption amount, but preferably in the range from 1 μg to 1 g per m² of the photothermographic material. In the photothermographic material of the present invention, it is preferred that radiation-absorbing compounds (dyes or pigments) are contained in a layer provided on the light-sensitive layer side of the support, for example, a sublayer, light-sensitive layer, interlayer or protective layer (preferably, light-sensitive layer) and are set so as to have an absorbance of 0.30 to 1.00 at absorption wavelengths of the whole layers described above, and radiation-absorbing compounds (dyes or pigments) are contained in a layer provided on the opposite side of the support to the light-sensitive layer, for example, an antistatic sublayer, antihalation layer, or protective layer (preferably antihalation layer) and are set so as to have an absorbance of 0.20 to 1.50. The absorbance at absorption wavelengths of the whole layers provided on the light-sensitive layer side of the support is preferably 0.40 to 0.90 and specifically preferably 0.50 to 0.80. The absorbance at absorption wavelengths of the whole layers provided on the opposite side of the support to the light-sensitive layer is preferably 0.30 to 1.20 and specifically preferably 0.40 to 1.00. An absorbance falling within the range described above can improve density variation caused along with image quality or humidity change, even when using resin lenses in an exposure system.

### (Support)

Suitable supports used in the photothermographic imaging materials of the present invention include various polymeric materials, glass, wool cloth, cotton cloth, paper, and metals (such as aluminum). As an information recording material, flexible sheets or roll-convertible one are preferred. Examples of preferred support used in the present invention include plastic resin films such as cellulose acetate film, polyester film, polyethylene terephthalate (PET) film, polyethylene naphthalate (PEN) film, polyamide film, polyimide film, cellulose triacetate (TAC) film and polycarbonate (PC) film, and biaxially stretched polyethylene terephthalate (PET) film is specifically preferred. The support thickness is 50 to 300 μm, and preferably 70 to 180 μm.

To improve electrification properties of photothermographic imaging materials, metal oxides and/or conductive compounds such as conductive polymers may be incorporated into the constituent layer. These compounds may be incorporated into any layer and preferably into a sublayer, a backing layer, interlayer between the light sensitive layer and the sublayer. Conductive compounds described in U.S. Pat. No. 5,244,773, col. 14-20. Specifically, the surface protective layer of the backing layer side preferably contains conductive metal oxides, whereby the effect of the present invention (specifically conveying property in the thermal developing process) is promoted.

The conductive metal oxide is crystalline metal oxide particles, and one which contains oxygen defects or one which contains a small amount of a heteroatom capable of forming a donor for the metal oxide, both exhibit enhanced conductivity and are preferred. The latter, which results in no fogging to a silver halide emulsion is preferred. Examples of metal oxide include ZnO, TiO₂, SnO₂, Al₂O₃, In₂O₃, SiO₂, MgO, BaO, MoO₃ and V₂O₅ and their combined oxides. Of these, Zno, TiO₂ and SnO₂ are preferred. As an example of containing a heteroatom, addition of Al or In to ZnO, addition of Sb, Nb, P or a halogen element to SnO₂, and addition of Nb or Ta to TiO₂ are effective. The heteroatom is added preferably in an amount of 0.01 to 30 mol %, and more preferably 0.110 mol %. To improve particle dispersibility and transparency, a silicon compound may be added in the course of particle preparation.

The metal oxide particles have electric conductivity, exhibiting a volume resistance of 10⁷ Ω·cm or less and preferably 10⁵ Ω·cm or less. The foregoing metal oxide may be adhered to other crystalline metal oxide particles or fibrous material (such as titanium oxide), as described in JP-A Nos. 56-143431, 56-120519 and 58-62647 and JP-B No. 59-6235.

The particle diameter usable in the present invention is preferably not more than 1 μm, and a particle diameter of not more than 0.5 μm results in enhanced stability after dispersion, rendering it easy to make use thereof. Employment of conductive particles of 0.3 μm or less enables to form a transparent photothermographic material. Needle-form or fibrous conductive metal oxide is preferably 30 μm or less in length and 1 μm or less in diameter, and more preferably 10 μm or less in length and 0.3 μm or less in diameter, in which the ratio of length to diameter is preferably 3 or more. SnO₂ is also commercially available from Ishihara Sangyo Co., Ltd., including SNS10M, SN-100P, SN-100D and FSS10M.

### (Constitution Layer)

The photothermographic material of the present invention is provided with at least one light-sensitive layer as a light-sensitive layer on the support. There may be provided an light-sensitive layer alone on the support but it is preferred to form at least one light-insensitive layer on the light-sensitive layer. For instance, a protective layer may be provided on the light-sensitive layer to protect the light-sensitive layer. Further, to prevent blocking between photothermographic materials or adhesion of the photothermographic material to a roll, a back coating layer may be provided on the opposite side of the support.

A binder used in the protective layer or the back coating layer can be chosen preferably from polymers having a higher glass transition point (Tg) than a binder used in the light-sensitive layer and exhibiting resistance to abrasion or deformation, for example, cellulose acetate, cellulose acetate butyrate or cellulose acetate propionate.

To control gradation, at least two light-sensitive layers may be provided on one side of the support or at least one light-sensitive layer may be provided on both sides of the support.

### (Subbing Layer (Slip Layer))

In the present invention, when the slide coater is applied, a thin subbing layer (slip layer) is preferably provided on the support. Namely, for the light-sensitive layer side, protective layers on the slip layer, light-sensitive layer and light-sensitive layer are preferably provided by concurrent multilevel coating method. When used on the back coating layer (BC layer) side, the slip layer and BC layer are preferably provided by concurrent multilevel coating method. In this case, the protective layer and BC layer on the light-sensitive layer and light-sensitive layer can be formed in a multiple level structure. The slip layer is normally formed in a very thin structure by the layer containing the organic silver salt and binder, and the layer containing a binder. When the dry film thickness SA of the slip layer on the light-sensitive layer side and the dry film thickness SB of the light-sensitive layer are assumed, the SA/SB is preferably in the range of 0.005 through 0.10. The aforementioned SA/SB is more preferably in the range of 0.01 through 0.07, still more preferably in the range of preferably 0.02 through 0.06. The dry film thickness SA of the slip layer on the light-sensitive layer side is preferably in the range of 0.1 through 1.0 μm, more preferably in the range of preferably 0.2 through 0.7 μm, still more preferably in the range of 0.3 through 0.6 μm. When the dry film thickness Sc of the slip layer on the back coating layer side and the dry film thickness Sd of the back coating layer are assumed, the Sc/Sd is preferably in the range of 0.01 through 0.30. The aforementioned Sc/Sd is more preferably in the range of preferably 0.05 through 0.25, still more preferably in the range of 0.08 through 0.20. The dry film thickness Sc of the slip layer on the back coating layer side is preferably in the range of 0.1 through 0.8 μm, more preferably 0.15 through 0.7 μm, still more preferably in the range of 0.2 through 0.5 μm.

The polyvinyl acetal resin, acryl resin, polyester resin, polyurethane, or cellulose ester is preferably used as the binder of the slip layer. The polyurethane is obtained by reaction between polyol and polyisocyanate. The polyester polyol obtained by reaction between the polyol and polybasic acid is commonly used as the polyol. Thus, if the polyester polyol containing a polar group is used as the material, the polyurethane containing a polar group can be synthesized. In the present invention, it is preferred to use an aliphatic or aromatic polyester polyurethane prepared by using the polyester polyol containing an aliphatic and aromatic ring and/or polyester polyol containing the cyclic hydrocarbon residue.

The polyisocyanate is exemplified by diphenylmethane-4,4′-diisocyanate (MDI), hexamethylene diisocyanate (HMDI), tolylenediisocyanate (TDI), 1,5-naphthalenediisocyanate (NDI), tolidine diisocyanate (TODI), and lysine isocyanate methyl ester (LDI). The monomer component constituting the acryl resin is exemplified by a homopolymer and copolymer formed of acrylonitryl, acrylate, methacrylate, methylmethacrylate, ethylacrylate, ethyl methacrylate, hydroxy ethyl methacrylate, 3-cyanophenylmethacryl amide, 4-cyanophenyl methacrylate and 4-hydroxy phenylmethacryl amide. Of these, polymethyl methacrylate is preferably used. The amount of the polyester resin, acryl resin and polyurethane contained in the slip layer is 10 through 90%, preferably 20 through 80%, more preferably 30 through 70% in terms of mass ratio with respect to all the binders contained in the slip layer. The crosslinking agent is assumed to be contained in the binder. When the amount of the polyester resin, acryl resin and polyurethane to be added is kept within this range, bondability with the support is drastically enhanced.

In the present invention, back coating layer and the subbing layer (slip layer) on the back coating layer preferably contains a polyester resin, acryl resin or polyurethane resin. Assume that the mass ratio of the total of the polyester resin, acryl resin and polyurethane resin in the back coating layer with respect to the total amount of the binder on the back coating layer is A, and the mass ratio of the total amount of the polyester resin, acryl resin or polyurethane resin in the subbing layer on the back coating layer side with respect to the total amount of the binder on the subbing layer is B. Then B is preferably greater than A. In this case, the crosslinking agent is assumed to contain a binder. The polyester resin, acryl resin or polyurethane resin is used as an adhesion accelerating binder on the back coating layer to improve the characteristics of the adhesive layer with respect to the support. However, these adhesion accelerating binders have been found to have an impact on the degree of contamination inside the thermal development apparatus at the time of thermal development. Thus, when the amount of the adhesion accelerating binder contained in the back coating layer surface in contact with the thermal development apparatus is minimized and the adhesion accelerating binder is contained in the subbing layer, it has been found to be possible to reduce the contamination inside the thermal development apparatus, with the bondability with the support kept unharmed. In this case, the value (B−A) is preferably 0.02 through 0.3, more preferably 0.05 through 0.2. A is 0 or more without exceeding 0.01, more preferably 0. B is preferably 0.02 through 0.5, more preferably, 0.05 through 0.3.

When the slip layer and light-sensitive layer are concurrently coated in a multilevel structure, the effect of correcting the coating irregularity is conspicuous when the light-sensitive layer coating speed is 25 m/minute or higher. The effect is more conspicuous when the speed is 30 m/minute or more, and is still more conspicuous when it is 35 m/minute or more. Thus, the effect is increased with the coating speed. A higher coating speed is preferred from the viewpoint of productivity. Normally, this speed is 300 m/minute or less. The speed of 200 m/minute or less is preferred from the viewpoint of ensuring a satisfactory coating property. The slip layer can be either an aqueous layer or a solvent based layer wherein an organic solvent is used. For concurrent multilevel coating, the slip layer is preferably an aqueous layer when the light-sensitive layer is aqueous, and an organic solvent based layer when the light-sensitive layer is an organic solvent layer. When the aqueous based acryl resin and polyurethane is used, the water-insoluble acryl resin or polyurethane is used, or it is used as a water-dispersion type latex.

### Coating of Constitution Layer

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, alight-sensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight (more preferably 90 percent by weight), the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method.

Of these, more preferred is an extrusion coating method. Coating methods have been described for coating layers on the light-sensitive layer side. However, the backing layer and the subbing layer are applied onto a support in the same manner as above. A simultaneous multi layer coating method for a photothermographic material is disclosed in detail in JP-A No. 2000-15173.

In the invention, it is preferable to determine the amount of silver coverage according to the purpose of the photothermographic material. For use in medical imaging, silver coverage is preferably from 0.3 to 1.5 g/m², more preferably from 0.5 to 1.4 g/m² and specifically preferably 0.5 to 1.4 g/m². The ratio of the silver coverage which is resulted from silver halide is preferably from 2% to 18% with respect to the total silver, and is more preferably from 5% to 15%.

Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷.

Further, the coated weight of aliphatic carboxylic acid silver salts of the present invention is from 10⁻¹⁷ to 10⁻¹⁴ g per silver halide grain having a diameter (being a sphere equivalent grain diameter) of at least 0.01 μm, and is more preferably from 10⁻¹⁶ to 10⁻¹⁵ g.

When coating is carried out under conditions within the aforesaid range, from the viewpoint of maximum optical silver image density per definite silver coverage, namely covering power as well as silver image tone, desired results are obtained.

The photothermographic material of the invention contains solvent preferably at 5 to 1,000 mg/m² when subjected to thermal development, and more preferably 10 to 150 mg/m², thereby leading to enhanced sensitivity, reduced fogging and enhanced maximum density. Examples of such a solvents are described, for instance, in JP-A No. 2001-264936, paragraph [0030] but are not limited to thereto. The solvent may be used singly or in combination.

The solvent content in the photothermographic material can be controlled by adjusting conditions in the drying stage after coating, for example, temperature conditions. The solvent content can be determined by gas chromatography under the condition suitable for detection of contained solvents.

### (Packaging Material)

There will be described packaging methods of sheet-form recording materials and a package of a sheet-form recording material, used in the invention.

In the invention, the process of cutting and packaging is conducted preferably under an environment at an air cleanliness degree of 10,000 or less of U.S. Standard 209d class, whereby internal staining in a thermal processor during thermal processing is markedly improved. The reason therefor is not clear but it is assumed as below. Chips or dust particles carried-in from the cutting and packaging process and adhered to photothermographic material are subsequently adhered to transporting members such as rollers in the thermal processor and accumulated therein, causing internal staining.

The U.S. Standard 209d class indicates to a standard of a clean room and the environment at an air cleanliness degree of 10,000 or less of U.S. Standard 209d class refers to an environment in which the cumulative number of particles having a size of 0.5 μm or more is not more than 10,000/ft³ (=28,317 cm³) and the cumulative number of particles having a size of more than 5.0 μm is not more than 65 particles/ft³.

An environment meeting the above conditions may be formed in a clean room but the method of the invention is not limited to embodiments in such a clean room. It is not necessarily required to place the overall apparatus for cutting and packaging of sheet-form recording material in a clean room to perform working. For instance, a mechanism to blow air flow onto the sheet-form recording material is provided in an apparatus cutting to packaging and work is performed with maintaining the environment at an air cleanliness degree of 10,000 or less of U.S. Standard 209d class.

It is necessary to maintain an environment at an air cleanliness degree of 10,000 or less of U.S. Standard 209d class during at least one of the cutting step and the packaging step. Preferably, the cutting step is conducted in an environment at an air cleanliness degree of 10,000 or less of U.S. Standard 209d class, and more preferably, both the cutting step and the packaging step are each conducted in an environment at an air cleanliness degree of 10,000 or less of U.S. Standard 209d class.

The cutting step in the invention refers to a step of cutting sheet-form recording material to a prescribed size or to a commonly used size (e.g., A4 size or a size of 34.5×43.0 cm). The number of times for cutting is not limited, which may be a single operation or plural ones. Cutting may be done all together in the longitudinal direction to form a stripe-form recording material and then cutting it in the cross direction is conducted to the prescribed size. There are not specifically limited cutting means or cutting devices used for cutting.

In cases when a sheet form recording material is mounted in an image recording apparatus, the packaging step in the invention means a process including a step of packaging the sheet form recording material. In cases when a load of sheet form recording material is mounted in an image recording apparatus, the packaging step is a process including the step of packaging the sheet form recording material. Thus, it refers to a step of packaging sheet form recording material or a load of sheet form recording material. There are not specifically limited packaging means or the packaging device.

The air cleanliness degree in the course from the cutting step to the packaging step is not necessarily 10,000 or less of U.S. Standard 209d class but it is preferred to maintain an environment at an air cleanliness degree of 10,000 or less of U.S. Standard 209d class. Similar conditions are preferred during the course until cutting manufactured sheet form recording material. The air cleanliness degree in the cutting step is preferably in class of 7,000 or less in the measurement method in accordance with the U.S. Standard 209d, more preferably 4,000 or less, still more preferably 1,000 or less, and 500 or less is specifically preferred. The air cleanliness degree in the packaging step is preferably a class of 7,000 or less in the measurement method in accordance with the U.S. Standard 209d, more preferably 4,000 or less, still more preferably 1,000 or less, and 500 or less is specifically preferred.

In the invention, a packaging material used for packaging sheets of recording material is chosen from materials barely generating dust. In the case when dust due to packaging material renders it difficult to maintain the cleanliness degree at a level of 10,000 or less of U.S. Standard 209d class, it is preferred not to choose such packaging material.

To prevent density change or fogging with time during storage or to reduce curl or roll-set curl, it is preferred to pack the photothermographic material of the invention with a packaging material exhibiting a low oxygen permeability and/or moisture permeability. The oxygen permeability is preferably not more than 50 ml/atm·m²·day, more preferably not more than 10 ml/atm·m²·day, and still more preferably not more than 1.0 ml/atm·m²·day. The moisture permeability is preferably not more than 0.01 g/m²·40° C.·90% RH·day (in accordance with JIS Z0208, Cap Method), more preferably not more than 0.005 g/m²·40° C.·90% RH·day, and still more preferably not more than 0.001 g/m²·40° C.·90% RH·day.

Specific examples of packaging material include those described in JP-A Nos. 8-254793, 2000-206653, 2000-235241, 2002-062625, 2003-015261, 2003-057790, 2003-084397, 2003-098648, 2003-098635, 2003-107635, 2003-131337, 2003-146330, 2003-226439 and 2003-228152. The free volume within a package is preferably 0.01 to 10%, and preferably 0.02 to 5%, and it is also preferred to fill nitrogen within the package at a nitrogen partial pressure of at least 80%, preferably at least 90%. The relative humidity within the package is preferably 10% to 60%, and more preferably 40% to 55%.

### (Thermal Development Apparatus)

The thermal development apparatus that can be used in the present invention has an image exposure section and thermal development section. The following describes each of them:

### (Image Exposure Section)

Image exposure can be performed by any of the conventional techniques. The preferred image exposure method is a laser scanning exposure technique. In this case, any form of laser can be used. The preferred lasers include a red through infrared emission He—Ne laser, a red semiconductor laser, or a blue through green emitted Ar⁺, He—Ne, He—Cd laser and a blue semiconductor laser. The red through infrared semiconductor laser is more preferably used. The peak wavelength of the laser beam is in the range of 600 nm through 900 nm, preferably in the range of 620 nm through 850 nm.

In recent years, the module formed by integration between the SHG (Second Harmonic Generator) element and semiconductor laser, and blue semiconductor laser in particular have been developed, and the laser output apparatus of short wavelength area has come to the fore. The future demand for the blue semiconductor laser is expected to grow because of high definition image recording, increased recording density, a long service life and stable output. The peak wavelength of the blue laser beam is preferably in the range of 300 nm through 500 nm, more preferably in the range of 400 nm through 500 nm.

The laser beam of longitudinal multiple oscillation by the high frequency superimposition and other method is also preferably utilized.

### (Thermal Development Section)

The thermal development section has a heating device that heats the photothermographic material to the thermal development temperature. The heating device preferably has two heating sections arranged to heat one surface of the aforementioned photothermographic material along the conveyance path of the photothermographic material.

More preferably, the aforementioned heating device is designed so that thermal development is performed at the time of passing through the second heating device after passing through the first heating device. The heat capacity of the aforementioned first heating device is 1.2 or more times greater than that of the second heating device, preferably, it is 1.3 or more times greater, more preferably, it is 1.5 or more times greater.

The aforementioned first heating device and the aforementioned second heating device are particularly preferred when the heating temperature is higher at the inlet of the aforementioned photothermographic material than at the outlet.

Preferably, the aforementioned first heating device and the aforementioned second heating device have heating members and members for pressing the aforementioned photothermographic material against this heating member. More preferably, the aforementioned heating member uses the coil of the electric resistor as a heat source, and the coil density of the aforementioned first heating device is 1.2 or more times greater than that of the second heating device. Still more preferably, the aforementioned heating member is a heat plate.

In the thermal development apparatus that can be used in the present invention, the heat plate of the thermal development section is preferably designed in such a way that the heating temperature is higher on the conveyance inlet side with respect to the direction of conveying the photothermographic material. When photothermographic material below the thermal development temperature has been conveyed from the upstream side in the direction of conveyance, this arrangement reduces the time of heating this photothermographic material up; to a predetermined thermal development temperature and ensures a sufficient time for thermal development. This avoids reduction in the image density of the photothermographic material that has been thermally developed.

Further, when the photothermographic material having a temperature below the thermal development temperature has been brought to the heat plate for thermal development, heat may be absorbed by contact with this photothermographic material. Even in this case, the required temperature can be ensured by raising the heating temperature the conveyance inlet side of the heat plate. This arrangement avoids the possibility of the temperature of the heat plate for thermal development being reduced below the thermal development temperature.

In the aforementioned thermal development apparatus, a heat generating member is installed on the heat plate and this heat generating member changes the heat watt density of the heat plate in the direction wherein the photothermographic material is conveyed, and ensures that the heat watt density on the conveyance inlet side is higher. This arrangement makes it possible to connect a heat supply device capable of controlling the heat generating member of the heat plate and to control the heat supply device to change the electric capacitance, whereby the heating temperature of the heat plate can be set, while the higher temperature on the conveyance inlet side is kept unchanged.

In the aforementioned thermal development apparatus, the heat generating member is a linear hot wire which is arranged in the form folded perpendicular to the direction wherein the photothermographic material in the heat plate is conveyed, and the space between the hot wires is preferably smaller on the inlet side of conveyance in the direction wherein the photothermographic material is conveyed. This arrangement permits uninterrupted installation of the linear hot wire inside the heat plate. If the hot wire is heated at the time of thermal development, the higher heating temperature can be maintained on the conveyance inlet side wherein the hot wires are thickly laid, and the entire heat plate can be heated, without having to control the temperature at every predetermined site of the heat plate.

According to this thermal development apparatus, a front heating section and development section are formed on a single heat plate and, in the heating area, the photothermographic material is heated up to the level close to the thermal development temperature in advance. After that, the photothermographic material can be heated in the development section. After that, the photothermographic material can be heated in the development section. Further, the heating temperature on the upstream side of the development section can be made higher than that on the downstream side. Thus, in the development section, the photothermographic material can be heated sufficiently to reach the thermal development temperature, eliminating the possibility of reduction in image density.

Both the heating and development processes can be accomplished by a single heat plate. This arrangement eliminates the need of installing another heat plate on the thermal development section, thereby ensuring a simple structure, downsized configuration and reduced cost.

Referring to drawings, the following describes the details of the thermal development apparatus that can be used in the present invention:

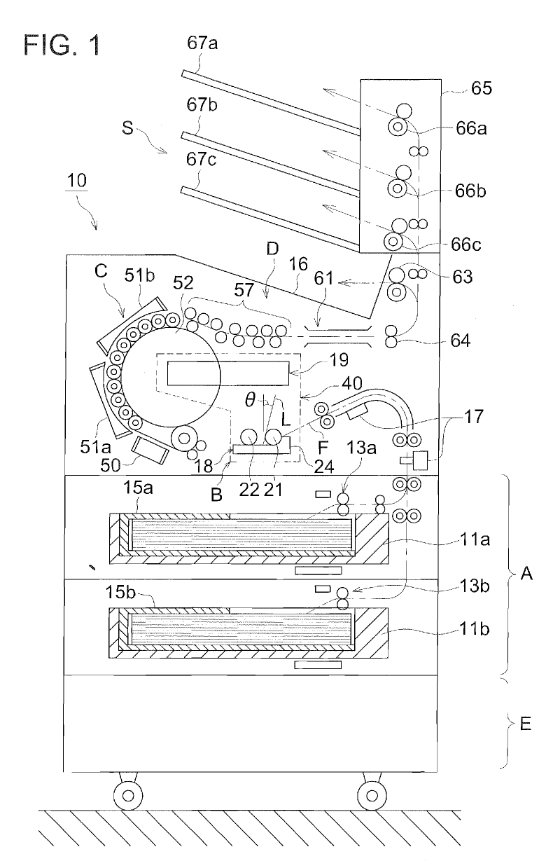

FIG. 1 is a schematic diagram representing the thermal development apparatus that can be used in the present invention. The thermal development apparatus 10 uses a sheet-like photothermographic material F that does not require processing of wet type development as an image recording material. After a latent image has been formed by application of the laser beam L modulated according to the image signal inputted into the photothermographic material F, this photothermographic material F is subjected to thermal development, whereby a visible image is obtained on the photothermographic material surface. Without being restricted to such a structure, the present invention is also applicable to the arrangement wherein an image is formed on the sheet-like photothermographic material by exposure to the laser beam L in advance, and the photothermographic material is subjected to thermal development alone.

The thermal development apparatus 10 contains the photothermographic material supply section A, image exposure section B, thermal development section C and cooling section D, according to the order along the direction wherein the photothermographic material F is fed. It also includes a conveyance device provided at major portions between various sections to convey the photothermographic material F, and a power/control section E for driving and controlling various sections.

In the thermal development apparatus 10, the power/control section E is arranged on the bottom row, and the photothermographic material supply section A is located on the higher row. Further, the image exposure section B, thermal development section C and cooling section D are positioned an the still higher row. The image exposure section B and thermal development section C are adjacent to each other.

According to this structure, both the exposure process and thermal development process for one photothermographic material F can be accomplished in one and the same conveyance path. Further, the exposure process and thermal development process are accomplished in a short distance of conveyance, whereby the path length for conveying the photothermographic material F is minimized, hence the per-sheet output time is minimized.

The photothermographic material having a thickness of about 0.2 mm (0.1 mm through 0.3 mm) can be used as the photothermographic material F. An image is recorded on the photothermographic material by the laser beam L (exposure to light), and is then subjected to thermal development, whereby colors are developed.

The photothermographic material supply section A picks up the photothermographic materials F one by one and sends them to the image exposure section B located downstream in the direction wherein the photothermographic material F is conveyed. It contains a plurality of loading sections 11a and 11b (two in the present embodiment), a pair of supply rollers 13a and 13b arranged on each of the loading sections 11a and 11b, a conveyance roller (not illustrated) and a conveyance guide. Further, the magazines 15a and 15b accommodating the photothermographic materials F of difference sides are located inside the loading sections 11a and 11b designed in a double-row structure. The magazines 15a and 15b loaded in each row are used on a selective basis in response to the size and direction of the photothermographic material F. It should be noted that the loading section is not restricted to the double row structure alone. It can be designed in a three or multi-row structure, or in a single row structure.

The image exposure section B applies a laser beam L in the main scanning direction to the photothermographic material F having been sent from the photothermographic material supply section A. Further, it feeds the material in the sub-scanning direction approximately perpendicular to the main scanning direction (i.e., conveyance direction), with the result that a latent image conforming to a desired image is formed on the image forming layer on the surface of the photothermographic material F.

A width adjusting mechanism 17 is arranged on the sheet conveyance path between the photothermographic material supply section A and image exposure section B. The photothermographic material F having been sent from the photothermographic material supply section A is fed to the image exposure section B, wherein the widthwise end of the photothermographic material F is adjusted.

While carrying the photothermographic material F subsequent to scanning exposure, the thermal development section C applies a process of temperature rise, whereby thermal development is performed. The cooling section D cools the photothermographic material F subsequent to the process of development, and this material F is fed to the ejection tray 16.

As shown in FIG. 1, the ejection tray 16 is provided with a sorter S for holding the photothermographic material F having been unloaded. The sorter S is provided with a main body 65 mounted removably from the thermal development apparatus 10, and a plurality of unloading rollers 66a, 66b and 66c provided on the main body 65. To hold the photothermographic material F having been unloaded from the main body 65 by a plurality of the unloading rollers 66a, 66b and 66c, it is provided with a plurality of supply sections 67a, 67b and 67c which are partitioned in the vertical direction of the main body 65. The sorter S selects one of the unloading rollers 66a, 66b and 66c to unload the photothermographic materials F, whereby the materials F can be sorted and held by each of the supply sections 67a, 67b and 67c corresponding to the unloading rollers 66a, 66b and 66c. The sorter S can be mounted removably on the top of the thermal development apparatus. It can be omitted, as required, so that the photothermographic material F is unloaded and fed to the ejection tray 16 alone.

The image exposure section B has a scanning exposure apparatus 40 that provides scanning exposure to laser beam, whereby the photothermographic material F is exposed. This scanning exposure apparatus 40 is provided with a sub-scanning conveyance section 18 equipped with a flapping preventive mechanism that allows conveyance while avoiding flapping from the photothermographic material F conveying surface. The scanning exposure apparatus 40 is also provided with a scanning exposure section 19. While controlling the laser output according to the separately prepared image data, the scanning exposure section 19 applies this laser beam L for scanning (main-scanning). In this case, the photothermographic material F is moved in the sub-scanning direction by the sub-scanning conveyance section 18.

The sub-scanning conveyance section 18 is provided with two drive rollers (conveyance devices) 21 and 22 wherein the rotary shaft is arranged approximately parallel to this scanning line, and the main scanning line of the laser beam L being applied for scanning is located in-between. It is equipped with a guide plate 24 which is arranged face to face with these drive rollers 21 and 22 to support the photothermographic material F. The guide plate 24 deflects the photothermographic material F to be inserted between drive rollers 21 and 22, outside these drive rollers 21 and 22 along part of the peripheral surface of the drive rollers 21 and 22. The photothermographic material F is supported in contact with the sites between the drive rollers 21 and 22 by the resulting elastic repulsive force of the photothermographic material F.

As described above, an adequate frictional force is produced between the photothermographic material F and the drive rollers 21 and 22 by the elastic repulsive force of the photothermographic material F per se. Thus, the conveyance drive force is correctly transmitted from the drive rollers 21 and 22 to the photothermographic material F so that the photothermographic material F is conveyed. The drive rollers 21 and 22 receive the drive force of the drive device such as a motor (not illustrated) through the transmission device such as a gear or belt, whereby rotation is preferably in the clockwise direction, as shown in FIG. 1.

The photothermographic material F is pressed against the upper surface of the guide plate 24 by its own elastic repulsive force, thereby minimizing the flapping from the conveyance surface of the photothermographic material F, namely, flapping in the vertical direction in the drawing. When the laser beam L is applied to the photothermographic material F between these drive rollers 21 and 22, satisfactory recording free from misregistration of exposure is provided.

The thermal development section C is provided with a plurality of (two in the present embodiment) heat plates 51a and 51b as heating members for heating the photothermographic material F. These heat plates 51a and 51b are arranged in a form of circular arc along the conveyance path of the photothermographic material F. The heat plates 51a and 51b come in contact with the photothermographic material F to be conveyed, whereby the function as a heating device for thermal development is performed.

In the cooling section D, a plurality of flocking rollers 57 are provided immediately downstream in the direction wherein the thermal development section C is conveyed, wherein these rollers ensure that the photothermographic material F having been subjected to thermal development is fed further downstream in the direction wherein the thermal development section C is conveyed. A plurality of these flocking rollers 57 are provided in a staggered arrangement along the conveyance path of the photothermographic material. While being carried by the flocking roller 57, the photothermographic material F ejected from the thermal development section C is gradually cooled down to the temperature below the glass transition point. The photothermographic material F is gradually cooled. This is because, if the photothermographic material is cooled quickly immediately after thermal development, there will be a difference in the degree of cooling at the center and ends in the direction of conveyance in the photothermographic material F. Then the photothermographic material is deformed in a corrugated form and is set in that form. To prevent this, a heat retaining section is provided to reduce the cooling efficiency immediately after thermal development, so that the speed of cooling can be reduced.

After having been cooled gradually by the flocking roller 57, the photothermographic material F is conveyed so as to come in contact with the flat surfaces of a pair of metal plate 61 having mutually opposing flat surfaces across the conveyance path of the photothermographic material F. The heat of the photothermographic material F is absorbed by this metal plate 61, and the photothermographic material F is adequately cooled so that wrinkles or curling will not occur. The photothermographic material F ejected from the cooling section D is conveyed to the unloading roller 63 on the downstream side from the conveyance roller 64 and is fed out of the unloading roller 63 (66a, 66b or 66c) to the ejection tray 16 (or to the supply sections 67a, 67b and 67c of the sorter S).

At the time of thermal development, the photothermographic material F subjected to the process of thermal development wherein the material is heated up to a predetermined thermal development temperature (about 120° C.) by the thermal development section C. Then an image is formed thereon. In this case, if it is heated up to the thermal development temperature abruptly in a short time, shrinkage will occur. To prevent this, in the thermal development apparatus 10 of the present invention, the material is heated up to about 110° C. in advance (heating process) by the heat plate 50 located upstream in the direction wherein the photothermographic material F is conveyed. After that, thermal development is applied at the aforementioned thermal development temperature by the remaining heat plates 51 and 52 installed downstream (development process). Without being restricted to three, the number of the heat plates formed in the thermal development section C can be two or four. When a plurality of heat plates are installed, it is also possible to arrange such a configuration that heating is provided by a desired, number of heat plates upstream in the direction of conveyance, and development is performed by the remaining downstream heat plate.

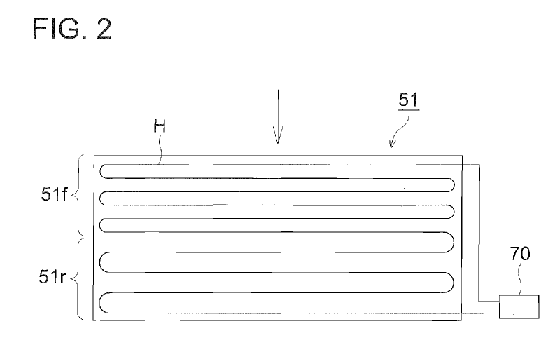

FIG. 2 is a diagram schematically representing the structure of the heat plate of the present embodiment. As shown in FIG. 2, the heat plate 51 is made up of the hot wire H as a heat generating member arranged in a folded state. The space between the hot wires is characterized in that the photothermographic materials are denser on the inlet side.

In the heat plate 51 of the present embodiment, the hot wire H is folded and arranged in the direction perpendicular to the direction of conveying the photothermographic material, along the entire heating member made up of a silicon rubber heater and others. The hot wire H is arranged in the direction of conveying the photothermographic material in such a way that the space between the hot wires H is smaller at the conveyance inlet side 51f than at the conveyance outlet side 51r. As a result, the heat watt density of the heat plate 51 on the conveyance inlet side 51f is higher. Further, part of the hot wire H can be led out of the heat plate 51, and can be connected with the heat supply device 70 that controls the heating temperature.

In the present embodiment, the heat plate 51a is preferably installed according to the aforementioned hot wire arrangement. This arrangement ensures that the temperature is not reduced below the thermal development temperature to be maintained by this heat plate 51a, even if the photothermographic material F having the temperature below the thermal development temperature should be fed into the heat plate 51a at the time of thermal development. This arrangement also ensures that the photothermographic material F immediately before being fed to the heat plate 51a quickly reaches the thermal development temperature. Thus, the present embodiment avoids the reduction in the density of the image on the photothermographic material F having been subjected to thermal development.

In the present invention, it is preferred that the heat plate 51b should be placed in the aforementioned hot wire arrangement as well.

In the laser imager preferably used in the present invention, the ratio of the path length of the cooling section with respect to the path length of the thermal development section is 1.5 or less, preferably in the range of 0.1 or more without exceeding 1.2, more preferably in the range of 0.2 or more without exceeding 1.0. In this case, the path length of the thermal development section can be defined as the conveyance path length wherein the photothermographic material is heated up to the development temperature in the thermal development apparatus. The path length of the cooling section is defined as the path length wherein the photothermographic material is ejected from the area wherein the photothermographic material is light-shielded by the laser imager after the thermal development section, to the site below the light in the room wherein the laser imager is installed.

The aforementioned laser imager preferably has a function of ensuring that the cooling speed on the surface withoutlight-sensitive layer (hereinafter referred to as “nonlight-sensitive surface”) across the support member of the photothermographic material is higher than that on the surface with light-sensitive layer (hereinafter referred to as “light-sensitive surface”).

In the present invention, the ratio of the cooling speed on the nonlight-sensitive surface to that on the nonlight-sensitive surface is preferably in the range of 1.1 or more, more preferably in the range of 1.1 through 5.0, still more preferably in the range of 1.5 through 3.0. Any method can be used to increase the cooling speed on the nonlight-sensitive surface. The nonlight-sensitive surface is preferably brought in direct contact with the metal plate, metallic roller, non-woven fabric and flocked roller. More preferably, a combined use of a heat sink or heat pipe should be used to take a positive step to discharge the heat stored in these members.

A compact laser imager of high processing speed is provided by the laser imager having a short path length of the cooling section wherein the ratio of the path length of the cooling section to that of the thermal development section is 1.5 or less.

The cooling time until the material is ejected after getting out of the thermal development section can be set to any desired level. It is preferably in the range of 0 or more without exceeding 25 seconds, more preferably in the range of 0 or more without exceeding 15 seconds, still more preferably in the range of 5 or more without exceeding 15 seconds.

The path length wherein the photothermographic material passes until it is ejected after getting out of the thermal development section can be set to a desired level. It is preferably in the range of 1 cm or more without exceeding G0 cm seconds, more preferably in the range of 5 cm or more without exceeding 50 cm, still more preferably in the range of 5 cm or more without exceeding 40 cm.

The photothermographic material of the present invention can be developed by any desired method. Normally, the temperature of the photothermographic material having been exposed image-wise is raised and the material is developed. The development temperature is preferably in the range of 80 through 250° C., more preferably in the range of 100 through 140° C., still more preferably in the range of 110 through 130° C. The development time is preferably in the range of 1 through 10 seconds, more preferably in the range of 2 through 10 seconds, still more preferably in the range of 3 through 10 seconds. If the heating temperature is below 80° C., a sufficient image density cannot be obtained in a short time. If it exceeds 200° C., the binder melts and this will adversely affect not only the image per se including the transfer to the roller but also to the conveying performances and development equipment. When heated, a silver image is produced by the reaction of oxidation and reduction between the organic silver salt (serving as an oxidizing agent) and reducing agent. This reaction process proceeds without any supply of the processing solution such as water from the outside. The time for thermal development (time until the photothermographic material is ejected after having been picked up at the tray section) is preferably 60 seconds or less, preferably in the range of 10 seconds or more without exceeding 50 seconds, because the requirements for emergency diagnosis can be met.

Either a drum type heater or plate heater can be used as the thermal development system. The plate heater is more preferably used. Thermal development by plate heater uses a laser imager that captures a visible image according to the method disclosed in the JP-A No. 11-133572, wherein the photothermographic material having a latent image formed on the silver halide particle by exposure is brought in contact with the heating device by the thermal development section. The aforementioned heating device is made up of a plate heater, and a plurality of retaining rollers are arranged face to face with one another along one of the surfaces of the aforementioned plate heater. The aforementioned photothermographic material is fed between the aforementioned retaining roller and plate heater, and is subjected to thermal development.

The linear speed of the photothermographic material in the exposure section, thermal development section and cooling section can be determined as desired. However, a higher speed will lead to high-speed processing and increased throughput. The linear speed is preferably in the range of 20 mm/second or more without exceeding 100 mm/second, more preferably in the range of 25 mm/second or more without exceeding 80 mm/second, still more preferably in the range of 25 mm/second or more without exceeding 60 mm/second. The conveyance speed maintained within this range will minimize the contamination inside the thermal development apparatus at the time of thermal development and will improve the conveying performances. Further, the processing time can be reduced and requirements for emergency diagnosis can be met.

To perform both the processes of exposure and thermal development simultaneously, namely, to start development of some of the already exposed sheet-like photothermographic materials while exposing part of the sheet-like photothermographic materials, the distance between the exposure section for performing the process of exposure and the development section is preferably 0 cm or more without exceeding 50 cm. This arrangement reduces the time of processing a series of exposure and development. This distance is preferably in the range of 3 cm or more without exceeding 40 cm, more preferably, 5 cm or more without exceeding 30 cm. The exposure section in the sense in which it is used here refers to the position wherein the light coming from the exposure light source is applied to the silver halide photothermal photographic dry imaging material. The development section can be defined as the position wherein the silver halide photothermal photographic dry imaging material is first heated for thermal development.

The position (tip of the arrow mark) wherein the laser beam denoted by a symbol “L” in FIG. 1 is applied to the silver halide photothermal photographic dry imaging material corresponds to the exposure section. The development section is the position wherein the photothermographic material conveyed from the 15 of FIG. 1 is first brought in contact with the plate 51a.

A typical heating device as a hot plate, an iron, a hot roller or a heat generator using carbon or white titanium can be used as the heating device, apparatus or means. More preferably, the silver halide photothermal photographic dry imaging material provided with a protective layer on the light-sensitive layer should be heat-treated by bringing the surface on the side having the protective layer in contact with the heating device. This method is preferable from the viewpoint of uniform heating, and improved thermal and working efficiency. While the surface on the side having the protective layer is brought in contact with the heat roller, the material is conveyed and heat-treated, whereby development is performed.

In the laser imager preferably used in the present invention, the ratio of the path length of the cooling section with respect to the path length of the thermal development section is 1.5 or less, preferably in the range of 0.1 or more without exceeding 1.2, more preferably in the range of 0.2 or more without exceeding 1.0. In this case, the path length of the thermal development section can be defined as the conveyance path length wherein the photothermographic material is heated up to the development temperature in the thermal development apparatus. The path length of the cooling section is defined as the path length wherein the photothermographic material is ejected from the area wherein the photothermographic material is light-shielded by the laser imager after the thermal development section, to the site below the light in the room wherein the laser imager is installed.

The aforementioned laser imager preferably has a function of ensuring that the cooling speed on the surface withoutlight-sensitive layer (hereinafter referred to as “nonlight-sensitive surface”) across the support member of the photothermographic material is higher than that on the surface with light-sensitive layer (hereinafter referred to as “light-sensitive surface”).

In the present invention, the ratio of the cooling speed on the nonlight-sensitive surface to that on the nonlight-sensitive surface is preferably in the range of 1.1 or more, more preferably in the range of 1.1 through 5.0, still more preferably in the range of 1.5 through 3.0. Any method can be used to increase the cooling speed on the nonlight-sensitive surface. The nonlight-sensitive surface is preferably brought in direct contact with the metal plate, metallic roller, non-woven fabric and flocked roller. More preferably, a combined use of a heat sink or heat pipe should be used to take a positive step to discharge the heat stored in these members.

A compact laser imager of high processing speed is provided by the laser imager having a short path length of the cooling section wherein the ratio of the path length of the cooling section to that of the thermal development section is 1.5 or less.

The cooling time until the material is ejected after getting out of the thermal development section can be set to any desired level. It is preferably in the range of 0 or more without exceeding 25 seconds, more preferably in the range of 0 or more without exceeding 15 seconds, still more preferably in the range of 5 or more without exceeding 15 seconds.

The path length wherein the photothermographic material passes until it is ejected after getting out of the thermal development section can be set to a desired level. It is preferably in the range of 1 cm or more without exceeding 60 cm seconds, more preferably in the range of 5 cm or more without exceeding 50 cm, still more preferably in the range of 5 cm or more without exceeding 40 cm.

The photothermographic material of the present invention can be developed by any desired method. Normally, the temperature of the photothermographic material having been exposed image-wise is raised and the material is developed. The development temperature is preferably in the range of 80 through 250° C., more preferably in the range of 100 through 140° C., still more preferably in the range of 110 through 130° C. The development time is preferably in the range of 1 through 10 seconds, more preferably in the range of 2 through 10 seconds, still more preferably in the range of 3 through 10 seconds. If the heating temperature is below 80° C., a sufficient image density cannot be obtained in a short time. If it exceeds 200° C., the binder melts and this will adversely affect not only the image per se including the transfer to the roller but also to the conveying performances and development equipment. When heated, a silver image is produced by the reaction of oxidation and reduction between the organic silver salt (serving as an oxidizing agent) and reducing agent. This reaction process proceeds without any supply of the processing solution such as water from the outside. The time for thermal development (time until the photothermographic material is ejected after having been picked up at the tray section) is preferably 60 seconds or less, preferably in the range of 10 seconds or more without exceeding 50 seconds, because the requirements for emergency diagnosis can be met.

Either a drum type heater or plate heater can be used as the thermal development system. The plate heater is more preferably used. The thermal development by plate heater preferably uses a laser imager, which captures a visible image according the method disclosed in the JP-A No. 11-133572, wherein the photothermographic material having a latent image formed on the silver halide particle by exposure is brought in contact with the heating device by the thermal development section. The aforementioned heating device is made up of a plate heater, and a plurality of retaining rollers are arranged face to face with one another along one of the surfaces of the aforementioned plate heater. The aforementioned photothermographic material is fed between the aforementioned retaining roller and plate heater, and is subjected to thermal development.

The linear speed of the photothermographic material in the exposure section, thermal development section and cooling section can be determined as desired. However, a higher speed will lead to higher-speed processing and increased throughput. The linear speed is preferably in the range of 20 mm/second or more without exceeding 150 mm/second, more preferably in the range of 25 mm/second or more without exceeding 120 mm/second, still more preferably in the range of 30 mm/second or more without exceeding 100 nm/second. The conveyance speed maintained within this range will minimize the contamination inside the thermal development apparatus at the time of thermal development and will improve the conveying performances. Further, the processing time can be reduced and requirements for emergency diagnosis can be met.

To perform both the processes of exposure and thermal development simultaneously, namely, to start development of some of the already exposed sheet-like photothermographic materials while exposing part of the sheet-like photothermographic materials, the distance between the exposure section for performing the process of exposure and the development section is preferably 0 cm or more without exceeding 50 cm. This arrangement reduces the time of processing a series of exposure and development. This distance is preferably in the range of 3 cm or more without exceeding 40 cm, more preferably, 5 cm or more without exceeding 30 cm. The exposure section in the sense in which it is used here refers to the position wherein the light coming from the exposure light source is applied to the photothermographic material. The development section can be defined as the position wherein the photothermographic material is first heated for thermal development. The position (tip of the arrow mark) wherein the laser beam denoted by a symbol “L” in FIG. 1 is applied to the photothermographic material corresponds to the exposure section. The development section is the position wherein the photothermographic material conveyed from the 15 of FIG. 1 is first brought in contact with the plate 51a.

A typical heating device as a hot plate, an iron, a hot roller or a heat generator using carbon or white titanium can be used as the heating device, apparatus or means. More preferably, the photothermographic material provided with a protective layer on the light-sensitive layer should be heat-treated by bringing the surface on the side having the protective layer in contact with the heating device. This method is preferable from the viewpoint of uniform heating, and improved thermal and working efficiency. While the surface on the side having the protective layer is brought in contact with the heat roller, the material is conveyed and heat-treated, whereby development is performed.

### EXAMPLES

The present invention will be further described based on examples but is by no means limited to these. Unless specifically noted, “%” designates percent by weight.

### Example 1

### Preparation of Subbed Photographic Support

A photographic support comprised of a 175 μm thick biaxially oriented polyethylene terephthalate film with blue tinted at an optical density of 0.150 (determined by Densitometer PDA-65, manufactured by Konica Corp.), which had been subjected to corona discharge treatment of 8 W·minute/m² on both sides, was subjected to subbing. Namely, subbing liquid coating composition a-1 was applied onto one side of the above photographic support at 22° C. and 100 m/minute to result in a dried layer thickness of 0.2 μm and dried at 140° C., whereby a subbing layer on the light-sensitive layer side (designated as Subbing Layer A-1) was formed. Further, subbing liquid coating composition b-1 described below was applied, as a backing layer subbing layer, onto the opposite side at 22° C. and 100 m/minute to result in a dry layer thickness of 0.12 μm and dried at 140° C. An electrically conductive subbing layer (designated as subbing lower layer B-1), which exhibited an antistatic function, was applied onto the backing layer side. The surface of subbing lower layer A-1 and subbing lower layer B-1 was subjected to corona discharge treatment of 8 W·minute/m². Subsequently, subbing liquid coating composition a-2 was applied onto subbing lower layer A-1 was applied at 33° C. and 100 m/minute to result in a dried layer thickness of 0.03 μm and dried at 140° C. The resulting layer was designated as subbing upper layer A-2. Subbing liquid coating composition b-2 described below was applied onto subbing lower layer B-1 at 33° C. and 100 m/minute to results in a dried layer thickness of 0.2 μm and dried at 140° C. The resulting layer was designated as subbing upper layer B-2. Thereafter, the resulting support was subjected to heat treatment at 123° C. for two minutes and wound up under the conditions of 25° C. and 50 percent relative humidity, whereby a subbed sample was prepared.

Blue dye

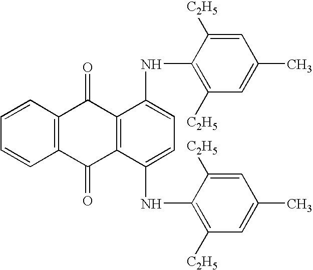

[Preparation of Hydrophilic Polyester Liquid A-1]

| | |
|---|---|
| dimethyl terephthalate | 35.4 weight parts |
| dimethyl isophthalate | 33.63 weight parts |
| sodium salt of dimethyl 5-sulfoisophthalate | 17.92 weight parts |
| ethylene glycol | 62 weight parts |
| calcium acetate monohydrate | 0.065 weight parts |
| manganese acetate tetrahydrate | 0.022 weight parts |

The above mixture underwent trans-esterification at 170 to 220° C. under a flow of nitrogen while distilling out methanol. Thereafter, 0.04 weight parts of trimethyl phosphate, 0.04 weight parts of antimony trioxide, and 6.8 weight parts of 4-cyclohexanedicarboxylic acid were added. The resulting mixture underwent esterification at a reaction temperature of 220 to 235° C. while a nearly theoretical amount of water being distilled away.

Thereafter, the reaction system was subjected to pressure reduction and heating over a period of one hour and was subjected to polycondensation at a final temperature of 280° C. and a maximum pressure of 133 Pa for one hour, whereby water-soluble polyester A-1 was synthesized. The intrinsic viscosity of the resulting water-soluble polyester A-1 was 0.33, the average particle diameter was 40 nm, and Mw was 80,000 to 100,000.

Subsequently, 850 ml of pure water was placed in a 2-liter three-necked flask fitted with stirring blades, a refluxing cooling pipe, and a thermometer, and while rotating the stirring blades, 150 g of water-soluble polyester A-1 was gradually added. The resulting mixture was stirred at room temperature for 30 minutes without any modification. Thereafter, the interior temperature was raised to 98° C. over a period of 1.5 hours and at that resulting temperature, dissolution was performed. Thereafter, the temperature was lowered to room temperature over a period of one hour and the resulting product was allowed to stand overnight, whereby 15% by weight hydrophilic polyester solution A-1 was prepared.

### [Preparation of Modified Hydrophilic Polyester Solutions B-1 to 2]

Into a 3-liter four-necked flask fitted with stirring blades, a reflux cooling pipe, a thermometer, and a dropping funnel was put 1,900 ml of the aforesaid 15 percent by weight water-based polyester A-1 solution, and the interior temperature was raised to 80° C., while rotating the stirring blades. Into this was added 6.52 ml of a 24 percent aqueous ammonium peroxide solution, and a monomer mixed liquid composition (consisting of 28.5 g of glycidyl methacrylate, 21.4 g of ethyl acrylate, and 21.4 g of methyl methacrylate) was dripped over a period of 30 minutes, and reaction was allowed for an additional 3 hours. Thereafter, the resulting product was cooled to at most 30° C., and filtrated, whereby modified water-based polyesters solution B-1 (vinyl based component modification ratio of 20 percent by weight) of 18 wt % solid was obtained.

Subsequently, modified polyester B-2 at a solid concentration of 18 percent by weight (a vinyl based component modification ratio of 20 percent by weight) was prepared in the same manner as above except that the vinyl modification ratio was changed to 36 percent by weight and the modified component was changed to styrene:glycidyl methacrylate:acetacetoxyethyl methacrylate:n-butyl acrylate=39.5:40:20:0.5.

### [Preparation of Acryl Polymer Latexes C-1 to C-3]

Acryl polymer latexes C-1 to C-3 having the monomer compositions shown in Table 1 were synthesized employing emulsion polymerization. All the solid concentrations were adjusted to 30 percent by weight.

TABLE 1

| Latex | | Tg |
|---|---|---|
| No. | Monomer Composition (weight ratio) | (° C.) |
| C-1 | styrene:glycidyl methacrylate:n-butyl acrylate = 20:40:40 | 20 |
| C-2 | styrene:n-butyl acrylate:t-butyl acrylate:hydroxyethyl | 55 |
| | methacrylate = 27:10:35:28 | |
| C-3 | styrene:glycidyl methacrylate:acetoacetoxyethyl | 50 |
| | methacrylate = 40:40:20 | |

[Coating Composition (a-1)of Subbing Lower Layer on Light-Sensitive Layer Side]

| | | |
|---|---|---|
| Acryl Polymer Latex C-3 (30% solids) | 70.0 | g |
| Aqueous dispersion of ethoxylated alcohol | 5.0 | g |
| and ethylene homopolymer (10% solids) | | |
| Surfactant (A) | 0.1 | g |
| Distilled Water to make | 1000 | ml |

[Coating Composition (a-2) of Light-Sensitive Layer Side Subbing Upper Layer]

| | | |
|---|---|---|
| Modified Water-based Polyester B-2 (18 wt %) | 30.0 | g |
| Surfactant (A) | 0.1 | g |
| Spherical silica matting agent (Sea Hoster | 0.04 | g |
| KE-P50, manufactured by Nippon Shokubai | | |
| Co., Ltd.) | | |
| Distilled water to make | 1000 | ml |

[Coating Composition (b-1) of Backing Layer Side Subbing Lower Layer]

| | | |
|---|---|---|
| Acryl Based Polymer Latex C-1 (30% solids) | 30.0 | g |
| Acryl Based Polymer Latex C-2 (30% solids) | 7.6 | g |
| SnO₂ sol* | 180 | g |
| Surfactant (A) | 0.5 | g |
| Aqueous 5 wt. % PVA-613 (PVA, manufactured | 0.4 | g |
| by Kuraray Co., Ltd.) | | |
| Distilled water to make | 1000 | ml |

*The solid concentration of SnO₂ sol synthesized employing the method described in Example 1 of JP-B No. 35-6616 was heated and concentrated to reach a solid concentration of 10 percent by weight, and subsequently, the pH was adjusted to 10 by the addition of ammonia water.

[Coatings Composition (b-2) of Backing Layer Side Subbing Upper Layer]

| | | |
|---|---|---|
| Modified Water-based Polyester B-1 (18% | 145.0 | g |
| by weight) | | |
| Spherical silica matting agent (Sea Hoster | 0.2 | g |
| KE-P50, manufactured by Nippon Shokubai | | |
| Co., Ltd.) | | |
| Surface Active Agent (A) | 0.1 | g |
| Distilled water to make | 1000 | ml |

On the subbing layer A-2 on the subbed support, a back coating layer and a protective layer of the back coating layer having the following composition were coated.

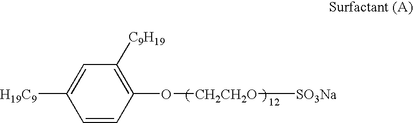

### [Preparation of Coating Solution of Back Coating Layer]

Into 830 g of methyl ethyl ketone (also denoted simply as MEK), 84.2 g of cellulose acetate propionate (CAP482-20, available form Eastman Chemical Co.) was added and dissolved with stirring. Subsequently, to this solution, 0.30 g of the following infrared dye 1 was added and further 4.5 g of a fluorinated surfactant (Surflon KH40, available from Asahi Glass Co., Ltd.) and 2.3 g of a fluorinated surfactant Megafac F120K, available from Dainippon Ink Co., Ltd.) which were dissolved in 43.2 g of methanol, were added and sufficiently stirred until dissolved. Then, 2.5 g of oleyl oleate was added with stirring to prepare a coating solution of the back coating layer.

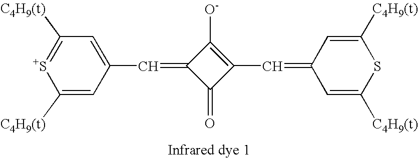

### <Preparation of Coating Solution of Back Coat Protective Layer>

Similarly to the foregoing coating solution of the back coating layer, a coating solution of the protective layer for the back coating layer was prepared according to the following composition, in which cross-linked PMMA (matting agent) was dispersed in MEK at a concentration of 1% using a dissolver type homogenizer and finally added.

| | |
|---|---|
| Cellulose acetate propionate (10% MEK solution | 15 g |
| CAP482-20 (produced by Eastman Chemical Co.) | |
| Three dimensionary cross-linked monodispersed | |
| spherical PMMA (polymethyl methacrylate) having | |
| monodispersion degree of 15% (average particle | |
| diameter and amount are shown in Tables 2 and 3) | |
| C₉F₁₇(CH₂CH₂O)₂₂C₉F₁₇ | 0.075 g |
| Fluorinated surfactant (Tables 2 and 3) | 0.01 g |
| Fluoropolymer (FM-1) | 0.05 g |
| Lubricant (Tables 2 and 3) | 0.1 g |
| α-alumina (Mohs hardness 9) | 0.1 g |

### <Preparation of Slipping Layer Coating Solution on Back Coating Layer Side>

A slipping layer coating solution on the back coating layer side having the following composition was prepared in a similar manner as the back coating layer coating solution.

| | |
|---|---|
| Cellulose acetate propionate (10% MEK solution) | 15 g |
| (CAP482-20 produced by Eastman Chemical Co.) | |
| Polyester resin (Bostic Co.: VitelPE2200B) | 0.15 g |

FM-1

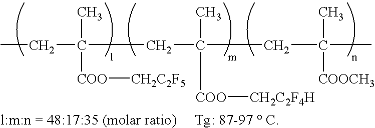

### <Preparation of Light-Sensitive Silver Halide Emultion A1>

| Solution A1 | | |
|---|---|---|
| Phenylcarbamoyl-modified gelatin | 88.3 | g |
| Compound (AO-1) (10% methanol aqueous solution) | 10 | ml |
| Potassium bromide | 0.32 | g |
| water to make | 5429 | ml |
| Solution B1 | | |
| 0.67 mol/L aqueous silver nitrate solution | 2635 | ml |
| Solution C1 | | |
| Potassium bromide | 50.69 | g |
| Potassium iodide | 2.66 | g |
| Water to make | 660 | ml |
| Solution D1 | | |
| Potassium bromide | 151.6 | g |
| Potassium iodide | 7.67 | g |
| Potassium hexachloroiridate (IV): | 0.93 | ml |
| K₂(IrCl₆) (1% aqueous solution) | | |
| Potassium hexacyanoiron (II) | 0.004 | g |
| Potassium hexachloroosmium (IV) | 0.004 | g |
| Water to make | 1982 | ml |
| Solution E1 | | |
| Aqueous 0.4 mol/L potassium bromide solution | | |
| in an amount to control silver potential | | |
| Solution F1 | | |
| Potassium hydroxide | 0.71 | g |
| Water to make | 20 | ml |
| Solution G1 | | |
| 56% aqueous acetic acid solution | 18.0 | ml |
| Solution H1 | | |
| Sodium carbonate anhydride | 1.72 | g |
| Water to make | 151 | ml |

AO-1: Compound (AO-1): HO(CH₂CH₂O)ₙ(CH(CH₃)CH₂O)₁₇(CH₂CH₂O)ₘH (m + n = 5 to 7)

Upon employing a mixing stirrer shown in JP-B No. 58-58288, ¼ portion of solution B1 and whole solution C1 were added to solution A1 over 4 minutes 45 seconds, employing a double-jet precipitation method while adjusting the temperature to 20° C. and the pAg to 8.09, whereby nuclei were formed. After one minute, whole solution F1 was added. During the addition, the pAg was appropriately adjusted employing Solution E1. After 6 minutes, ¾ portions of solution B1 and whole solution D1 were added over 14 minutes 15 seconds, employing a double-jet addition method while adjusting the temperature to 20° C. and the pAg to 8.09. After stirring for 5 minutes, the mixture was heated to 40° C., and whole solution G1 was added, whereby a silver halide emulsion was flocculated. Subsequently, while leaving 2000 ml of the flocculated portion, the supernatant was removed, and 10 L of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, solution H1 was added and the resultant mixture was heated to 60° C., and then stirred for an additional 120 minutes. Finally, the pH was adjusted to 5.8 and water was added so that the weight was adjusted to 1,161 g per mol of silver, whereby a light-sensitive silver halide emulsion A1 (hereinafter, also denoted as AgX A1) was prepared.

The prepared emulsion was comprised of monodisperse cubic silver iodobromide grains (iodide content 3.5 mol %) having an average grain diameter of 25 nm, 12% of a coefficient of variation of grain diameter (hereinafter, also denoted as a grain diameter variation coefficient) and a [100] crystal face ratio of 92%.

### [Preparation of Light-Sensitive Silver Halide Emulsion A2]

Similarly to the foregoing silver halide emulsion A1, light-sensitive silver halide emulsion A2 (also denoted as AgX A2) was prepared, except that after adding the total amount of solution F1 after nucleation, 40 ml of an 5% aqueous solution of 4-hydroxy-6-methyl-1,3,3a,7-tetrazaindene was added. The prepared emulsion was comprised of monodisperse cubic silver iodobromide grains (AgI content 3.5 mol %) having an average grain diameter of 25 nm, a grain diameter variation coefficient of 12% and a (100) crystal face ratio of 92%.

### [Preparation of Light-Sensitive Silver Halide Emulsion A3]

Similarly to the foregoing silver halide emulsion A1, light-sensitive silver halide emulsion A3 was prepared, except that after nucleation, the total amount of solution F1 was added and then, 4 ml of a 0.1% ethanol solution of the following compound (TPPS) was added thereto.

The prepared emulsion was comprised of monodisperse cubic silver iodobromide grains (AgI content 3.5 mol %) having an average grain diameter of 25 nm, a grain diameter variation coefficient of 12% and a (100) crystal face ratio of 92%.

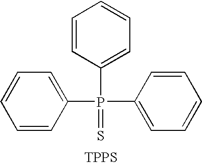

### [Preparation of Light-Sensitive Silver Halide Emulsion B1]

Similarly to the foregoing silver halide emulsion A1, light-sensitive silver halide emulsion B1 was prepared, except that the double jet addition was conducted at 45° C. The prepared emulsion was comprised of monodisperse cubic silver iodobromide grains (AgI content 3.5 mol %) having an average grain diameter of 55 nm, a grain diameter variation coefficient of 12% and a (100) crystal face ratio of 92%.

### [Preparation of Light-Sensitive Silver Halide Emulsion B2]

Similarly to the foregoing silver halide emulsion B1, light-sensitive silver halide emulsion B2 was prepared, except that after nucleation, the whole amount of solution F1 was added and then, 4 ml of a 0.1% ethanol solution of the foregoing compound (TPPS) was added thereto. The prepared emulsion was comprised of monodisperse cubic silver iodobromide grains (AgI content 3.5 mol %) having an average grain diameter of 55 nm, a grain diameter variation coefficient of 12% and a (100) crystal face ratio of 92%.

### Preparation of Powdery Organic Silver Salt

In 4,720 ml of pure water were dissolved 130.8 g of behenic acid, 67.7 g of arachidic acid, 43.6 g of stearic acid, and 2.3 g of palmitic acid at 80° C. Subsequently, 540.2 ml of a 1.5 M aqueous potassium hydroxide solution was added, and further, 6.9 ml of concentrated nitric acid was added. Thereafter, the resultant mixture was cooled to 55° C., whereby an aliphatic acid potassium salt solution was prepared. While maintaining the aliphatic acid potassium salt solution at 55° C., each of light-sensitive silver halide emulsions A1, A2, A3, B1 and B2 (kind and amount are shown in Tables 2 and 3) and 450 ml of pure water were added and stirred for 5 min.

Subsequently, 468.4 ml of 1 mol/L silver nitrate solution was added over 2 min. and stirred for 10 min., whereby an organic silver salt dispersion was prepared. Thereafter, the organic silver salt dispersion was transferred to a water washing machine, and deionized water was added. After stirring, the resultant dispersion was allowed to stand, whereby a flocculated organic silver salt was allowed to float and was separated, and the lower portion, containing water-soluble salts, were removed. Thereafter, washing was repeated employing deionized water until electric conductivity of the resultant effluent reached 2 μS/cm. After centrifugal dehydration, the resultant cake-shaped aliphatic carboxylic acid silver salt was dried employing an gas flow type dryer Flush Jet Dryer (manufactured by Seishin Kigyo Co., Ltd.), while setting the drying conditions such as nitrogen gas as well as heating flow temperature at the inlet of the dryer (65° C. at the inlet and 40° C. at the outlet), until its moisture content reached 0.1 percent, whereby powdery organic silver salt was prepared. The moisture content of the organic silver salt compositions was determined employing an infrared moisture meter.

### [Preparation of Preliminary Dispersion]

In 1457 g of methyl ethyl ketone (hereinafter referred to as MEK) was dissolved 14.57 g of poly(vinyl butyral) exhibiting a Tg of 62° C. and containing a SO₃K group at 0.2 mmol/g, as a binder of the light-sensitive layer (Image forming layer). While stirring by dissolver DISPERMAT Type CA-40M (manufactured by VMA-Getzmann Co.), 500 g of the foregoing powdery organic silver salt was gradually added and sufficiently mixed, and preliminary dispersion was thus prepared.

### [Preparation of Light-Sensitive Emulsion Dispersed Solution]

Preliminary dispersion prepared as above, was charged into a media type homogenizer DISPERMAT Type SL-C12EX (manufactured by VMA-Getzmann Co.), filled with 0.5 mm diameter zirconia beads (Toreselam, produced by Toray Co.) so as to occupy 80 percent of the interior volume so that the retention time in the mill reached 1.5 minutes and was dispersed at a peripheral rate of the mill of 8 m/second, whereby light-sensitive emulsion dispersed solution was prepared.

### <Preparation of Stabilizer Solution>

Stabilizer solution was prepared by dissolving 1.0 g of stabilizer 1 and 0.31 g of potassium acetate in 4.97 g of methanol.

### <Preparation of Infrared Sensitizing Dye A Solution>

Infrared sensitizing dye A solution was prepared by dissolving 9.6 mg of infrared sensitizing dye 1, 9.6 mg of infrared sensitizing dye 2, 1.488 g of 2-chloro-benzoic acid, 2.779 g of stabilizer 2, and 365 mg of 5-methyl-2-mercaptobenzimidazole in 31.3 ml of MEK in a dark room.

<Preparation of Additive Solution (a)>

Additive solution (a) was prepared by dissolving a reducing agent (as shown in Tables 2 and 3), 0.159 g of yellow dye forming leuco dye (YA-1) of the foregoing Formula (YB), 0.159 g of cyan dye forming leuco dye (CLA-4), 1.54 g of 4-methylphthalic acid, and 0.48 g of aforesaid infrared dye 1 in 110.0 g of MEK.

<Preparation of Additive Solution (b)>

Additive Solution (b) was prepared by dissolving 1.56 g of Antifoggant 2, 0.5 g of antifoggant 3, 0.5 g of antifoggant 4, 0.5 g of antifoggant 5 and 3.43 g of phthalazine in 40.9 g of MEK.

<Preparation of Additive Solution (c)>

Additive Solution (c) was prepared by dissolving 0.05 g of silver saving agent (SE1-3) in 39.95 g of MEK.

<Preparation of Additive Solution (d)>

Additive Solution (d) was prepared by dissolving 0.1 g of supersensitizer 1 in 9.9 g of MEK.

<Preparation of Additive Solution (e)>

Additive Solution (e) was prepared by dissolving 0.5 g of potassium p-toluenesulfonate and 0.5 g of antifoggant 6 in 9.0 g of MEK.

<Preparation of Additive Solution (f)>

Additive solution (f) was prepared by dissolving an antifoggant containing 1.0 g of vinylsulfone [(CH₂═CH—SO₂CH₂)₂CHOH] in 9.0 g of MEK.

### <Preparation of Light-Sensitive Layer Coating Solution>

In an inert gas atmosphere (97% nitrogen), 50 g of the foregoing light-sensitive dispersion (shown in Tables 2 and 3) and 15.11 g of MEK were mixed and the resultant mixture was maintained at 21° C., then, 1000 μl of chemical sensitizer S-5 (0.5% methanol solution) and after 2 min., 390 μl of antifoggant 1 (10% methanol solution) was added thereto and stirred for 1 hr. Further, 494 μl of calcium bromide (10% methanol solution) was added and after stirred for 10 minutes, gold sensitizer Au-5 corresponding to 1/20 mol of the foregoing chemical sensitizer was added. Subsequently, 167 μl of the foregoing stabilizer solution was added and stirred for 10 minutes. Thereafter, 1.32 g of the foregoing infrared sensitizing dye A was added and the resulting mixture was stirred for one hour. Subsequently, the resulting mixture was cooled to 13° C. and stirred for 30 min. While maintaining at 13° C., 0.5 g of additive solution d, 0.5 g of additive solution e, 0.5 g of additive solution f and 13.31 g of —SO₃K group-containing poly(vinyl butyral) (Tg: 62° C., containing 0.2 mmol/g of —SO₃K group) were added and stirred for 30 min. Thereafter, 1.084 g of tetrachlorophthalic acid (9.4% MEK solution) was added and stirred for 15 minutes. Further, while stirring, 12.43 g of additive solution a, 1.6 ml of Desmodur N3300 (aliphatic isocyanate, manufactured by Mobay Chemical Corp. 10% MEK solution), 4.27 g of additive solution b and 4.0 g of additive solution c were successively added, whereby a light-sensitive layer coating solution was prepared.

Additives used in the respective coating solutions and the coating solution of the light-sensitive layer are shown with respect to their chemical structures, as below.

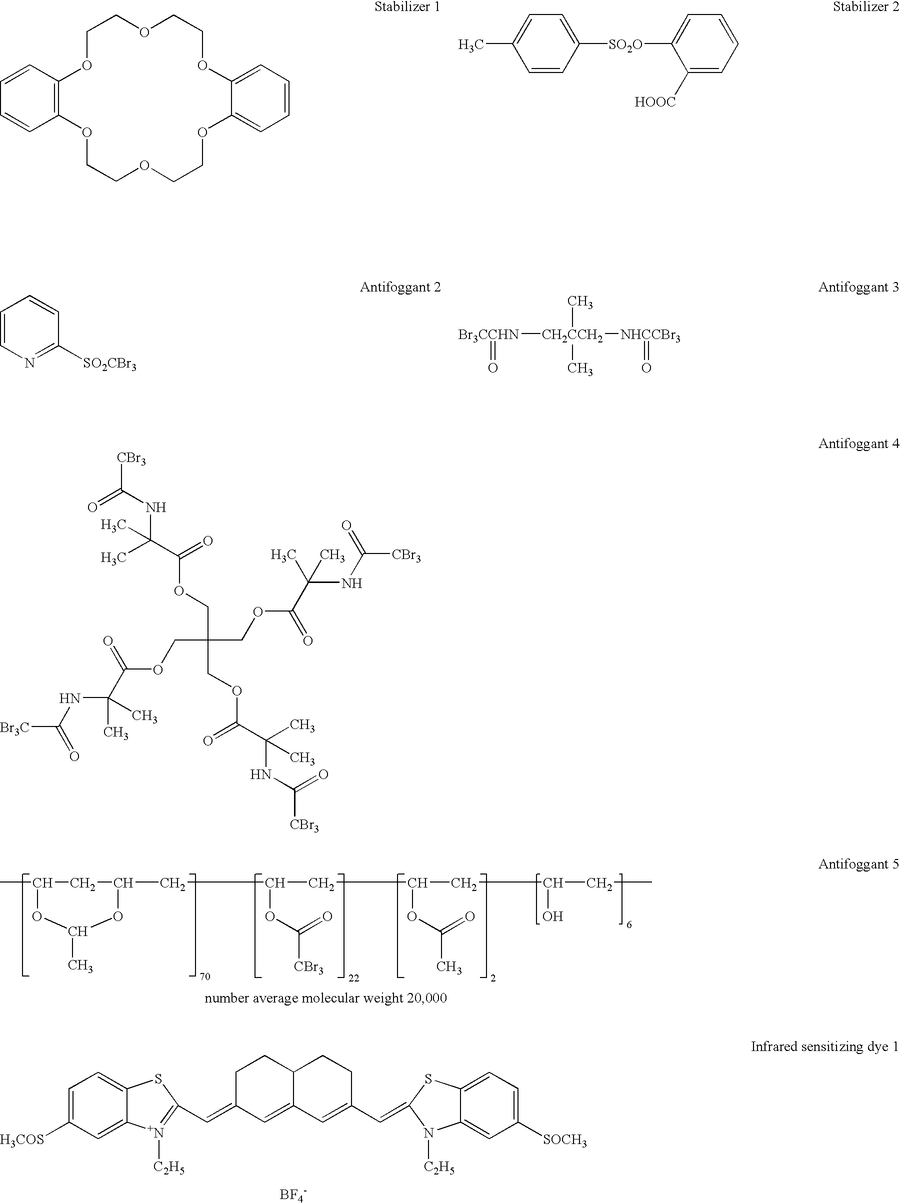

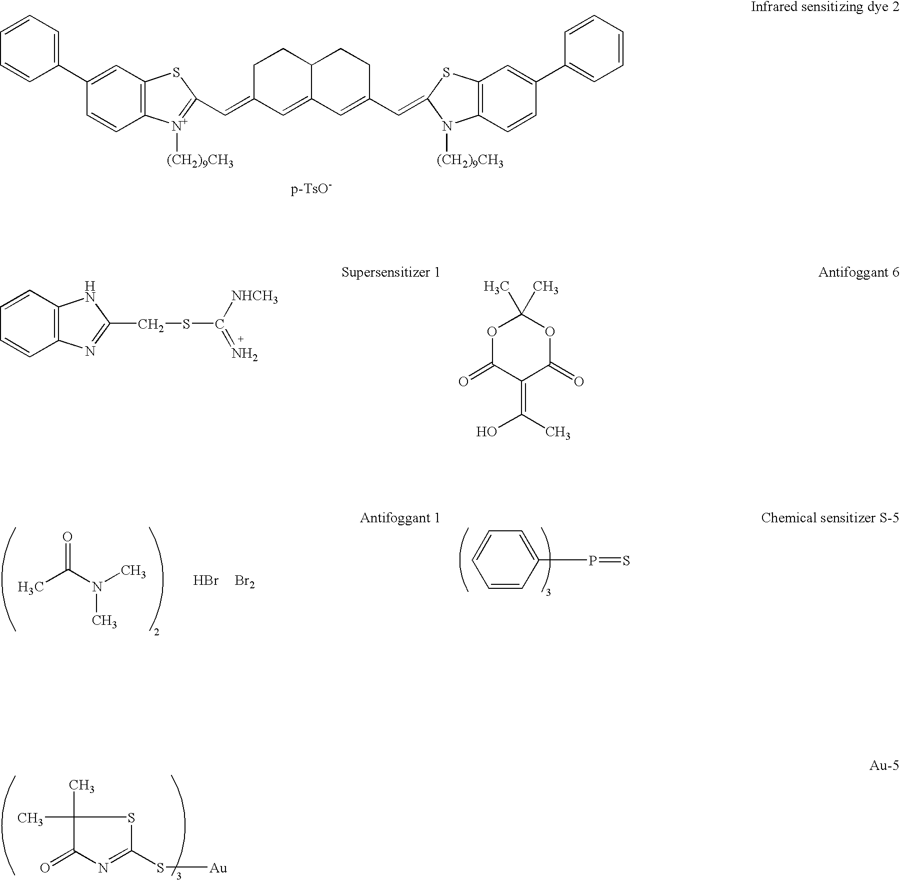

### <Preparation of Lower Protective Layer Coating Solution>

| | | |
|---|---|---|
| Acetone | 5 | g |
| MEK | 21 | g |
| Cellulose acetate Propionate(CAP-141-20, | 2.3 | g |
| Tg of 190° C., Eastman Chemical Co.) | | |
| Methanol | 7 | g |
| Phthalazine | 0.25 | g |
| CH₂═CHSO₂CH₂CH₂OCH₂CH₂SO₂CH═CH₂ | 0.035 | g |

### <Preparation of Upper Protective Layer Coating Solution>

| | | |
|---|---|---|
| Acetone | 5 | g |
| MEK | 21 | g |
| Cellulose acetate Propionate(CAP-141-20, | 2.3 | g |
| Tg of 190° C., Eastman Chemical Co.) | | |
| Paraloid A-21 (Rohm & Haas Co.) | 0.08 | g |
| Benzotriazole | 0.03 | g |
| Methanol | 7 | g |
| Phthalazine | 0.25 | g |
| Monodisperse (15%) spherical three | 0.40 | g |
| dimension-cured PMMA (average | | |
| particle diameter 1.0 μm) | | |
| Monodisperse (15%) spherical three | 0.10 | g |
| dimension-cured PMMA (average | | |
| particle diameter 4.5 μm) | | |
| CH₂═CHSO₂CH₂CH₂OCH₂CH₂SO₂CH═CH₂ | 0.035 | g |
| C₉F₁₇(CH₂CH₂O)₂₂C₉F₁₇ | 0.01 | g |
| Fluorinated surfactant (Tables 2 and 3) | 0.005 | g |
| Fluoropolymer (FM-1) | 0.01 | g |
| Isotridecyl stearate | 0.1 | g |
| Silicon-containing comb-shaped | 0.1 | g |
| graft polymer | | |
| (a copolymer having weight average | | |
| molecular weight of 5000 containing | | |
| silicon-containing macromonomer and | | |
| methyl methacryrate) | | |
| α-alumina (Mohs hardness 9) | 0.1 | g |

Coating solutions of the lower and upper protective layers were prepared based on the foregoing composition similarly to the coating solution of the back coating layer described earlier, in which cross-linked PMMA was dispersed in MEK at a concentration of 1% using a dissolver type homogenizer and finally added to form the lower protective layer and the upper protective layer.

### <Preparation of Slipping Layer Solution on the Light-Sensitive Layer Side>

The above-described coating solution of the light-sensitive layer was diluted with MEK to 10.5% solid content by using a dissolver type homogenizer. Then, PMMA was dissolved in the coating solution at a binder concentration of 30% and diluted with MEK to 10.5% solid content by using a dissolver type homogenizer to obtain a coating solution of a slipping layer on the light-sensitive layer side.

<preparation of Photothermographic Material>

The coating solutions of the slipping layer, the back coating layer and the protective layer for the back coating layer were coated on the upper subbing layer B-2, using a slide coater at a coating speed of 50 m/min so that the respective layers had dry thicknesses of 0.3 μm, 1.1 μm and 1.0 μm, respectively. Drying was conducted using a dry air having a dew point of 10° C. at 100° C. over a period of 5 min.

The coating solutions of the slipping layer, the light-sensitive layer and the coating solution of the protective layer (surface protective layer) for the light-sensitive layer were coated on the upper subbing layer A-2, using a slide coater at a coating speed of 50 m/min to prepare photothermographic material samples 101 to 140, as shown in Tables 2 and 3. Coating was conducted so that the slipping layer had a dry thickness of 0.3 μm, the light-sensitive layer had the dry thicknesses shown in Tables 2 and 3, and the protective layer for the light-sensitive layer (surface protective layer) had a dry thickness of 3.0 μm (i.e., 1.5 μm of the upper protective layer and 1.5 μm of the lower protective layer). Thereafter, drying was conducted using a dry air having a dew point of 10° C. at 100° C. over a period of 10 min.

The sample 123 was produced in the same procedure as that of the sample 111 except that, in the preparation of the powder organic silver salt A, 259.4 g of behenic acid and 0.5 g of arachidic acid were used instead of 130.8 g of behenic acid, 67.7 g of arachidic acid, 43.6 g of stearic acid and 2.3 g of palmitate.

The sample 132 was produced in the same procedure as that of the sample 111 except that, in the preparation of the slip layer coating solution on the back coating layer side of the sample 111, polymethyl methacrylate (Pararoid A21 by Rome and Hearth) instead of the polyester resin (Vitel PE 2200B by Bostic) was used in the same mass. The measurements of the sample 111 were B=0.09 and A=0, and those of the sample 132 were B=0.09 and A=0.

The sample 133 was produced in the same procedure as that of the sample 111 except that, in the preparation of the slip layer coating solution on the back coating layer side in the sample 111, a solid polyurethane resin (UR8300 by Toyobo) instead of the polyester resin (Vitel PE 2200B by Bostic) was used in the same mass. The measurements of the sample 133 were B=0.09 and A=0.

The sample 134 was produced in the same procedure as that of the sample 111 except that, in the preparation of the slip layer coating solution on the back coating layer side in the sample 111, the polyester resin (Vitel PE 2200B by Bostic) was not used. The measurements of the sample 134 were B=0 and A=0.

The sample 135 was produced in the same procedure as that of the sample 111 except that, in the preparation of the protective layer coating solution on the back coating layer side in the sample 111, 0.50 g of polyester resin (Vitel PE 2200B by Bostic) in addition to 15 g of cellulose acetate propionate (10% MEK solution) was added. The measurements of the sample 135 were B=0.09 and A=0.125. In the calculation of A and B, the back coated protective layer (surface protective layer) was assumed to be included in the back coating layer.

The sample 136 was produced in the same procedure as that of the sample 111 except that, in the preparation of the protective layer coating solution on the back coating layer side in the sample 111, 0.20 g of polyester resin (Vitel PE 2200B by Bostic) and 0.20 g of polymethyl methacrylate (Pararoid A21 by Rome and Hearth) in addition to 15 g of cellulose acetate propionate (10% MEK solution) were added. The measurements of the sample 136 were B=0.09 and A=0.105. In the calculation of A and B, the back coated protective layer (surface protective layer) was assumed to be included in the back coating layer.

The sample 137 was produced in the same procedure as that of the sample 111 except that, in the preparation of the protective layer coating solution on the back coating layer side in the sample 111, 0.10 g of polyester resin (Vitel PE 2200B by Bostic) and 0.30 g of polyurethane resin (UR8300 (30% MEK solution by Toyobo) in addition to 15 g of cellulose acetate propionate (10% MEK solution) were added. The measurements of the sample 137 were B=0.09 and A=0.105. In the calculation of A and B, the back coated protective layer (surface protective layer) was assumed to be included in the back coating layer.

The samples 138 and 139 were produced in the same procedure as that of the sample 111 except that, in the preparation of the protective layer coating solution on the back coating layer side in the sample 111, two types of matting agents having different particle diameters shown in Table 3 were added as shown in Table 3.

For the samples 101 through 140, the surface roughness of the outermost surface in the light-sensitive layer side was measured. The measurements were Rz(E)=2.9 μm and Ra(E)=126 nm.

For the samples 101 through 140, an absorption peak having a maximum absorption wavelength of 420 nm due to a yellow color producing leuco dye was observed. For the samples 101 through 140, an absorption peak having a maximum absorption wavelength of 620 nm due to a cyan color producing leuco dye was observed.

TABLE 2

| | | | | | | | | | | Type of | | |
|---|---|---|---|---|---|---|---|---|---|---|---|---|
| | | | | | | | | | | fluorine | | |
| | | | | | | | | | | based | | |
| | | | | Particle | | | | | Type of | surface | | Type and |
| | | Type of | Molecular | diameter | Amount | | | | fluorine | active | | amount of |
| | | lubricant | weight | of | of | | | | based | agent in | | reducing |
| | | in | of | matting | matting | Ra | Rz | Rt | surface | the upper | Dry | agent |
| | Type and | the BC | lubricant | agent in | agent in | (nm) | (μm) | (μm) | active | level of | thickness | represented |
| | amount of | (Back | in | the BC | the BC | on | on | on | agent in | the photo- | of | by |
| | photo- | Coating) | the BC | layer | layer | the | the | the | the BC | sensitive | photo- | Formula |
| Sam- | sensitive | layer | layer | protecttive | protecttive | BC | BC | BC | layer | layer | sensitive | (RD1) and |
| ple | silver halide | protecttive | protecttive | layer | layer | layer | layer | layer | protecttive | protecttive | layer | Formula |
| No. | emulsion (g) | layer | layer | (μm) | (g) | surface | surface | surface | layer | layer | (μm) | (RD2) (g) |
| 101 | A2/B2 = | LB-1 | 1270 | 10.0 | 0.03 | 117 | 6.9 | 9.7 | SF-17 | SF-17 | 10.5 | (1-1) = 27.98 |
| | 36.2/9.1 | | | | | | | | | | | |
| 102 | A3/B2 = | LB-1 | 1270 | 10.0 | 0.03 | 117 | 6.9 | 9.7 | SF-17 | SF-17 | 10.5 | (1-1) = 27.98 |
| | 36.2/9.1 | | | | | | | | | | | |
| 103 | A3/B2 = | LB-2 | 1186 | 10.0 | 0.03 | 117 | 6.9 | 9.7 | SF-17 | SF-17 | 10.5 | (1-1) = 27.98 |
| | 36.2/9.1 | | | | | | | | | | | |
| 104 | A3/B2 = | LB-3 | 885 | 10.0 | 0.03 | 117 | 6.9 | 9.7 | SF-17 | SF-17 | 10.5 | (1-1) = 27.98 |
| | 36.2/9.1 | | | | | | | | | | | |
| 105 | A3/B2 = | LB-1 | 1270 | 10.0 | 0.03 | 117 | 6.9 | 9.7 | SF-21 | SF-21 | 10.5 | (1-1) = 27.98 |
| | 36.2/9.1 | | | | | | | | | | | |
| 106 | A3/B2 = | LB-2 | 1186 | 10.0 | 0.03 | 117 | 6.9 | 9.7 | SF-22 | SF-22 | 10.5 | (1-1) = 27.98 |
| | 36.2/9.1 | | | | | | | | | | | |
| 107 | A3/B2 = | LB-3 | 885 | 10.0 | 0.03 | 117 | 6.9 | 9.7 | A | A | 10.5 | (1-1) = 27.98 |
| | 36.2/9.1 | | | | | | | | | | | |
| 108 | A3/B2 = | LB-4 | 723 | 10.0 | 0.03 | 117 | 6.9 | 9.7 | SF-17 | SF-17 | 10.5 | (1-1) = 27.98 |
| | 36.2/9.1 | | | | | | | | | | | |
| 109 | A3/B2 = | LB-5 | 639 | 10.0 | 0.03 | 117 | 6.9 | 9.7 | SF-17 | SF-17 | 10.5 | (1-1) = 27.98 |
| | 36.2/9.1 | | | | | | | | | | | |
| 110 | A3/B2 = | LB-6 | 934 | 10.0 | 0.03 | 117 | 6.9 | 9.7 | SF-17 | SF-17 | 10.5 | (1-1) = 27.98 |
| | 36.2/9.1 | | | | | | | | | | | |
| 111 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 112 | A3/B2 = | LB-7 | 1853 | 10.0 | 0.04 | 135 | 7.3 | 10.3 | SF-17 | SF-17 | 10.5 | (1-1) = 27.98 |
| | 36.2/9.1 | | | | | | | | | | | |
| 113 | A3/B2 = | LB-7 | 1853 | 12.0 | 0.04 | 148 | 7.8 | 11.9 | SF-17 | SF-17 | 10.5 | (1-1) = 27.98 |
| | 36.2/9.1 | | | | | | | | | | | |
| 114 | A3/B2 = | LB-7 | 1853 | 9.0 | 0.03 | 102 | 5.2 | 8.8 | SF-17 | SF-17 | 10.5 | (1-1) = 27.98 |
| | 36.2/9.1 | | | | | | | | | | | |
| 115 | A3/B2 = | LB-7 | 1853 | 10.0 | 0.03 | 117 | 6.9 | 9.7 | SF-17 | SF-17 | 14.0 | (1-1) = 27.98 |
| | 36.2/9.1 | | | | | | | | | | | |
| 116 | A3/B2 = | LB-7 | 1853 | 10.0 | 0.03 | 117 | 6.9 | 9.7 | SF-17 | SF-17 | 9.5 | (1-1) = 27.98 |
| | 36.2/9.1 | | | | | | | | | | | |
| 117 | A3/B2 = | LB-7 | 1853 | 10.0 | 0.03 | 117 | 6.9 | 9.7 | SF-17 | SF-17 | 15.5 | (1-1) = 27.98 |
| | 36.2/9.1 | | | | | | | | | | | |
| 118 | A3/B2 = | LB-7 | 1853 | 10.0 | 0.03 | 117 | 6.9 | 9.7 | SF-17 | SF-17 | 10.5 | (1-3) = 27.98 |
| | 36.2/9.1 | | | | | | | | | | | |
| 119 | A3/B2 = | LB-7 | 1853 | 10.0 | 0.03 | 117 | 6.9 | 9.7 | SF-17 | SF-17 | 10.5 | (1-10) = 27.98 |
| | 36.2/9.1 | | | | | | | | | | | |

TABLE 3

| | | | | | | | | | | Type of | | |
|---|---|---|---|---|---|---|---|---|---|---|---|---|
| | | | | | | | | | | fluorine | | |
| | | | | | | | | | | based | | |
| | | | | Particle | | | | | Type of | surface | | Type and |
| | | Type of | Molecular | diameter | Amount | | | | fluorine | active | | amount of |
| | | lubricant | weight | of | of | | | | based | agent in | | reducing |
| | | in | of | matting | matting | Ra | Rz | Rt | surface | the upper | Dry | agent |
| | Type and | the BC | lubricant | agent in | agent in | (nm) | (μm) | (μm) | active | level of | thickness | represented |
| | amount of | (Back | in | the BC | the BC | on | on | on | agent in | the photo- | of | by |
| | photo- | Coating) | the BC | layer | layer | the | the | the | the BC | sensitive | photo- | Formula |
| Sam- | sensitive | layer | layer | protecttive | protecttive | BC | BC | BC | layer | layer | sensitive | (RD1) and |
| ple | silver halide | protecttive | protecttive | layer | layer | layer | layer | layer | protecttive | protecttive | layer | Formula |
| No. | emulsion (g) | layer | layer | (μm) | (g) | surface | surface | surface | layer | layer | (μm) | (RD2) (g) |
| 120 | A3/B2 = | LB-7 | 1853 | 10.0 | 0.03 | 117 | 6.9 | 9.7 | SF-17 | SF-17 | 10.5 | *1) |
| | 36.2/9.1 | | | | | | | | | | | |
| 121 | A3/B2 = | LB-7 | 1853 | 10.0 | 0.03 | 117 | 6.9 | 9.7 | SF-17 | SF-17 | 10.5 | (1-40) = 27.98 |
| | 36.2/9.1 | | | | | | | | | | | |
| 122 | A3/B2 = | LB-7 | 1853 | 10.0 | 0.03 | 117 | 6.9 | 9.7 | SF-17 | SF-17 | 10.5 | (1-47) = 27.98 |
| | 36.2/9.1 | | | | | | | | | | | |
| 123 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 124 | A1/B1 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 125 | A1/B1 = | LB-7 | 1853 | 10.0 | 0.03 | 117 | 6.9 | 9.7 | SF-17 | SF-17 | 10.5 | (2-6) = 27.98 |
| | 36.2/9.1 | | | | | | | | | | | |
| 126 | A1/B1 = | LB-7 | 1853 | 10.0 | 0.03 | 117 | 6.9 | 9.7 | SF-17 | SF-17 | 17.0 | (1-1) = 27.98 |
| | 36.2/9.1 | | | | | | | | | | | |
| 127 | A1/B1 = | LB-7 | 1853 | 10.0 | 0.03 | 117 | 6.9 | 9.7 | SF-17 | SF-17 | 8.0 | (1-1) = 27.98 |
| | 36.2/9.1 | | | | | | | | | | | |
| 128 | A1/B1 = | LB-7 | 1853 | 16.0 | 0.03 | 155 | 9.5 | 14.2 | SF-17 | SF-17 | 10.5 | (1-1) = 27.98 |
| | 36.2/9.1 | | | | | | | | | | | |
| 129 | A1/B1 = | LB-7 | 1853 | 8.0 | 0.03 | 96 | 4.9 | 6.2 | SF-17 | SF-17 | 10.5 | (1-1) = 27.98 |
| | 36.2/9.1 | | | | | | | | | | | |
| 130 | A1/B1 = | B | 341 | 10.0 | 0.03 | 117 | 6.9 | 9.7 | SF-17 | SF-17 | 10.5 | (1-1) = 27.98 |
| | 36.2/9.1 | | | | | | | | | | | |
| 131 | A1/B1 = | C | 519 | 10.0 | 0.03 | 117 | 6.9 | 9.7 | SF-17 | SF-17 | 10.5 | (1-1) = 27.98 |
| | 36.2/9.1 | | | | | | | | | | | |
| 132 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 133 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 134 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 135 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 136 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 137 | A3/B2 = | LB-7 | 1853 | 10.0 | 0.03 | 117 | 6.9 | 9.7 | SF-17 | SF-17 | 10.5 | (1-1) = 27.98 |
| | 36.2/9.1 | | | | | | | | | | | |
| 138 | A3/B2 = | LB-7 | 1853 | 10.0/20.0 | 0.03/0.004 | 120 | 7.1 | 10.3 | SF-17 | SF-17 | 10.5 | (1-1) = 27.98 |
| | 36.2/9.1 | | | | | | | | | | | |
| 139 | A3/B2 = | LB-7 | 1853 | 10.0/15.0 | 0.03/0.004 | 119 | 7.0 | 10.0 | SF-17 | SF-17 | 10.5 | (1-1) = 27.98 |
| | 36.2/9.1 | | | | | | | | | | | |
| 140 | A3/B2 = | D | 7000 | 10.0 | 0.03 | 117 | 6.9 | 9.7 | SF-17 | SF-17 | 10.5 | (1-1) = 27.98 |
| | 36.2/9.1 | | | | | | | | | | | |

*1): (RD1-47)/(RD2-6) = 4.20/23.78
LB-1 Isotridesyl stearate
LB-2 Isotridesyl palmitate
LB-3 Glycerine triolate
LB-4 Glycerine trimyristate
LB-5 Glycerine trilaurate
LB-6 Trimethylol propane triisostrearate
LB-7 Dipentaerithritol hexaisostrearate
A C₈F₁₇SO₃Li
B Butyl stearate
C Oleyl oleate
D Silicon-containing comb-shaped graft polymer (copolymer having a weight-average molecular weight of 5000 formed of silicon-containing macromonomer and methylmethacrylate)

### <Exposure and Development>

The photothermographic material samples 101 through 140 produced in the aforementioned manner were cut to a half size cm×43.0 cm). After that, the samples were packaged in the following packaging material at 25° C. with a relative humidity of 50% and were stored under normal temperature for two weeks. After that, the aforementioned evaluation was made:

### (Packaging Material)

A barrier bag (according to JIS Z0208 Cup Method) made up of 10 μm of PET, 12 μm of PE, 9 μm of aluminum foil, 15 μm of Ny, and 50 μm of polyethylene containing 3% carbon 3, having an oxygen transmittance of 0.02 ml/m² per day at 25° C. under 1.013×10⁵ Pa and a moisture transmittance of 0.001 g/m² at 40° C. with a relative humidity of 90%, wherein a paper tray is used.

### (Sample Evaluation)

### <Exposure and Development>

For the photothermographic material samples 101 through 140 produced in the aforementioned manner, the setting temperature for simultaneous exposure and thermal development (51a of FIG. 1 (75 mm long in the direction of conveyance)) was set at 123° C., and the setting temperature (51b of FIG. 1 (175 mm long in the direction of conveyance)) was set at 27° C., respectively, using the thermal development apparatus of FIG. 1 (equipped with a 810 nm-semiconductor laser having a maximum 50 mW output on an installation area of 0.35 m²). The samples were conveyed so as to be brought in contact for 3 seconds and 7 seconds (for a total of ten seconds). The heat plates 51a and 51b each were set in such a way that the heating temperature was higher at the inlet in the direction of conveying the photothermographic material. The “simultaneous exposure and thermal development” in the sense in which it is used here refers to the start of development of some of the already exposed sheet-like photothermographic materials made up of a photothermographic material, while some of them are being exposed at the same time. The distance between the exposure section and development section was 12 cm. The conveyance speed from the photothermographic material supply apparatus to the image exposure apparatus at this time, the conveyance speed at the image exposure section and the conveyance speed at the thermal development section were 30 mm/second. Further, the bottom surface of the photothermographic material stock tray at the lowermost portion was 45 cm high above the floor surface. The time required for thermal development (time until the photothermographic material was ejected after being picked up by the tray section) was 45 seconds. (In the continuous processing mode, the thermal development time interval was 4 seconds. Exposure was conducted by reducing the exposure energy from the maximum output stepwise in increments of log E 0.05.)

### <<Gradation (Gamma Value (γ))>>

The optical density of the obtained photothermographic material was measured to get the gamma value. The gamma value was expressed in terms of the gamma at an optical density of 1.2 in the characteristic curve when the photothermographic material was subjected to thermal development. The characteristic curve of the photograph refers to the D-log E curve representing the relationship between the two when the common logarithm (log E) of the amount of exposure as exposure energy is plotted on the horizontal axis, and the optical density, i.e., scattered light photograph density (D), is plotted on the vertical axis. The gamma (γ) value refers to the slope of the tangential line (tan θ when the angle formed by this tangent line and the horizontal axis is expressed as 0) for the optical density D=1.2 on the characteristic curve.

### <<Evaluation of Surface Roughness>>

The samples prior to thermal development were measured by the following method using the non-contact three dimensional surface analyzer (RST/PLUS by WYKO).

1) Objective lens: ×10.0; Intermediate lens: ×1.0

2) Range of measurement: 463.4 μm×623.9 μm

3) Pixel size: 368×238

4) Filter: For cylindrical correction and inclination correction

5) Smoothing: Medium smoothing

6) Scanning speed: Low

The Ra, Rz and Rt were defined according to the stipulation on the surface roughness in JIS (B 0601). Each of 10 cm×10 cm samples was divided into 100 squares at an interval of 1 cm, and measurement was performed at the center of each regular square area. The average of 100 measurements was obtained.

### <<Film Damage>>

Using the thermal development apparatus of FIG. 1, a film was fed and damages of the outermost surface on the light-sensitive layer side were visually observed. The five-step evaluation was made, wherein the best level was assigned with “5”, and the worst level was assigned with “1”. (Evaluation was made in increments of 0.5 ranks). Practical use was rejected at level 2.5.

### <<Contamination Inside the Thermal Development Apparatus>>

Using the thermal development apparatus of FIG. 1, 5,000 film sheets were subjected to thermal development at 25° C. with a relative humidity of 65%. After that, contamination on the conveyance roller inside the thermal development apparatus was visually observed for evaluation. The best level free from any contamination of the roller surface was assigned with “5”, and the worst level (contamination observed over the entire roll surface) was assigned with “1”. Thus, evaluation was made in increments of 0.5 ranks.

### <<Film Conveying Performances at Low Moisture>>

Using the thermal development apparatus of FIG. 1, 100 film sheets were processed and conveyed at 10° C. with a relative humidity of 15%, so that the conveyance failures were counted (number of failures per 100 sheets).

<<Change in Density Resulting from Fluctuation in Humidity>>

The PDM65 transmission densitometer (by Konica) was used to measure the difference between the value at the maximum density portion (Dmax 1) when thermal development was performed under the same conditions as those for image quality evaluation (i.e., at 25° C. with a relative humidity of 40%) after samples were moisture-conditioned at 25° C. with a relative humidity of 40% for 24 hours; and the value at the maximum density portion (Dmax 2) when thermal development was performed under the same conditions as those for image quality evaluation (i.e., at 45° C. with a relative humidity of 9%) after samples were moisture-conditioned at 45° C. with a relative humidity of 90% for 24 hours (Dmax 1−Dmax 2=ΔDmax).

### <<Bondability>>

Cellotape (tradename for cellophane adhesive tape) was attached onto the sample and was scratched in squares. After the tape was separated, the percentage of the separated portion to total area was obtained and, and the following criteria were used for evaluation in increments of 0.5.

5: Separated portion is 0%.

4: Separated portion is 1 through 33%.

3: Separated portion is 34 through 66%.

2: Separated portion is 67% through 99%.

1: Separated portion is 100%.

The results are given in Table 4.

TABLE 4

| | | | | | | Change in | | |
|---|---|---|---|---|---|---|---|---|
| | | | | | Film | density | | |
| | | | Contamination | | conveyance | resulting | | |
| | | | inside | | under | from | | |
| | | | thermal | Damage | low | fluctuation | | |
| | Image | Gradation | development | on | moisture | in | | |
| Sample | density | (GamMa) | apparatus | film | (time) | humidity | Bondability | Remarks |
| 101 | 4.2 | 4.0 | 5.0 | 5.0 | 0 | 0.1 | 5.0 | Inv. |
| 102 | 4.2 | 4.0 | 5.0 | 5.0 | 0 | 0.1 | 5.0 | Inv. |
| 103 | 4.2 | 4.0 | 5.0 | 5.0 | 0 | 0.1 | 5.0 | Inv. |
| 104 | 4.2 | 4.0 | 5.0 | 5.0 | 0 | 0.1 | 5.0 | Inv. |
| 105 | 4.2 | 4.0 | 5.0 | 5.0 | 0 | 0.1 | 5.0 | Inv. |
| 106 | 4.2 | 4.0 | 5.0 | 5.0 | 0 | 0.1 | 5.0 | Inv. |
| 107 | 4.2 | 4.0 | 4.0 | 4.0 | 2 | 0.3 | 5.0 | Inv. |
| 108 | 4.2 | 4.0 | 5.0 | 5.0 | 0 | 0.1 | 5.0 | Inv. |
| 109 | 4.2 | 4.0 | 5.0 | 5.0 | 0 | 0.1 | 5.0 | Inv. |
| 110 | 4.2 | 4.0 | 5.0 | 5.0 | 0 | 0.1 | 5.0 | Inv. |
| 111 | 4.2 | 4.0 | 5.0 | 5.0 | 0 | 0.1 | 5.0 | Inv. |
| 112 | 4.1 | 3.9 | 4.5 | 4.5 | 1 | 0.2 | 5.0 | Inv. |
| 113 | 4.0 | 3.9 | 4.0 | 4.0 | 2 | 0.2 | 5.0 | Inv. |
| 114 | 4.2 | 4.0 | 5.0 | 5.0 | 0 | 0.1 | 5.0 | Inv. |
| 115 | 4.3 | 4.1 | 5.0 | 5.0 | 0 | 0.1 | 5.0 | Inv. |
| 116 | 3.8 | 3.8 | 4.5 | 4.5 | 1 | 0.2 | 5.0 | Inv. |
| 117 | 4.3 | 4.1 | 4.5 | 4.5 | 1 | 0.2 | 5.0 | Inv. |
| 118 | 4.2 | 4.0 | 5.0 | 5.0 | 0 | 0.1 | 5.0 | Inv. |
| 119 | 4.2 | 4.1 | 5.0 | 5.0 | 0 | 0.1 | 5.0 | Inv. |
| 120 | 4.0 | 3.8 | 4.5 | 4.5 | 1 | 0.2 | 5.0 | Inv. |
| 121 | 4.2 | 6.7 | 5.0 | 5.0 | 0 | 0.1 | 5.0 | Inv. |
| 122 | 4.1 | 3.9 | 5.0 | 5.0 | 1 | 0.2 | 5.0 | Inv. |
| 123 | 4.0 | 4.0 | 5.0 | 5.0 | 0 | 0.0 | 5.0 | Inv. |
| 124 | 3.9 | 3.9 | 4.5 | 4.5 | 1 | 0.1 | 5.0 | Inv. |
| 125 | 3.7 | 3.5 | 4.5 | 4.5 | 1 | 0.3 | 5.0 | Inv. |
| 126 | 4.2 | 4.0 | 2.5 | 2.5 | 8 | 0.7 | 5.0 | Comp. |
| 127 | 4.0 | 3.9 | 2.5 | 2.5 | 7 | 0.6 | 5.0 | Comp. |
| 128 | 4.1 | 4.0 | 2.0 | 2.0 | 13 | 1.1 | 5.0 | Comp. |
| 129 | 4.1 | 4.0 | 2.0 | 2.0 | 14 | 1.0 | 5.0 | Comp. |
| 130 | 4.2 | 4.0 | 1.5 | 1.5 | 12 | 1.0 | 5.0 | Comp. |
| 131 | 4.2 | 4.0 | 2.0 | 2.0 | 11 | 0.9 | 5.0 | Comp. |
| 132 | 4.2 | 4.0 | 5.0 | 5.0 | 0 | 0.1 | 4.5 | Inv. |
| 133 | 4.2 | 4.0 | 5.0 | 5.0 | 0 | 0.1 | 4.5 | Inv. |
| 134 | 4.2 | 4.0 | 5.0 | 5.0 | 0 | 0.1 | 3.5 | Inv. |
| 135 | 4.2 | 4.0 | 3.5 | 4.5 | 0 | 0.1 | 5.0 | Inv. |
| 136 | 4.2 | 4.0 | 3.5 | 4.5 | 0 | 0.1 | 4.5 | Inv. |
| 137 | 4.2 | 4.0 | 3.5 | 4.5 | 0 | 0.1 | 4.5 | Inv. |
| 138 | 4.2 | 4.0 | 5.0 | 5.0 | 0 | 0.1 | 5.0 | Inv. |
| 139 | 4.2 | 4.0 | 5.0 | 5.0 | 0 | 0.1 | 5.0 | Inv. |
| 140 | 4.2 | 4.0 | 4.0 | 4.0 | 1 | 0.2 | 5.0 | Inv. |

Inv.: Present invention,
Comp.: Comparison

In the sample 102, the paper tray was designed in a push-up bottom structure and the silica gel-containing paper tray with a silica gel filled in the space formed on the lower portion of the tray was used. An improvement effect was observed in the change of density resulting from fluctuation in humidity.

The above description refers to the best form of practicing the present invention. It is to be expressly understood, however, that the present invention is not restricted thereto. The present invention can be embodied in a great number of variations with appropriate modification or additions, without departing from the technological spirit and scope of the present invention claimed. For example, the image forming apparatus 10 of FIG. 1 can be formed as a laser imager for medical use capable of forming an image for medical use on a film and outputting the same by inputting the image data for medical use.

Further, the image forming apparatus 10 of FIG. 1 is designed in a relatively compact structure of desktop type. It goes without saying that the sheet film conveyance apparatus of the present invention is applicable not only to such a desktop type image forming apparatus but also to a stand-alone type comparatively large-sized thermal development type image forming apparatus, for example.

### Example 2

The following photothermographic materials were prepared using the support provided with a subbing layer, coating solutions, additives in a similar manner as Example 1, except that:

### <Preparation of Coating Solution of Back Coat Protective Layer>

<Preparation of Additive Solution (a)>and

### <Preparation of Upper Protective Layer Coating Solution>

were carried out as follows:

### <Preparation of Coating Back Coat Protective Layer>

Similarly to the foregoing coating solution of the back coating layer, a coating solution of the protective layer for the back coating layer was prepared according to the following composition, in which cross-linked PMMA (matting agent) was dispersed in MEK at a concentration of 1% using a dissolver type homogenizer and finally added.

| | | |
|---|---|---|
| Cellulose acetate propionate (10% MEK solution | 15 | g |
| CAP482-20 (produced by Eastman Chemical Co.) | | |
| Three dimensionary cross-linked monodispersed spherical | 0.03 | g |
| PMMA (polymethyl methacrylate) having monodispersion | | |
| degree of 15% (average particle diameter: 8.0 μm) | | |
| C₉F₁₇(CH₂CH₂O)₂₂C₉F₁₇ | 0.075 | g |
| Fluorinated surfactant (SF-8) | 0.01 | g |
| Fluoropolymer (FM-1) | 0.05 | g |
| Lubricant (Tables 5) | 0.1 | g |

<Preparation of Additive Solution (a)>

Additive solution (a) was prepared by dissolving a reducing agent (as shown in Table 5), 0.159 g of yellow dye forming leuco dye (YA-1) of the foregoing Formula (YB), 0.159 g of cyan dye forming leuco dye (CLA-4), 1.54 g of 4-methylphthalic acid, and 0.48 g of aforesaid infrared dye 1 in 110.0 g of MEK.

### <Preparation of Upper Protective Layer Coating Soution>

| | | |
|---|---|---|
| Acetone | 5 | g |
| MEK | 21 | g |
| Cellulose acetate Propionate(CAP-141-20, | 2.3 | g |
| Tg of 190° C., Eastman Chemical Co.) | | |
| Paraloid A-21(Rohm & Haas Co.) | 0.08 | g |
| Benzotriazole | 0.03 | g |
| Methanol | 7 | g |
| Phthalazine | 0.25 | g |
| Monodisperse (15%) spherical three | 0.40 | g |
| dimension-cured PMMA (average | | |
| particle diameter 1.0 μm) | | |
| Monodisperse (15%) spherical three | 0.35 | g |
| dimension-cured PMMA (average | | |
| particle diameter is shown in Table 5) | | |
| CH₂═CHSO₂CH₂CH₂OCH₂CH₂SO₂CH═CH₂ | 0.035 | g |
| C₉F₁₇(CH₂CH₂O)₂₂C₉F₁₇ | 0.01 | g |
| Fluorinated surfactant (SF-8) | 0.005 | g |
| Fluoropolymer (FM-1 aforementioned) | 0.01 | g |
| Lubricant (shown in Table 5) | 0.1 | g |

### <Preparation of Photothermographic Material>

The coating solutions of the slipping layer, the back coating layer and the protective layer for the back coating layer were coated on the upper subbing layer B-2, using a slide coater at a coating speed of 50 m/min so that the respective layers had dry thicknesses of 0.3 μm, 1.1 μm and 1.0 μm, respectively. Drying was conducted using a dry air having a dew point of 10° C. at 100° C. over a period of 5 min.

The coating solutions of the slipping layer, the light-sensitive layer and the coating solution of the protective layer (surface protective layer; light-insensitive layer) for the light-sensitive layer were coated on the upper subbing layer A-2, using a slide coater at a coating speed of 50 m/min to prepare photothermographic material samples 201 to 235, as shown in Tables 5 and 6. Coating was conducted so that the slipping layer had a dry thickness of 0.3 μm, the light-sensitive layer had the dry thicknesses shown in Table 5, and the protective layer for the light-sensitive layer (surface protective layer; light-insensitive layer) had a dry thickness of 3.0 μm (i.e., 1.5 μm of the upper protective layer and 1.5 μm of the lower protective layer). Thereafter, drying was conducted using a dry air having a dew point of 10° C. at 100° C. over a period of 10 min.

The sample 205 was produced in the same procedure as that of the sample 202 except that the fluorine-based surface active agent (SF-9) was used instead of the fluorine-based surface active agent (SF-8) of the back coating layer protective layer and light-sensitive layer protective layer.

The sample 206 was produced in the same procedure as that of the sample 203 except that the fluorine-based surface active agent (SF-14) was used instead of the fluorine-based surface active agent (SF-8) of the back coating layer protective layer, and light-sensitive layer protective layer.

The sample 207 was produced in the same procedure as that of the sample 204 except that the fluorine-based surface active agent (C₈F₁₇SO₃Li) was used instead of the fluorine-based surface active agent (SF-8) of the back coating layer protective layer and light-sensitive layer protective layer.

The sample 227 was produced in the same procedure as that of the sample 211 except that, in the preparation of the powder organic silver salt A, 259.4 g of behenic acid and 0.5 g of arachidic acid were used instead of 130.8 g of behenic acid, 67.7 g of arachidic acid, 43.6 g of stearic acid and 2.3 g of palmitate.

For the samples 201 through 235, the surface roughness of the outermost surface of the back coating layer side was measured. The measurements obtained are as follows: Ra(B)=95 nm, Rz(B)=4.6 μm, Rt(B)=6.3 μm.

For the samples 201 through 235, the absorption peak at the maximum absorption wavelength of 420 nm by yellow color producing leuco dye was observed. For the samples 201 through 235, the absorption peak at the maximum absorption wavelength of 620 nm by the cyan color producing leuco dye was observed.

### <<Evaluation Method>>

The photothermographic material samples 201 through 235 produced in the aforementioned manner were cut to a half size (34.5 cm×43.0 cm). After that, the samples were packaged in the following packaging material at 25° C. with a relative humidity of 50% and were stored under normal temperature for two weeks. After that, the aforementioned evaluation was made:

### (Packaging Material)

A barrier bag (according to JIS Z0208 Cup Method) made up of 10 μm of PET, 12 μm of PE, 9 μm of aluminum foil, 15 μm of Ny, and 50 μm of polyethylene containing 3% carbon 3, having an oxygen transmittance of 0.02 Ml/m² per day at 25° C. under 1.013×10⁵ Pa and a moisture transmittance of 0.001 g/m² at 40° C. with a relative humidity of 90%, wherein a paper tray is used.

### (Sample Evaluation)

### <Exposure and Development>

For the photothermographic material samples 201 through 235 produced in the aforementioned manner, the setting temperature for simultaneous exposure and thermal development (51a of FIG. 1 (75 mm long in the direction of conveyance)) was set at 123° C., and the setting temperature (51b of FIG. 1 (175 mm long in the direction of conveyance)) was set at 127° C., respectively, using the thermal development apparatus of FIG. 1 (equipped with a 810 nm-semiconductor laser having a maximum 50 mW output on an installation area of 0.35 m²). The samples were conveyed so as to be brought in contact for 3 seconds and 7 seconds (for a total of ten seconds). The heat plates 51a and 51b each were set in such a way that the heating temperature was higher at the inlet in the direction of conveying the light-sensitive material. The “simultaneous exposure and thermal development” in the sense in which it is used here refers to the start of development of some of the already exposed sheet-likelight-sensitive materials made of a photothermographic material, while some of them are being exposed at the same time. The distance between the exposure section and development section was 12 cm. The conveyance speed from the photothermographic material supply apparatus to the image exposure apparatus at this time, the conveyance speed at the image exposure section and the conveyance speed at the thermal development section were 30 mm/second. Further, the bottom surface of the light-sensitive material stock tray at the lowermost portion was 45 cm high above the floor surface. The time required for thermal development (time until the light-sensitive material was ejected after being picked up by the tray section) was 45 seconds. (In the continuous processing mode, the thermal development time interval was 4 seconds. Exposure was conducted by reducing the exposure energy from the maximum output stepwise in increments of log E 0.05.)

### <<Image Density>>

The value at the maximum density portion of the image obtained under the aforementioned conditions was measured by a densitometer, and the result was used as the image density.

### <<Gradation (Gamma Value (γ))>>

The optical density of the obtained photothermographic material was measured to get the gamma value. The gamma value was expressed in terms of the gamma at an optical density of 1.2 in the characteristic curve when the photothermographic material was subjected to thermal development. The characteristic curve of the photograph refers to the D-log E curve representing the relationship between the two when the common logarithm (log E) of the amount of exposure as exposure energy is plotted on the horizontal axis, and the optical density, i.e., scattered light photograph density (D), is plotted on the vertical axis. The gamma (γ) value refers to the slope of the tangential line (tan θ when the angle formed by this tangent line and the horizontal axis is expressed as θ) for the optical density D=1.2 on the characteristic curve.

### <<Evaluation of Surface Roughness>>

The surface roughness of the samples prior to thermal development was measured using the non-contact three dimensional surface analyzer (RST/PLUS by WYKO) according to the following procedure:

1) Objective lens: ×10.0; Intermediate lens: ×1.0

2) Range of measurement: 463.4 μm×623.9 μm

3) Pixel size: 368×238

4) Filter: Cylindrical correction and inclination correction

5) Smoothing: Medium smoothing

6) Scanning speed: Low

The Ra, Rz and Rt were defined according to the stipulation on the surface roughness in JIS (B 0601). Each of 10 cm×10 cm samples was divided into 100 squares at an interval of 1 cm, and measurement was performed at the center of each regular square area. The average of 100 measurements was obtained.

### <<Film Damage>>

Using the thermal development apparatus of FIG. 1, a film was fed and damages of the outermost surface on the light-sensitive layer side were visually observed. The five-step evaluation was made, wherein the best level was assigned with “5”, and the worst level was assigned with “1”. (Evaluation was made in increments of 0.5 ranks). Practical use was rejected at level 2.5.

### <Contamination Inside the Thermal Development Apparatus>>

Using the thermal development apparatus of FIG. 1, 5,000 film sheets were subjected to thermal development at 25° C. with a relative humidity of 65%. After that, contamination on the conveyance roller inside the thermal development apparatus was visually observed for evaluation. The best level free from any contamination of the roller surface was assigned with “5”, and the worst level (contamination observed over the entire roll surface) was assigned with “1”. Thus, evaluation was made in increments of 0.5 ranks.

### <<Film Conveying Performances at Low Moisture>>

Using the thermal development apparatus of FIG. 1, 100 film sheets were processed and conveyed at 20° C. with a relative humidity of 50%, so that the conveyance failures were counted (number of failures per 100 sheets).

The results are given in Table 6.

TABLE 5

| | | | | | | | | | Particle |
|---|---|---|---|---|---|---|---|---|---|
| | | | | | | | | | diameter |
| | | | | Lubricant in | | | | | of matting |
| | | | | the | | | | | agent in |
| | | | | protective | | | | | the |
| | | Lubricant in | | layer on the | | On the surface | | | protective |
| | Type and amount | the BC layer | | light- | | of the light- | | | layer on |
| | of light- | protective | | sensitive | | sensitive | | | the light- |
| | sensitive | layer | | layer side | | layer side | | | sensitive |
| Sample | silver halide | | Molecular | | Molecular | Ra | Rz | Rt | layer side |
| No. | emulsion (g) | Type | weight | Type | weight | (nm) | (μm) | (μm) | (μm) |
| 201 | A2/B2 = 36.2/9.1 | LB-1 | 1270 | LB-1 | 1270 | 132 | 4.1 | 5.5 | 6.5 |
| 202 | A3/B2 = 36.2/9.1 | LB-1 | 1270 | LB-1 | 1270 | 132 | 4.1 | 5.5 | 6.5 |
| 203 | A3/B2 = 36.2/9.1 | LB-2 | 1186 | LB-2 | 1186 | 132 | 4.1 | 5.5 | 6.5 |
| 204 | A3/B2 = 36.2/9.1 | LB-3 | 885 | LB-3 | 885 | 132 | 4.1 | 5.5 | 6.5 |
| 205 | A3/B2 = 36.2/9.1 | LB-1 | 1270 | LB-1 | 1270 | 132 | 4.1 | 5.5 | 6.5 |
| 206 | A3/B2 = 36.2/9.1 | LB-2 | 1186 | LB-2 | 1186 | 132 | 4.1 | 5.5 | 6.5 |
| 207 | A3/B2 = 36.2/9.1 | LB-3 | 885 | LB-3 | 885 | 132 | 4.1 | 5.5 | 6.5 |
| 208 | A3/B2 = 36.2/9.1 | LB-4 | 723 | LB-4 | 723 | 132 | 4.1 | 5.5 | 6.5 |
| 209 | A3/B2 = 36.2/9.1 | LB-5 | 639 | LB-5 | 639 | 132 | 4.1 | 5.5 | 6.5 |
| 210 | A3/B2 = 36.2/9.1 | LB-6 | 934 | LB-6 | 934 | 132 | 4.1 | 5.5 | 6.5 |
| 211 | A3/B2 = 36.2/9.1 | LB-7 | 1853 | LB-7 | 1853 | 132 | 4.1 | 5.5 | 6.5 |
| 212 | A3/B2 = 36.2/9.1 | LB-8 | 5000 | LB-8 | 1853 | 132 | 4.1 | 5.5 | 6.5 |
| 213 | A3/B2 = 36.2/9.1 | LB-7 | 1853 | LB-7 | 1853 | 145 | 4.8 | 6.2 | 7.7 |
| 214 | A3/B2 = 36.2/9.1 | LB-7 | 1853 | LB-7 | 1853 | 129 | 3.6 | 5.1 | 5.3 |
| 215 | A3/B2 = 36.2/9.1 | LB-7 | 1853 | LB-7 | 1853 | 120 | 3.0 | 4.5 | 4.7 |
| 216 | A3/B2 = 36.2/9.1 | LB-7 | 1853 | LB-7 | 1853 | 165 | 4.8 | 6.3 | 9.3 |
| 217 | A3/B2 = 36.2/9.1 | LB-7 | 1853 | LB-7 | 1853 | 132 | 4.1 | 5.5 | 6.5 |
| 218 | A3/B2 = 36.2/9.1 | LB-7 | 1853 | LB-7 | 1853 | 132 | 4.1 | 5.5 | 6.5 |
| 219 | A3/B2 = 36.2/9.1 | LB-7 | 1853 | LB-7 | 1853 | 132 | 4.1 | 5.5 | 6.5 |
| 220 | A3/B2 = 36.2/9.1 | LB-7 | 1853 | LB-7 | 1853 | 132 | 4.1 | 5.5 | 6.5 |
| 221 | A3/B2 = 36.2/9.1 | LB-7 | 1853 | LB-7 | 1853 | 132 | 4.1 | 5.5 | 6.5 |
| 222 | A3/B2 = 36.2/9.1 | LB-7 | 1853 | LB-7 | 1853 | 132 | 4.1 | 5.5 | 6.5 |
| 223 | A3/B2 = 36.2/9.1 | LB-7 | 1853 | LB-7 | 1853 | 132 | 4.1 | 5.5 | 6.5 |
| 224 | A3/B2 = 36.2/9.1 | LB-7 | 1853 | LB-7 | 1853 | 132 | 4.1 | 5.5 | 6.5 |
| 225 | A3/B2 = 36.2/9.1 | — | — | LB-7 | 1853 | 132 | 4.1 | 5.5 | 6.5 |
| 226 | A3/B2 = 36.2/9.1 | LB-7 | 1853 | — | — | 132 | 4.1 | 5.5 | 6.5 |
| 227 | A3/B2 = 36.2/9.1 | LB-7 | 1853 | LB-7 | 1853 | 132 | 4.1 | 5.5 | 6.5 |
| 228 | A1/B1 = 36.2/9.1 | LB-7 | 1853 | LB-7 | 1853 | 132 | 4.1 | 5.5 | 6.5 |
| 229 | A1/B1 = 36.2/9.1 | LB-7 | 1853 | LB-7 | 1853 | 132 | 4.1 | 5.5 | 6.5 |
| 230 | A1/B1 = 36.2/9.1 | LB-7 | 1853 | LB-7 | 1853 | 132 | 4.1 | 5.5 | 6.5 |
| 231 | A1/B1 = 36.2/9.1 | LB-7 | 1853 | LB-7 | 1853 | 132 | 4.1 | 5.5 | 6.5 |
| 232 | A1/B1 = 36.2/9.1 | LB-7 | 1853 | LB-7 | 1853 | 175 | 5.4 | 7.3 | 11.0 |
| 233 | A1/B1 = 36.2/9.1 | LB-7 | 1853 | LB-7 | 1853 | 115 | 2.9 | 4.3 | 4.5 |
| 234 | A1/B1 = 36.2/9.1 | A | 341 | A | 341 | 132 | 4.1 | 5.5 | 6.5 |
| 235 | A1/B1 = 36.2/9.1 | B | 519 | B | 519 | 132 | 4.1 | 5.5 | 6.5 |

LB-1 Isotridesyl stearate
LB-2 Isotridesyl palmitate
LB-3 Glycerin triolate
LB-4 Glycerin trimyristate
LB-5 Glycerin trilaurate
LB-6 Trimethylol propane trimisostearate
LB-7 Dipenta-erithritol hexaisostearate
LB-8 Silicon-containing comb-shaped graft polymer (hydroxyl group-containing copolymer having a weight-average molecular weight of 5000 formed of silicon-containing macromonomer and methylmethacrylate)
A Butyl stearate
B oleyl oleate

TABLE 6

| | Dry film | Type and | | | | | | |
|---|---|---|---|---|---|---|---|---|
| | thickness | amount of | | | | | | |
| | of | reducing agent | | | Contamination | | | |
| | the | in | | | inside | | | |
| | light- | Formula (RD1) | | | the | | | |
| | sensitive | and | | Gradation | thermal | Damage | | |
| Sample | layer | Formula (RD2) | Image | (GamMa | development | on | | |
| No. | (μm) | (g) | density | value) | apparatus | film | Conveyance | Remarks |
| 201 | 10.5 | (RD1-1) = 27.98 | 4.2 | 4.1 | 5.0 | 5.0 | 0 | Inv. |
| 202 | 10.5 | (RD1-1) = 27.98 | 4.2 | 4.1 | 5.0 | 5.0 | 0 | Inv. |
| 203 | 10.5 | (RD1-1) = 27.98 | 4.2 | 4.0 | 5.0 | 5.0 | 0 | Inv. |
| 204 | 10.5 | (RD1-1) = 27.98 | 4.2 | 4.0 | 5.0 | 5.0 | 0 | Inv. |
| 205 | 10.5 | (RD1-1) = 27.98 | 4.2 | 4.1 | 5.0 | 5.0 | 0 | Inv. |
| 206 | 10.5 | (RD1-1) = 27.98 | 4.2 | 4.0 | 5.0 | 5.0 | 0 | Inv. |
| 207 | 10.5 | (RD1-1) = 27.98 | 4.1 | 4.0 | 4.0 | 4.0 | 2 | Inv. |
| 208 | 10.5 | (RD1-1) = 27.98 | 4.2 | 4.0 | 5.0 | 5.0 | 0 | Inv. |
| 209 | 10.5 | (RD1-1) = 27.98 | 4.2 | 4.0 | 5.0 | 5.0 | 0 | Inv. |
| 210 | 10.5 | (RD1-1) = 27.98 | 4.2 | 4.1 | 5.0 | 5.0 | 0 | Inv. |
| 211 | 10.5 | (RD1-1) = 27.98 | 4.2 | 4.1 | 5.0 | 5.0 | 0 | Inv. |
| 212 | 10.5 | (RD1-1) = 27.98 | 4.2 | 4.1 | 5.0 | 5.0 | 0 | Inv. |
| 213 | 10.5 | (RD1-1) = 27.98 | 4.2 | 4.1 | 4.5 | 4.5 | 1 | Inv. |
| 214 | 10.5 | (RD1-1) = 27.98 | 4.2 | 4.1 | 4.5 | 4.5 | 0 | Inv. |
| 215 | 10.5 | (RD1-1) = 27.98 | 4.2 | 4.1 | 4.0 | 4.0 | 1 | Inv. |
| 216 | 10.5 | (RD1-1) = 27.98 | 4.1 | 4.0 | 4.0 | 4.0 | 2 | Inv. |
| 217 | 14.0 | (RD1-1) = 27.98 | 4.3 | 4.2 | 4.5 | 4.5 | 1 | Inv. |
| 218 | 9.5 | (RD1-1) = 27.98 | 3.8 | 3.8 | 4.5 | 4.5 | 2 | Inv. |
| 219 | 15.5 | (RD1-1) = 27.98 | 4.3 | 4.1 | 4.0 | 4.0 | 2 | Inv. |
| 220 | 10.5 | (RD1-3) = 27.98 | 4.2 | 4.1 | 5.0 | 5.0 | 0 | Inv. |
| 221 | 10.5 | (RD1-10) = 27.98 | 4.2 | 4.1 | 5.0 | 5.0 | 0 | Inv. |
| 222 | 10.5 | *1) | 4.0 | 3.9 | 4.5 | 4.5 | 0 | Inv. |
| 223 | 10.5 | (RD1-40) = 27.98 | 4.2 | 6.7 | 5.0 | 5.0 | 0 | Inv. |
| 224 | 10.5 | (RD1-47) = 27.98 | 4.1 | 3.9 | 4.5 | 4.5 | 0 | Inv. |
| 225 | 10.5 | (RD1-1) = 27.98 | 4.2 | 4.1 | 4.0 | 4.0 | 2 | Inv. |
| 226 | 10.5 | (RD1-1) = 27.98 | 4.2 | 4.0 | 4.0 | 4.0 | 2 | Inv. |
| 227 | 10.5 | (RD1-1) = 27.98 | 4.0 | 4.0 | 5.0 | 5.0 | 0 | Inv. |
| 228 | 10.5 | (RD1-1) = 27.98 | 3.9 | 3.9 | 5.0 | 5.0 | 0 | Inv. |
| 229 | 10.5 | (RD2-6) = 27.98 | 3.7 | 3.6 | 4.5 | 4.5 | 0 | Inv. |
| 230 | 17.0 | (RD1-1) = 27.98 | 4.3 | 4.2 | 2.5 | 2.5 | 7 | Comp. |
| 231 | 8.0 | (RD1-1) = 27.98 | 3.4 | 3.3 | 2.5 | 2.5 | 8 | Comp. |
| 232 | 10.5 | (RD1-1) = 27.98 | 4.1 | 4.0 | 1.5 | 1.5 | 9 | Comp. |
| 233 | 10.5 | (RD1-1) = 27.98 | 4.2 | 4.1 | 1.5 | 1.5 | 11 | Comp. |
| 234 | 10.5 | (RD1-1) = 27.98 | 4.2 | 4.0 | 1.5 | 1.5 | 12 | Comp. |
| 235 | 10.5 | (RD1-1) = 27.98 | 4.2 | 4.0 | 2.0 | 2.0 | 10 | Comp. |

Inv.: Present invention,
Comp.: Comparison
*1): (RD1-47)/(RD2-6) = 4.20/23.78

As is apparent from Tables 5 and 6, the samples of the present invention are characterized by minimized contamination inside the thermal development apparatus, minimized film damage, excellent conveying performances and superb image density.

It has been demonstrated that the present invention provides a photothermographic material characterized by minimized contamination inside the thermal development apparatus, minimized film damage, excellent conveying performances and superb image density, even when the photothermographic material is subjected to quick thermal development by a compact and low-cost thermal development apparatus.

In the sample 202, the paper tray was designed in a push-up bottom structure and the silica gel-containing paper tray with a silica gel filled in the space formed on the lower portion of the tray was used. An improvement effect was observed in the change of density resulting from fluctuation in humidity.

The above description refers to the best form of practicing the present invention. It is to be expressly understood, however, that the present invention is not restricted thereto. The present invention can be embodied in a great number of variations with appropriate modification or additions, without departing from the technological spirit and scope of the present invention claimed. For example, the image forming apparatus 10 of FIG. 1 can be formed as a laser imager for medical use capable of forming an image for medical use on a film and outputting the same by inputting the image data for medical use.

Further, the image forming apparatus 10 of FIG. 1 is designed in a relatively compact structure of desktop type. It goes without saying that the sheet film conveyance apparatus of the present invention is applicable not only to such a desktop type image forming apparatus but also to a stand-alone type comparatively large-sized thermal development type image forming apparatus, for example.

What is claimed is:

1. A photothermographic material comprising on one side of a support a light-sensitive layer containing an organic silver salt, silver halide grains, a binder and a reducing agent and on the other side of the support a back coating layer,
wherein
a dry thickness of the light-sensitive layer is 9 to 16 μm;
a centerline average roughness (Ra(B)) of an outermost surface of a back coating layer side is 100 to 150 nm; and
the back coating layer contains a lubricant having a molecular weight of 550 to 10000.

2. The photothermographic material of claim 1, wherein the lubricant is a polyvalent alcohol fatty acid ester.

3. The photothermographic material of claim 1, wherein the centerline average roughness (Ra(B)) of the outermost surface of the back coating layer side is 110 to 140 nm.

4. The photothermographic material of claim 1, wherein the light-sensitive layer contains a silver saving agent.

5. The photothermographic material of claim 4, wherein the silver saving agent is at least one selected from the group consisting of a hydrazine derivative compound, a vinyl compound, a phenol derivative compound, a naphthol derivative compound, a quaternary onium compound and a silane compound.

6. The photothermographic material of claim 1, wherein a maximum value of an image density after thermal development is 4.0 to 5.0.

7. The photothermographic material of claim 1, wherein a gamma value at an optical density of 1.2 on a photographic characteristic curve is 2.0 to 6.0.

8. A photothermographic material comprising:
on one side of a support, a light-sensitive layer containing an organic silver salt, silver halide grains, a binder and a reducing agent; and
on the other side of the support, a back coating layer, and a subbing layer between the back coating layer and the support, the back coating layer and the subbing layer containing at least one of a polyester resin, an acryl resin and a polyurethane resin,
wherein B>A is satisfied,
wherein
A represents a mass ratio of a total mass of the polyester resin, the acryl resin and the polyurethane resin contained in the back coating layer based on a total mass of a binder contained in the back coating layer; and
B represents a mass ratio of a total mass of the polyester resin, the acryl resin and the polyurethane resin contained in the subbing layer based on a total mass of a binder contained in the subbing layer.

9. A photothermographic material comprising:
on one side of a support, a light-sensitive layer containing an organic silver salt, silver halide grains, a binder and a reducing agent, and a light-insensitive layer provided on the light-sensitive layer; and
on the other side of the support, a back coating layer, wherein
a dry thickness of the light-sensitive layer is 9 to 16 μm;
a centerline average roughness (Ra(E)) of an outermost surface of a light-sensitive layer side is 120 to 170 nm; and
the light-insensitive layer or the back coating layer contains a lubricant having a molecular weight of 550 to 10000.

10. A photothermographic material of claim 9, wherein the lubricant is a polyvalent alcohol fatty acid ester.

11. A photothermographic material of claim 9, wherein the light-insensitive layer contains matting agent particles, wherein an average diameter of the matting agent particles is 4.7 to 10.0 μm.

12. A photothermographic material of claim 9, wherein the centerline average roughness (Ra(E)) of an outermost surface of a light-sensitive layer side is 125 to 160 nm.

13. A photothermographic material of claim 9, wherein a ten-point average roughness (Rz(E)) of the outermost surface of the light-sensitive layer side is 3.0 to 5.0 μm.

14. A photothermographic material of claim 9, wherein a maximum roughness (Rt(E)) of the outermost surface of the light-sensitive layer side is 4.5 to 6.5 μm.

15. The photothermographic material of claim 9, wherein the light-sensitive layer contains a silver saving agent.

16. The photothermographic material of claim 15, wherein the silver saving agent is at least one selected from the group consisting of a hydrazine derivative compound, a vinyl compound, a phenol derivative compound, a naphthol derivative compound, a quaternary onium compound and a silane compound.

17. The photothermographic material of claim 9, wherein a maximum value of an image density after thermal development is 4.0 to 5.0.

18. The photothermographic material of claim 9, wherein a gamma value at an optical density of 12 on a photographic characteristic curve is 2.0 to 6.0.
